(19) United States
(12) Patent Application Publication
(10) Pub. No.: US 2009/0096958 A1
(43) Pub. Date: Apr. 16, 2009

(54) FLUORESCENT LAMP, BACKLIGHT UNIT AND LIQUID CRYSTAL DISPLAY

(76) Inventors: Tomokazu Matsuura, Osaka (JP); Akiko Nakanishi, Osaka (JP); Hideki Wada, Osaka (JP); Akio Kitada, Osaka (JP); Masanobu Murakami, Osaka (JP); Hiroshi Sakurai, Osaka (JP); Takashi Maniwa, Osaka (JP); Kazuhiro Kumada, Hyogo (JP); Shigeru Ido, Osaka (JP); Makoto Yokozeki, Kagawa (JP); Nozomu Hashimoto, Osaka (JP)

Correspondence Address: SNELL & WILMER L.L.P. (Panasonic), 600 ANTON BOULEVARD, SUITE 1400, COSTA MESA, CA, 92626, US

(21) Appl. No.: 12/294,011

(22) PCT Filed: Mar. 23, 2007
(86) PCT No.: PCT/JP2007/056008

§ 371 Date: Sep. 22, 2008

(30) Foreign Application Priority Data
Mar. 24, 2006 (JP) 2006-084105

(51) Int. Cl. G02F 1/13357; H01J 1/62; G09F 13/08

(52) U.S. Cl. 349/70; 313/487; 362/97.1

(57) ABSTRACT

A cold cathode fluorescent lamp includes a glass bulb (16), a protective film (22) formed on an inner face of the glass bulb, and a phosphor layer (24) that overlaps the protective film and that contains blue phosphor particles (26B), green phosphor particles (26) and red phosphor particles (26). The glass bulb has been formed from soda glass, and the blue phosphor particles have been coated with a metal oxide (30). Also, the protective film is made of silica (SiO₂). Since the protective film has been provided in the fluorescent lamp and since the blue phosphor particles, which readily deteriorate, have been coated with the metal oxide, a good luminance maintenance rate is obtained. In addition, although the glass bulb of the fluorescent lamp is made of soda glass, since the protective film is made of silica, the fluorescent lamp obtains an initial luminance equivalent to the initial luminance of a fluorescent lamp whose glass bulb is made of borosilicate glass.

### TECHNICAL FIELD

The present invention relates to a fluorescent lamp, etc. such as is used as a light source for a backlight unit in a liquid crystal display apparatus.

### BACKGROUND ART

Among types of fluorescent lamps, one that is suited to having a small diameter is a cold cathode fluorescent lamp that has a phosphor layer formed on an inner face of a straight tube shaped glass bulb, and has cold cathodes disposed as internal electrodes at both ends. Accordingly, this type of cold cathode fluorescent lamp is preferable for use as a light source in a backlight unit for which thinness (a compact size) is required.

Also, when used as a light source in a backlight unit, a superior luminance maintenance rate is particularly necessary. Deterioration of phosphor and depletion of mercury are major causes of reduced luminance over time. Deterioration of phosphor and depletion of mercury are thought to occur in the following ways.

Conventionally, the phosphor layer is composed of innumerable red, green and blue phosphor particles and a binding agent made only from, for example, CBB (a type of alkali earth metal borate) that binds together these phosphor particles. Since a majority of the CBB binds the phosphor particles together by attaching to points on the phosphor particles, a large portion of the surface of each phosphor particle is likely to not be covered by the CBB.

The phosphor layer is bombarded by mercury ions generated when the cold cathode fluorescent lamp is lit. In such a case, due to exposed portions of the blue phosphor particles being bombarded by mercury ions, the crystal structure of the blue phosphor particles change to a non-light-emitting crystal structure and the blue phosphor particles readily deteriorate. Also, some of the mercury ions that hit the blue phosphor particles and the CBB accumulate therein. This results in the gradual depletion of the mercury that contributes to ultraviolet radiation emission. The deterioration of the blue phosphor particles and the depletion of mercury cause a reduction in luminance.

Also, sodium that is a component of the glass bulb elutes into a discharge space, and a reaction between the sodium and the mercury also causes the depletion of the mercury and reduction in luminance.

In view of this, patent document 1 discloses a structure in which the phosphor layer is formed from phosphor particles and a metal oxide (e.g., lanthanum oxide) that covers the phosphor particles, and a protective film constituted from yttrium oxide (Y₂O₃) is provided between an inner wall of the glass bulb and the phosphor layer.

Accordingly, the metal oxide covering protects the phosphor particles (particularly the blue phosphor particles) from mercury ion bombardment, and also prevents the sodium that has eluted out of the glass bulb from appearing in the discharge space, thereby improving the luminance maintenance rate.

Patent document 1: Japanese Patent Application Publication No. 2005-11665

### DISCLOSURE OF THE INVENTION

### Problems Solved by the Invention

However, upon testing the cold cathode fluorescent lamp described in patent document 1, the inventors of the present invention found that although the luminance maintenance rate was improved, the initial luminance is lower when soda glass is used as the material of the glass bulb than when borosilicate glass is used.

Currently, borosilicate glass is mainly used as the material of glass bulbs in cold cathode fluorescent lamps from a standpoint of achieving strength. However, there is demand to use soda glass from a standpoint of reducing cost. When using soda glass in place of borosilicate glass as the glass material, it is necessary to achieve an initial luminance that is equal to when borosilicate glass is used.

Note that the above problem is also shared by external electrode fluorescent lamps and hot cathode fluorescent lamps, not only cold cathode fluorescent lamps.

The present invention was achieved in view of the above problem, and an aim thereof is to provide a fluorescent lamp that achieves a favorable luminance maintenance rate and a substantially equal initial luminance to borosilicate glass even when soda glass is used as the glass material. Also, the present invention aims to provide a backlight unit and a liquid crystal display apparatus that include such a fluorescent lamp.

### Means to Solve the Problems

The above aim of the present invention is achieved by a fluorescent lamp including a glass bulb, a protective film formed on an inner face of the glass bulb, and a phosphor layer formed so as to overlap the protective film, the phosphor layer including blue phosphor particles, green phosphor particles, and red phosphor particles, wherein the glass bulb has been formed from soda glass, and among the blue phosphor particles, the green phosphor particles, and the red phosphor particles, at least the blue phosphor particles have been coated with a metal oxide, and the protective film has been formed from silica (SiO₂).

Also, in the fluorescent lamp of the present invention, one of a titanium compound and a cerium compound may be dispersed in the protective film.

Also, in the fluorescent lamp of the present invention, the metal oxide may be lanthanum oxide (La₂O₃), and the lanthanum oxide may be included in the phosphor layer at a ratio from 0.1 [wt %] to 1.5 [wt %] inclusive with respect to a total weight of the phosphor particles.

Alternatively, in the fluorescent lamp of the present invention, the metal oxide may be lanthanum oxide (La₂O₃), and the phosphor layer may include CBBP as a binding agent at a ratio from 1.3 [wt %] to 3 [wt %] inclusive.

Also, in the fluorescent lamp of the present invention, the metal oxide may be yttrium oxide (Y₂O₃), the phosphor layer may include CBB as a binding agent, and in the phosphor layer, letting A be a total weight ratio of yttrium oxide, and B be a total weight ratio of CBB, with respect to a total weight of 100 for the phosphor particles, A and B may be in ranges of 0.1≦A≦0.6, and 0.4≦(A+B)≦0.7.

Also, in the fluorescent lamp of the present invention, the blue phosphor particles may be europium-activated barium-magnesium aluminate, and a content amount of an impurity included in the blue phosphor particles may be less than or equal to 0.1 [wt %] of a total weight of the blue phosphor particles.

Also, in the fluorescent lamp of the present invention, cerium oxide may be included in the blue phosphor particles as the impurity.

Also, in the fluorescent lamp of the present invention, barium aluminate and magnesium aluminate may be included as the impurity.

Also, the fluorescent lamp of the present invention may further include a pair of bottomed tube-shaped electrodes, each electrode being disposed on an inner side of a different end and of the glass bulb, wherein an electrode material of at least one of the electrodes is composed of nickel as a base material, yttrium oxide having been added to the electrode material in a range of 0.1 [wt %] to 1.0 [wt %] inclusive.

Also, in the fluorescent lamp of the present invention, any of silicon, titanium, strontium and calcium may be added to the electrode material in a content amount that is less than or equal to half of a content amount of the yttrium oxide.

Also, the fluorescent lamp of the present invention may further include a pair of bottomed tube-shaped electrodes, each electrode being disposed on an inner side of a different end of the glass bulb; and a fluorescent lamp emitter formed on at least a portion of an inner face or an outer face of at least one of the electrodes, containing magnesium oxide, whose primary particles are formed from single crystals, an average particle diameter of the single crystals being less than or equal to 1 [μm].

Also, in the fluorescent lamp of the present invention, both ends of the glass bulb may be pinch-sealed to form pinch-sealed ends, a lead-in wire and a gas exhaust tube have been inserted through at least one of the pinch-sealed ends, the lead-in wire functioning as a power supply route to an internal electrode, and an outer end of the gas exhaust tube being sealed, and the fluorescent lamp may further include a base that is electrically connected to the lead-in wire and affixed to one of the gas exhaust tube and a portion of the glass bulb excluding the pinch-sealed ends.

Also, in the fluorescent lamp of the present invention, the base may be sleeve-shaped and affixed to an un-pinch-sealed portion of the glass bulb, the un-pinch-sealed portion being a portion of the glass bulb other than the pinch-sealed ends.

Also, in the fluorescent lamp of the present invention, the gas exhaust tube may extend outward from the at least one of the pinch-sealed ends, and the base may be affixed to an extending portion of the gas exhaust tube.

Also, in the fluorescent lamp of the present invention, the glass bulb may be sealed on both ends, and the fluorescent lamp may further include, on at least one end of the glass bulb, a lead wire that penetrates through the end, an electrode that is joined to an end of the lead wire on an inner side of the glass bulb, and a power supply terminal that is composed of a conductive film formed on an outer face of the end and an outer circumferential surface of the glass bulb that is contiguous with the outer face, and that is electrically connected to the lead wire.

Also, the fluorescent lamp of the present invention may further include an electrode provided on an inner side of an end of the glass bulb; and a lead wire, one end of which is connected to the electrode, and another end of which extends out of the end of the glass bulb, wherein a member has been attached to at least one end of the glass bulb via a buffer material, an elastic modulus of the member being higher than the buffer material, and the lead wire may be fitted through the buffer material and the member.

Also, in the fluorescent lamp of the present invention, a difference between a length of a non-phosphor layer area extending from a one end of the glass bulb and a length of a non-phosphor layer area extending from another end of the glass bulb may be greater than or equal to 2 [mm].

The above aim is also achieved by a backlight unit of the present invention that includes the fluorescent lamp of claim 1 as a light source.

Also, the above aim of the present invention is achieved by a liquid crystal display apparatus of the present invention that includes the backlight unit of claim 18 further including an outer case that stores the fluorescent lamp; and a liquid crystal display panel, wherein the outer case is disposed behind the liquid crystal display panel.

### EFFECTS OF THE INVENTION

Since at least the blue phosphor particles have been coated with a metal oxide, and a protective film has been formed on an inner face of the glass bulb, the above fluorescent lamp enables achieving a favorable luminance maintenance rate. Also, an experiment has confirmed that even though the glass bulb is made of soda glass, since the protective film is formed from silica (SiO₂), the fluorescent lamp achieves a substantially equal initial luminance to a fluorescent lamp that has a glass bulb made from borosilicate glass.

Also, dispersing a titanium compound or a cerium compound in the protective film enables reducing the amount of ultraviolet radiation emitted from the fluorescent lamp over a case of not dispersing a compound in the protective film.

Also, using lanthanum oxide as the metal oxide, and letting the total weight of phosphor particles be 100, including the lanthanum oxide in the phosphor layer at a weight ratio from 0.1 [wt %] to 1.5 [wt %] inclusive enables obtaining a necessary initial luminance and a necessary luminance maintenance rate.

Also, when the metal oxide is lanthanum oxide, and the phosphor layer includes CBBP as a binding agent at a ratio from 1.3 [wt %] to 3 [wt %] inclusive, the phosphor layer does not readily detach, and the fluorescent lamp achieves a necessary luminance.

Also, setting the total weight and the mixture ratios of the yttrium oxide and the CBB included in the phosphor layer to fall in the ranges specified above enables achieving an effect of suppressing defects of the phosphor layer, as well as suppressing a reduction in luminance due to binding agent discoloration that occurs in the manufacturing process.

Since the backlight unit of the present invention includes the above fluorescent lamp as a light source, and the liquid crystal display apparatus of the present invention includes the backlight unit, a high degree of luminance is reliably achieved on the display screen.

### BRIEF DESCRIPTION OF THE DRAWINGS

FIG. 1A shows a longitudinal section of a cold cathode fluorescent lamp pertaining to embodiment 1, and FIG. 1B illustrates dimensions of an electrode that is a constituent element of the cold cathode fluorescent lamp;

FIG. 2A is an enlarged pattern diagram of a phosphor layer and a vicinity thereof in the cold cathode fluorescent lamp, and FIG. 2B is a pattern diagram of a cold cathode fluorescent lamp pertaining to variation 1;

FIG. 3 shows selected processes involved in manufacturing the cold cathode fluorescent lamp;

FIG. 4 indicates results of an experiment pertaining to initial luminance and initial chromaticity shift, etc.;

FIG. 5 indicates results of an experiment pertaining to luminance maintenance rate;

FIG. 6 indicates results of an experiment to investigate the relationship between the content ratio of lanthanum oxide and initial luminance;

FIG. 7 is a perspective view of a schematic structure of a direct type backlight unit pertaining to embodiment 1 having one part cut away;

FIG. 8 shows a schematic structure of a liquid crystal television that uses the backlight unit;

FIG. 9 is a perspective view of a schematic structure of the direct type backlight unit pertaining to embodiment 1;

FIG. 10A shows a schematic structure of the cold cathode fluorescent lamp having a portion cut away, and FIG. 10B is a pattern diagram showing an area on the glass bulb where a phosphor film has been formed;

FIG. 11 shows results of an experiment to investigate how efficacy varies according to charged pressure and drive current among lamps having different charged pressures of mixed gas and drive currents, the mixed gas including argon gas at a partial pressure rate of 10%;

FIG. 12 shows the values of charged pressures and drive current as percentages, letting efficiency be 100 at a charged pressure of 60 [Torr], based on the results of the experiment of FIG. 11;

FIG. 13 shows a range of values when emission efficiency is improved 3[%], 5[%], 7[%], and 10[%] over a cold cathode fluorescent lamp having a charged pressure of 60 [Torr], based on FIG. 12;

FIG. 14 indicates values of coordinate points shown in FIG. 13;

FIG. 15 shows results of an experiment to investigate luminance maintenance rate when varying the partial pressure rate of argon gas in a mixed gas;

FIG. 16 shows a percentage analysis of values of other charged pressures and drive currents when the charged pressure is 60 [Torr] and the luminous efficiency is set at 100, with use of the results of the experiment to investigate how luminous efficiency varies according to charged pressure and drive current among lamps having different charged pressures of the mixed gas and drive currents, the mixed gas including argon gas at a partial pressure rate of 40%;

FIG. 17 is a block diagram showing a structure of a lighting apparatus in the backlight unit;

FIG. 18 shows manufacturing processes for the cold cathode fluorescent lamp;

FIG. 19 shows manufacturing processes for the cold cathode fluorescent lamp;

FIG. 20A diagrammatically shows a lamp filter, FIG. 20B shows a process for orienting lamps, and FIG. 20C shows a process for installing the lamps in a housing;

FIGS. 21A and 21B show a glass bulb pertaining to variation 1, FIG. 21A showing a glass bulb on which identifying marks have been printed, and FIG. 21B showing a cross section taken along line C-C of FIG. 21A;

FIG. 22 shows a glass bulb pertaining to variation 2;

FIG. 23 is a pattern diagram showing a schematic structure of a glass bulb pertaining to variation 3;

FIG. 24A is a cross-sectional view of a fluorescent lamp pertaining to embodiment 3-1 of the present invention including a tube axis thereof, and FIG. 24B is an enlarged cross-sectional view of section A of FIG. 24A;

FIG. 25A is an SEM cross section photograph of specimen 1 of the present invention, FIG. 25B is an SEM cross section photograph of comparative specimen 1, and FIG. 25C is an SEM cross section photograph of comparative specimen 2;

FIG. 26 is a table showing elemental analysis results of specimen 1 of the present invention, comparative specimen 1 and comparative specimen 2;

FIG. 27A shows an X-ray diffraction pattern diagram of specimen 1 of the present invention, FIG. 27B shows an X-ray diffraction pattern diagram of comparative specimen 1, and FIG. 27C shows an X-ray diffraction pattern diagram of comparative specimen 2;

FIG. 28 is a graph indicating changes in luminance maintenance rate between specimen 1-1 of the present invention, comparative specimen 1-1 and comparative specimen 2-1 according to hours lit;

FIG. 29 is a graph indicating changes in luminance maintenance rate between specimen 1-2 of the present invention, comparative specimen 1-2 and comparative specimen 2-2 according to hours lit;

FIG. 30A is a cross-sectional view of the fluorescent lamp pertaining to embodiment 3-2 of the present invention including the tube axis thereof, and FIG. 30B is an enlarged cross-sectional view of section B of FIG. 30A;

FIG. 31 is a graph indicating changes in luminance maintenance rates of specimen 1-2 of the present invention and specimen 1-1 of the present invention according to hours lit;

FIG. 32 shows a manufacturing method for an electrode 18;

FIG. 33 is an enlarged cross-sectional view of a portion of an exemplary fluorescent lamp pertaining to embodiment 12;

FIG. 34 shows another configuration of an emitter 4012b on an electrode 4012 shown in FIG. 33;

FIG. 35 shows a further configuration of the emitter 4012b on the electrode 4012 shown in FIG. 33;

FIG. 36 is a cross sectional view of another example of the electrode 4012 of FIG. 33;

FIG. 37A is a cross-sectional view of another example of a fluorescent lamp pertaining to embodiment 12, and FIG. 37B shows a cross section taken along I-I of FIG. 37A;

FIG. 38 is an electron microscope photograph showing an example of single-crystal magnesium oxide microparticles used in the present invention;

FIG. 39 is a graph indicating relationships between lamp current and lamp voltage in the lamps of working example 1 and comparative specimens 1 and 2;

FIG. 40 is a table showing the results of a comparative measurement of spatter amounts;

FIG. 41 is a perspective view of a fluorescent lamp pertaining to embodiment 6;

FIG. 42 is an enlarged cross-sectional view of a relevant portion of the fluorescent lamp pertaining to embodiment 6;

FIG. 43A is a perspective view of the fluorescent lamp pertaining to embodiment 6 when a member thereof has been marked, and FIG. 43B shows a cross section taken along A-A′ of the fluorescent lamp of FIG. 43A;

FIG. 44 is a cross-sectional front view of the fluorescent lamp pertaining to embodiment 6;

FIG. 45 is an enlarged cross-sectional view of a relevant portion pertaining to variation 1 of embodiments 6 to 7;

FIG. 46 is an enlarged cross-sectional view of a relevant portion pertaining to variation 2 of embodiments 6 to 7;

FIG. 47 is an enlarged cross-sectional view of a relevant portion pertaining to variation 3 of embodiments 6 to 7;

FIG. 48 is a perspective view of a socket for an external electrode type fluorescent lamp;

FIG. 49A is a front view showing a cold cathode fluorescent lamp pertaining to variation 4 of embodiment 7 being installed in an external electrode type fluorescent lamp socket, FIG. 49B is a side view of FIG. 49A, FIG. 49C is a front view of the cold cathode fluorescent lamp being inserted into a cold cathode fluorescent lamp socket, and FIG. 49D is a side view of FIG. 49C;

FIG. 50 is a perspective view of the socket for the cold cathode fluorescent lamp;

FIG. 51 pertains to conventional technology, and is an enlarged cross-sectional view of a relevant portion of a cold cathode fluorescent lamp that includes a glass tube and a heat-resistant sealing member on an outer side of a sealed portion of a lead wire;

FIG. 52 is a perspective view of a relevant portion of a backlight unit pertaining to embodiment 8;

FIGS. 53A and 53B are enlarged views of relevant portions of a cold cathode fluorescent lamp pertaining to embodiment 8;

FIGS. 54A and 54B pertain to variation 1 of embodiment 8, FIG. 54A being an enlarged cross-sectional front view of a relevant portion of a fluorescent lamp of variation 1, and FIG. 54B showing a cross section taken along A-A′ of the fluorescent lamp of FIG. 54A;

FIG. 55 is a cross-sectional front view of a fluorescent lamp pertaining to embodiment 8, including a tube axis thereof;

FIGS. 56A and 56B pertain to variation 3 of embodiment 8, FIG. 56A being a cross-sectional enlarged front view of a relevant portion of a fluorescent lamp, and FIG. 56B showing a cross section taken along B-B′;

FIGS. 57A and 57B pertain to variation 4 of embodiment 8, FIG. 57A being an enlarged cross-sectional front view of a relevant portion of a fluorescent lamp, and FIG. 57B showing a cross section taken along line C-C′;

FIGS. 58A and 58B pertain to variation 5 of embodiment 8, FIG. 58A being an enlarged cross-sectional front view of a relevant portion of the fluorescent lamp, and FIG. 58B showing a cross section taken along line D-D′;

FIGS. 59A and 59B pertain to variation 6 of embodiment 8, FIG. 59A being an enlarged cross-sectional front view of a relevant portion of the fluorescent lamp, and FIG. 59B showing a cross section taken along E-E′;

FIGS. 60A and 60B pertain to variation 7 of embodiment 8, FIG. 60A being an enlarged cross-sectional view of a relevant portion of the fluorescent lamp, and FIG. 60B showing a cross section taken along F-F′

FIGS. 61A and 61B pertain to variation 8 of embodiment 8, FIG. 61A being an enlarged cross-sectional front view of a relevant portion of a fluorescent lamp, and FIG. 61B showing a cross section taken along G-G′;

FIGS. 62A, 62B and 62C pertain to variation 9 of embodiment 8, FIG. 62A being an enlarged cross-sectional front view of a relevant portion of a fluorescent lamp, FIG. 62B being an enlarged cross-sectional bottom view of a relevant portion of the fluorescent lamp, and FIG. 62C showing a cross section taken along H-H′;

FIGS. 63A, 63B and 63C pertain to variation 10 of embodiment 8, FIG. 63A being an enlarged cross-sectional front view of the fluorescent lamp, FIG. 63B being an enlarged cross-sectional bottom view, and FIG. 63C showing a cross section taken along I-I′;

FIGS. 64A, 64B and 64C pertain to variation 11 of embodiment 8, FIG. 64A being an enlarged front cross-sectional view of a relevant portion of a fluorescent lamp, FIG. 64B being an enlarged cross-sectional bottom view of the fluorescent lamp, and FIG. 64C showing a cross section taken along J-J′;

FIG. 65 is a view of a relevant portion of a hot cathode fluorescent lamp pertaining to embodiment 9;

FIG. 66 is a view of a relevant portion of a hot cathode fluorescent lamp pertaining to embodiment 10;

FIG. 67 is a view of a relevant portion of a hot cathode fluorescent lamp pertaining to embodiment 11;

FIG. 68 is a perspective view of a relevant portion of a hot cathode fluorescent lamp pertaining to embodiment 12;

FIG. 69 is a view of a relevant portion of a hot cathode fluorescent lamp pertaining to embodiment 13;

FIG. 70 is a pattern diagram showing an area in which a phosphor layer has been formed on a glass bulb;

FIG. 71 shows an outline of manufacturing processes for a cold cathode fluorescent lamp;

FIG. 72 is an outline process drawing showing a manufacturing process for a cold cathode fluorescent lamp;

FIG. 73 is a pattern diagram showing a schematic structure of a glass bulb pertaining to variation 12 of embodiments 8 to 13;

FIG. 74 is a pattern diagram showing a schematic structure of a glass bulb pertaining to variation 13 of embodiments 8 to 13;

FIG. 75 is a perspective view showing a schematic structure of a cold cathode fluorescent lamp pertaining to the embodiments having a portion cut away;

FIG. 76 shows a longitudinal section of an end portion of the cold cathode fluorescent lamp;

FIG. 77 is an enlarged cross section showing one end of a cold cathode fluorescent lamp pertaining to embodiment 14-2;

FIG. 78 is a perspective view of a thin film member constituting a power supply terminal; and

FIG. 79 indicates results of an experiment to investigate the relationship between the weight ratio of lanthanum oxide and chromaticity shift.

### DESCRIPTION OF THE CHARACTERS

10 cold cathode fluorescent lamp
16 glass bulb
22 protective film
24, 50 phosphor layer
26 phosphor particles
26B blue phosphor particles
30, 52 coating

### BEST MODE FOR CARRYING OUT THE INVENTION

Embodiments of the present invention are described below with reference to the drawings.

### Embodiment 1

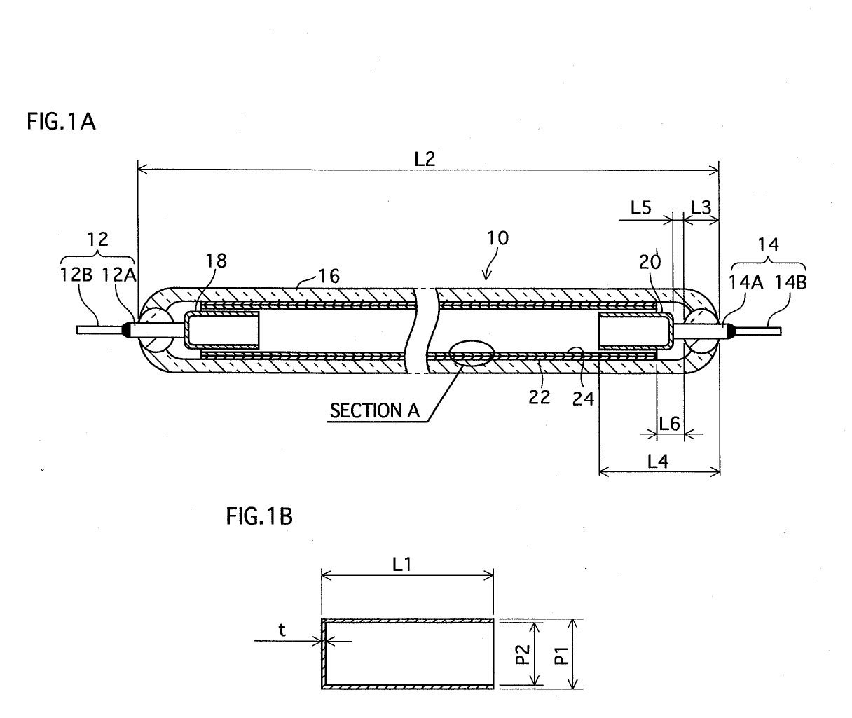

FIG. 1A is a longitudinal sectional view of a schematic structure of a cold cathode fluorescent lamp 10 pertaining to embodiment 1. Note that in each of the drawings, including FIG. 1A, the constituent elements are not necessarily drawn to scale.

The cold cathode fluorescent lamp 10 includes a glass bulb 16 formed by creating an airtight seal, with use of lead wires 12 and 14, on both ends of a glass tube having a circular cross section. The glass bulb 16 is formed from lead glass, lead-free glass, soda lime glass, or another soda glass, and has a 740 [mm] total length L2, a 4 [mm] outer diameter, and a 3 [mm] inner diameter (the thickness is 0.5 [mm]).

Note that the total length L2 may vary in a range from 300 [mm] to 1500 [mm] inclusive. Also, the outer diameter may vary in a range from 1.0 [mm] to 8.0 [mm] inclusive, and is preferably in a range from 2.0 [mm] to 4.0 [mm] inclusive. The thickness (glass thickness) may vary in a range from 0.2 [mm] to 0.6 [mm] inclusive, and is preferably in a range from 0.3 [mm] to 0.5 [mm] inclusive.

Soda glass is a glass material containing Na₂O in a range from 4.5 [wt %] to 20 [wt %] inclusive. In the present example, lead-free glass (Na₂O content from 5 [wt %] to 12 [wt %] inclusive) is used. Note that a preferable Na₂O content when using lead-free glass is from 7 [wt %] to 10 [wt %] inclusive.

Also, the inside of the glass bulb 16 is filled with approximately 2 [mg] of mercury (not depicted) and a mixed gas (not depicted) composed of a plurality of types of noble gas, the types being argon (Ar) gas and neon (Ne) gas. In the mixed noble gas in the present example, the partial pressure rate of argon is 10[%] and the partial pressure rate of neon is 90[%], and the mixed noble gas is enclosed in the glass bulb 16 at a pressure of 50 [Torr]. Note that the partial pressure rate of the mixed noble gas is not limited to this, and the range of neon can be set to be from 60[%] to 99.9[%] inclusive, with argon occupying the remaining portion. Also, the gas pressure may vary in a range from 6 [kPa] to 18 [kPa].

The lead wires 12 and 14 are connected wires including, respectively, inner lead wires 12A and 14A that are made of Dumet, and outer lead wires 12B and 14B that are made of nickel. At both ends of the glass tube, airtight seals have been formed by the inner lead wires 12A and 14A. The inner lead wires 12A and 14A and the outer lead wires 12B and 14B all have circular cross sections. The inner lead wires 12A and 14A have 1.0 [mm] wire diameters and 3.0 [mm] total lengths, and the outer lead wires 12B and 14B have 0.8 [mm] wire diameters and 3.0 [mm] total lengths.

Note that the lead wires are not limited to being connected wires, and may be single wires made of an Fe and Ni alloy. In this case, the wire diameter of the lead wires is set to be in a range from 0.3 [mm] to 1.0 [mm] inclusive, and preferably in a range from 0.5 [mm] to 0.8 [mm] inclusive.

A sealed length L3 of the lead wires is set to be in a range from 1.0 [mm] to 2.5 [mm] inclusive, and preferably from 1.5 [mm] to 2.0 [mm] inclusive.

Electrodes 18 and 20 are joined by laser welding or the like to ends inside the glass bulb 16 on the sides of inner lead wires 12A and 14A, respectively, that are supported at the ends of the glass bulb 16. The electrodes 18 and 20 are so-called hollow-type electrodes, have bottomed-tube shapes, and are formed by processing niobium rods. Hollow-type electrodes are used as the electrodes 18 and 20 since hollow-type electrodes are effective in suppressing spattering caused by electrical discharge during lamp operation (for details, see Japanese Patent Application Publication No. 2002-289138, etc.) Note that the material of the electrodes 18 and 20 is not limited to niobium (Nb), and may also be nickel (Ni), molybdenum (Mo), or tungsten (W), etc.

The electrodes 18 and 20 have the same shape, and the measurements of each portion shown in FIG. 1B are as follows. Electrode length L1=5.5 [mm], outer diameter P1=2.7 [mm], and bottom thickness t=0.2 [mm] (inner diameter P2=2.3 [mm]) Note that the electrode length L1, the outer diameter P1, the inner diameter P2, and the bottom thickness t can vary in the ranges indicated below. The range of the electrode length L1 is from 3 [mm] to 10 [mm] inclusive, and preferably from 5 [mm] to 6 [mm] inclusive. The range of the outer diameter P1 is from 1.0 [mm] to 7.0 [mm] inclusive, and preferably from 1.5 [mm] to 3.0 [mm] inclusive. The range of the inner diameter P2 is from 0.8 [mm] to 6.8 [mm] inclusive, and preferably from 1.3 [mm] to 2.8 [mm] inclusive. The range of the bottom thickness t is from 0.2 [mm] to 0.6 [mm] inclusive, and preferably from 0.4 [mm] to 0.5 [mm] inclusive.

Also, the length L4 from the outer end of the glass bulb 16 to the tip of the electrode 20(18) is set to be in a range from 5 [mm] to 10 [mm] inclusive, and preferably from 7 [mm] to 9 [mm] inclusive. The length L5 from the inner end of the glass bulb 16 to the bottom portion of the electrode 20(18) is set to be in a range from 0.2 [mm] to 1.2 [mm] inclusive, and preferably from 0.5 [mm] to 1.0 [mm] inclusive.

A protective film 22 having an average thickness of 2 [μm] has been formed on an inner surface of the glass bulb 16. Also, a phosphor layer 24 has been formed so as to overlap with the protective film 22. The protective film 22 is made from SiO₂ (silica). Note that the “average thickness” of the protective film 22 is the average circumferential thickness of a central portion in the tube axis direction. The average thickness is not limited to 2 [μm], and may vary in a range from 0.5 [μm] to 4 [μm] inclusive.

The length L6 from the inner end of the glass bulb 16 to the edge of the phosphor layer 24 (protective film 22) (in other words, the length, in the lengthwise direction, of an area on the inner surface of the glass bulb 16 on which the phosphor layer 22 has not been formed) is in a range from 2 [mm] to 10 [mm] inclusive, and preferably from 4 [mm] to 7 [mm] inclusive.

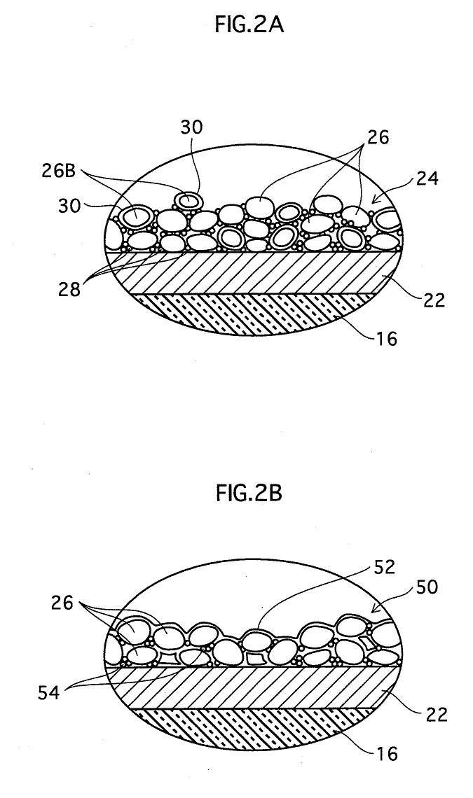

FIG. 2A shows a detailed view of section A of FIG. 1.

The phosphor layer 24 includes a plurality of phosphor particles 26 and a binding agent 28.

Each of the phosphor particles 26 is one of three types, the three types being red phosphor particles that emit red light, green phosphor particles that emit green light, and blue phosphor particles that emit blue light.

The red phosphor particles are composed of europium-activated yttrium oxide [Y₂O₃:Eu³⁺] (abbreviation: YOX), the green phosphor particles are composed of cerium and terbium activated lanthanum phosphate [LaPO₄:Ce³⁺,Tb³⁺] (abbreviation: LAP), and the blue phosphor particles are composed of europium-activated barium-magnesium aluminate BaMg₂Al₁₆O₂₇:Eu²⁺ (abbreviation: BAM), respectively.

Among these, blue phosphor particles 26B, as shown in FIG. 2A, are coated with a coating 30 made of lanthanum oxide (La₂O₃), shown as an example of a metal oxide. The form of the coating 30, as shown in FIG. 2A, is not limited to being a continuous film on the surface of the blue phosphor particles 26B, and may also be granule-shaped lanthanum oxide attached to the surface of the blue phosphor particles 26B. As described in “Background Art” above, the blue phosphor particles 26B are coated with lanthanum oxide to protect the blue phosphor particles 26B from mercury. Note that the coating 30 is not limited to lanthanum oxide, and may also be formed from another metal oxide, for example, yttrium oxide (Y₂O₃), alumina (Al₂O₃), calcium oxide (CaO), or silica (SiO₂).

The binding agent 28 is formed from CBBP (Ca₂P₂O₇, BaO, B₂O₃), shown as an example of an alkali earth metal borate. The binding agent 28 binds the phosphor particles to each other, and also affixes the phosphor particles 26 to the protective film 22. The weight percentage of the binding agent (CBBP) 28 in the phosphor layer 24 is preferably in a range from 1.3 [wt %] to 3.0 [wt %]. If less than 1.3 [wt %], a required adhesion strength (binding and affixing strength) cannot be achieved, and if more than 3.0 [wt %], there is a decline in the percentage of the ultraviolet radiation emitted from the mercury that reaches the phosphor particles. Also, the percentage of visible light generated by the phosphor particles to outside the lamp declines, and the required luminance cannot be achieved. Needless to say, when the adhesion strength is too slight, the phosphor layer 24 readily detaches. Note that CBBP is formed by adding P (calcium pyrophosphate) to CBB (CaO, BaO, B₂O₃).

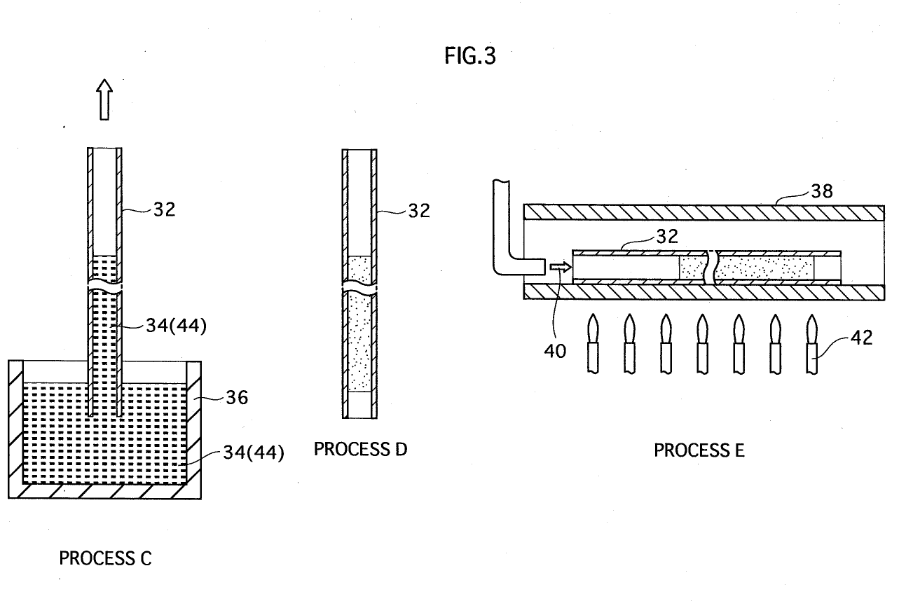

Next, among the processes for manufacturing the cold cathode fluorescent lamp 10 having the above structure, processes for forming the protective film 22 and the phosphor layer 24 are described with reference to FIG. 3. The methods for forming the protective film 22 and the phosphor layer 24 are basically the same, except that the application liquids (dispersion liquid, suspension liquid) are different.

First, in process C shown in FIG. 3, a dispersion liquid 34 is applied to an inner surface of the glass tube 32 that constitutes the glass bulb 16.

Specifically, a tank 36 containing the dispersion liquid 34 is prepared. The dispersion liquid 34 is powdered silica (SiO₂) dispersed in water. Note that powdered silica dissolved in alcohol may also be used as the dispersion liquid. The particle diameter of the silica is in a range from 0.01 [μm] to 0.1 [μm] inclusive.

The glass tube 32 is then held vertically so that the bottom end is immersed in the dispersion liquid 34. Due to the suction force of a vacuum pump, not depicted, on the top end of the glass tube 32, the air is discharged from the inside of the glass bulb 32, thereby creating a negative pressure inside the glass tube 32, and the dispersion liquid 34 is suctioned. The suction is stopped when the liquid level in the glass tube 32 reaches partway to the top end (a predetermined height), and the glass tube 32 is removed from the dispersion liquid 34.

In this way, the dispersion liquid attaches as a film to a predetermined area of the inner circumference of the glass tube 32.

After blowing dry air into the glass tube 32 to cause the dispersion liquid 34 attached in a film shape to dry (this process is not depicted), a portion of the dry film is removed from the vicinity of the end through which the dispersion liquid was suctioned in process C (process D).

Next, as shown in process E, the glass tube 32 is tilted horizontally and inserted into a quartz tube 38. While air 40 is being sent into the quartz tube 38, the glass tube 32 is heated from outside the quartz tube 38 by a heater 42, and sintered for approximately 15 [minutes]. The temperature of heating by the heater 42 is such that the inner circumference surface of the glass tube 32 is 630[° C.].

This sintering causes the protective film 22 that is made of silica to be formed on the inner surface of the glass tube 32.

After forming the protective film 22, the phosphor layer 24 is formed. The method of forming the phosphor layer 24 is basically the same as the method for forming the protective film 22 except that a suspension liquid 44 is used in place of the dispersion liquid 34, and in the drying process, the temperature of the warm air, sintering temperature and sintering time are different. Accordingly, the following description focuses on these differences.

The suspension liquid has been formed by adding a predetermined amount of phosphor particles, CBBP particles, and nitrocellulose (NC), as a thickener, to butyl acetate, as an organic solvent.

The mixture percentage of the three colors of phosphor particles is a weight ratio of 38.8 [wt %] blue phosphor particles, 28.8 [wt %] green phosphor particles, and 36.4 [wt %] red phosphor particles, to the total weight. Note that the weight of the blue phosphor particles includes the lanthanum oxide coating. In this case, the lanthanum oxide occupies a percentage from 0.1 [wt %] to 1.5 [wt %] inclusive, of the total weight of the phosphor particles. If less than 0.1 [wt %], the required luminance maintenance rate cannot be achieved, and if higher than 1.5 [wt %], the required initial luminance cannot be achieved. Note that results of an experiment to investigate the relationship between the ratio of lanthanum oxide and initial luminance are described later.

Nitrocellulose dissolved at a 2 [wt %] strength in a butyl acetate solution (nitrocellulose solution) is used as the nitrocellulose.

Letting the total weight of the phosphor particles be 100, the suspension liquid 44 has been mixed at a weight ratio such that nitrocellulose solution is 2 [wt %], CBBP is 1.5 [wt %], and butyl acetate is 60 [wt %]. Since nitrocellulose and butyl acetate are vaporized and consumed by the sintering process described later, the phosphor layer that is finally obtained is constituted from phosphor particles and CBBP. Accordingly, in the case of the above weight ratios, the ratio of CBBP that is present in the final phosphor layer is approximately 1.5 [wt %] [={(1.5)/(1.5+100)}×100]. Note that the percentage of CBBP present in the phosphor layer is not limited to being 1.5 [wt %], and may be adjusted as appropriate in a range from 1.3 [wt %] to 3 [wt %].

In the sintering process, the sintering temperature is 630[° C.] and the sintering time is 15 [minutes].

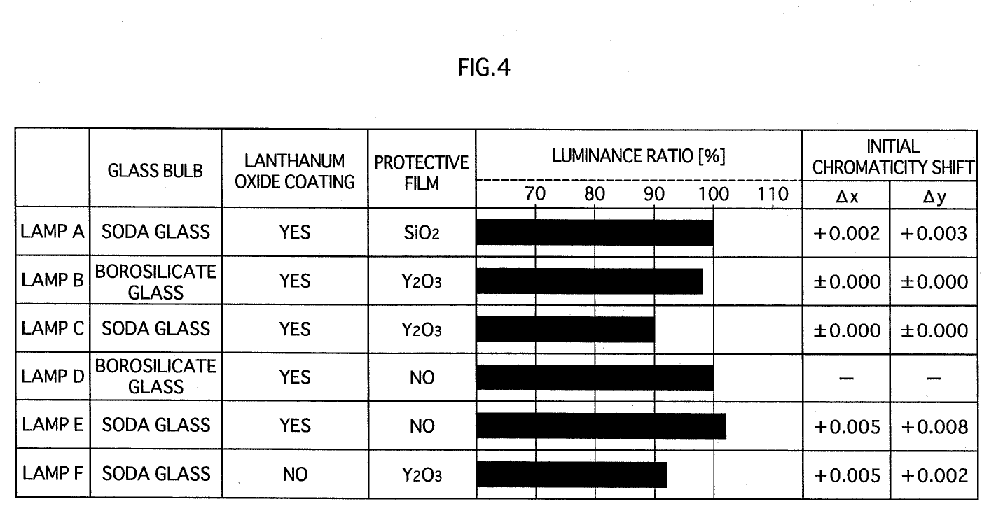

By the process described above, the inventors manufactured the cold cathode fluorescent lamp 10, formed from the protective film 22 and the phosphor layer 24, and cold cathode fluorescent lamps having different combinations of glass bulb materials and protective film materials, and conducted an experiment to compare the initial luminance and initial chromaticity shift of the lamps. In the experiment, the cold cathode fluorescent lamp 10 is referred to as “lamp A”. Also, the combinations of glass bulb materials and protective film materials of other cold cathode fluorescent lamps (lamps B to F), and the experiment results, are indicated in FIG. 4.

Lamps A to E basically have the same structure except that the glass bulb materials and protective film materials are different. Lamp F is a lamp that was manufactured for reference, and does not include a lanthanum oxide coating on the blue phosphor particles.

Five of each type of lamp were manufactured. The luminance (in this description defined as initial luminance) was measured in each lamp after 10 [minutes] had passed since first lighting the lamp, and for each type of lamp, an average of the five lamps was used in the comparison. Also, for each lamp, 10 [minutes] after lighting the lamp, the relative chromaticity difference from lamp D [Δx, Δy] (in this description, defined as initial chromaticity shift) was measured on the CIE 1931 chromaticity scale, and the average values of the five lamps were compared.

As described in “Problems Solved by the Invention”, based on the results indicated in FIG. 4, it was discovered that in lamps B and C in which the protective film is formed from yttrium oxide, the initial luminance of lamp C that was manufactured to have a glass bulb made of soda glass is approximately 10[%] lower than the initial luminance of lamp B that was manufactured using borosilicate glass.

On the other hand, in lamp A pertaining to embodiment 1, although the glass bulb is made of soda glass, an equivalent initial luminance to lamp B that is made of borosilicate glass can be achieved. It can be inferred that this fact is due to a difference in the protective film. This is apparent since lamps D and E that do not have protective films do not have a great difference in initial luminance due to using different glass bulb materials, and lamp E whose glass bulb was manufactured of soda glass actually had a slightly higher initial luminance. Since yttrium oxide (Y₂O₃) has a greater thermal conductivity than silica (SiO₂), yttrium oxide is readily influenced by heat when heated in the sintering process during manufacturing. Therefore, in lamp C that is provided with an yttria protective film, heat is readily transferred from the protective film to the glass bulb, and sodium ions on a portion of the glass bulb adjacent to the protective film readily disperse. Particularly in soda glass that has a high content ratio of sodium, since discoloration occurs when dispersed sodium ions and mercury ions become partially alloyed, this is likely to cause reduced initial luminance.

The reason for a difference in initial luminance between lamps C and F is thought to be that lamp F, in which the blue phosphor particles are not coated by lanthanum oxide, has a correspondingly higher initial luminance. However, since it has been confirmed that the luminance maintenance rate of lamp F is much less than lamps A, B, and C in which the blue phosphor particles are coated by lanthanum oxide, coating the blue phosphor particles with lanthanum oxide (or another metal oxide) is necessary.

An initial chromaticity shift that is less than or equal to 0.005 for each of Δx and Δy is preferable for implementation. Based on the results indicated in FIG. 4, lamp A pertaining to embodiment 1 was found to have a substantially equal chromaticity shift to lamps B and C, and in both the chromaticity shift is less than or equal to 0.005.

Note that FIG. 5 is a graph indicating results of a experiment on the relationship between hours passed since lighting the lamp [h] and luminance maintenance rate in lamps A, B, and C. As shown in FIG. 5, each of A, B, and C have substantially equal luminance maintenance rates.

Based on the above experiment results, even if soda glass is used as the glass bulb material, forming the protective film from silica (SiO₂) (lamp A) enables achieving an equal initial luminance to a lamp in which borosilicate glass is used as the material of the glass bulb and the protective film is formed from yttrium oxide (lamp B).

In this way, although the cold cathode fluorescent lamp 10 is superior in terms of initial luminance and luminance maintenance rate, in terms of the property of blocking ultraviolet radiation, soda glass is inferior to borosilicate glass. When used as a light source for a backlight unit as described later, measures against ultraviolet radiation are necessary for the reasons described below. The diffusion plate that is a constituent element of the backlight unit has been mainly formed from acrylic resin until recently. However, the properties of acrylic resin include having a comparatively low mechanical strength, expanding and contracting readily due to variations in the surrounding environment such as temperature and humidity, and having poor dimensional stability. For these reasons, in recent years, as liquid crystal display devices such as liquid crystal televisions and the like tend to have larger and larger screens, using acrylic resin for the diffusion plate has become more difficult. Thus, polycarbonate resin that has superior mechanical strength and dimensional stability is now used in place of acrylic resin. However, the properties of polycarbonate resin include readily degrading upon exposure to ultraviolet radiation. Note that among the ultraviolet radiation released from the phosphor lamp, the cause of degradation is particularly 313 [mm] wavelength ultraviolet radiation.

Since cerium compounds and titanium compounds have a property of absorbing ultraviolet radiation, one possibility is to make use of this property by forming an ultraviolet radiation blocking film, composed only of cerium and titanium compounds, on the inside of the glass bulb. However, since cerium compounds and titanium compounds also have a property of blocking visible light, if the film is thick enough to be sufficiently effective in blocking ultraviolet radiation, decreased luminance is a problem. Note that forming the ultraviolet radiation barrier film at a film thickness of 0.2 [μm] enables completely blocking 313 [nm] wavelength radiation.

Thus, the inventors of the present invention dissipated a cerium compound or a titanium compound in a protective film made of silica (SiO₂).

Specifically, cerium oxide (CeO) or titanium oxide (TiO₂) was dissipated in a protective film having a film thickness averaging 2 [μm], in a range from 1 [wt %] to 20 [wt %].

The following describes results of an experiment to investigate the relationship, referred to previously, between initial luminance and the ratio of lanthanum oxide to total phosphor weight.

The inventors of the present invention manufactured lamps having the structure of lamp A described above and different weight ratios of lanthanum oxide to total weight of the phosphor particles (hereinafter referred to as “content ratios”), and performed an experiment to investigate the initial luminance of each lamp. The nine content ratios of lanthanum oxide to total weight of the phosphor particles were 0 [wt %], 0.1 [wt %], 0.3 [wt %], 0.5 [wt %], 0.6 [wt %], 0.9 [wt %], 1.2 [wt %], 1.5 [wt %], and 1.8 [wt %]. Note that the weight ratio of blue phosphor particles (BAM), red phosphor particles (YOX), and green phosphor particles (LAP) in the phosphor particles was 2:1:1.

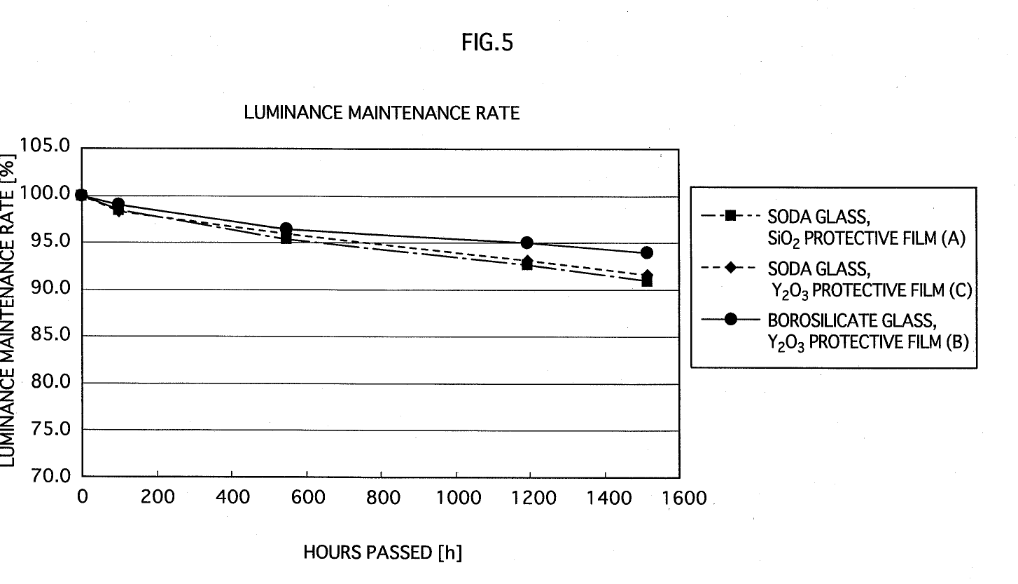

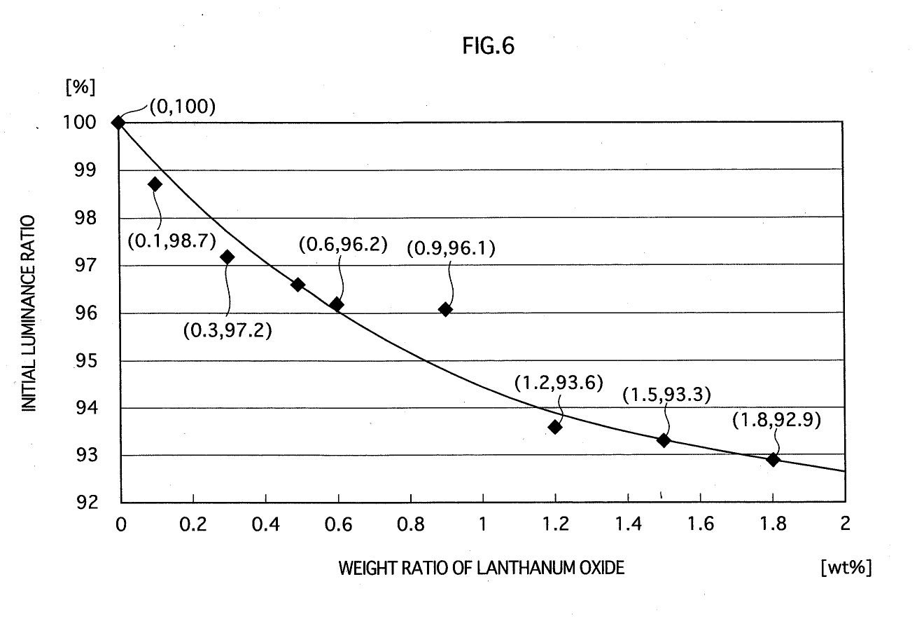

The results of the experiment are shown in FIG. 6. FIG. 6 is a drawing that shows the content ratio of lanthanum oxide on the horizontal axis, and an initial luminance (initial luminance ratio) corresponding to each content ratio on the vertical axis, where the initial luminance is 100[%] when the content ratio of lanthanum oxide is 0. Note that the coordinate values of each plotted point are displayed side by side in parentheses. According to FIG. 6, the content ratio of lanthanum oxide is preferably less than or equal to 1.5 [wt %]. This is because a content ratio of less than or equal to 1.5 [wt %] lanthanum oxide enables increasing the initial luminance more than 93[%] over when lanthanum oxide is not included. A content ratio of less than or equal to 0.9 [wt %] lanthanum oxide is even more preferable. This is because a content ratio of less than or equal to 0.9 [wt %] lanthanum oxide enables increasing the initial luminance more than 96[%] over when lanthanum oxide is not included.

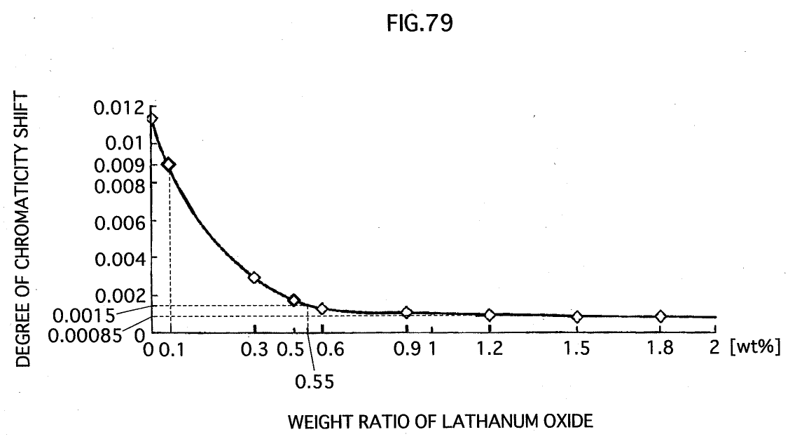

FIG. 79 is a drawing that shows the weight ratio [wt %] of lanthanum oxide to the total weight of phosphor particles in the phosphor layer on the horizontal axis, and degree of chromaticity shift on the vertical axis. Here, the degree of chromaticity shift refers to the extent of slippage between an actual CIE chromaticity coordinate value (x₁,y₁) of a CIE chromaticity coordinate (x,y) and a target value (set value). Therefore, where the target CIE chromaticity value is expressed as (x₀,y₀), the chromaticity shift is expressed as (Δx²+Δy²)^{1/2} (Δx=x₀−x₁, Δy=y₀−y₁). Also, upon investigating direct and indirect visual influences of light from a lamp due to chromaticity shift, the inventors found that a chromaticity shift (Δx²+Δy²)^{1/2} of over 0.01 causes the color of the lamp to turn yellowish, and for example when used for a backlight of a liquid crystal display apparatus, has a negative influence on color reproduction on the liquid crystal display screen, and is not preferable. According to this finding, as illustrated by FIG. 79, when the content ratio of lanthanum oxide is 0.1 [wt %], the degree of chromaticity shift (Δx²+Δy²)^{1/2} is 0.009, and to prevent chromaticity shift in the light of the lamp, the content ratio of lanthanum oxide is preferably greater than or equal to 0.1 [wt %]. Also, a content ratio of greater than or equal to 0.3 [wt %] is even more preferable, since the chromaticity shift in the light from the lamp can be further suppressed.

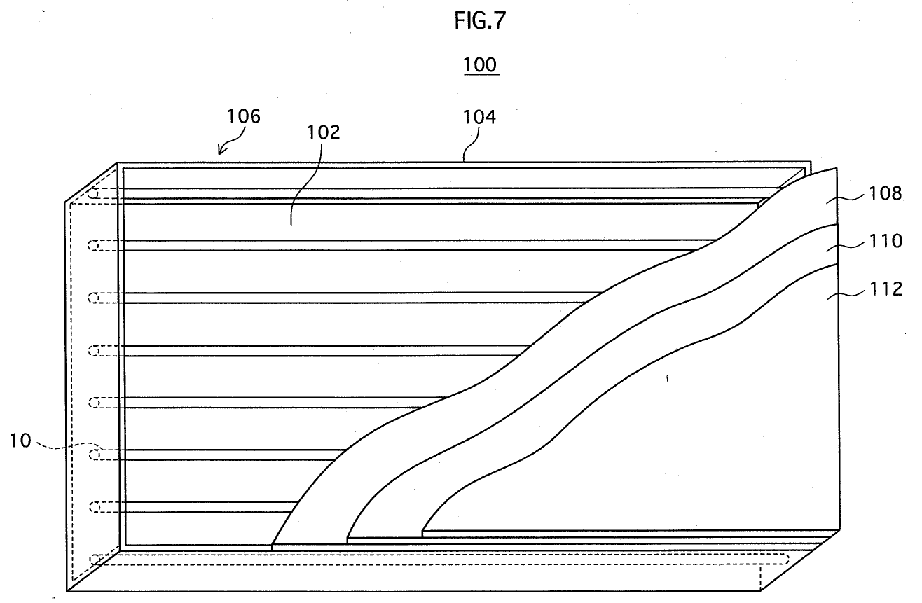

FIG. 7 is a perspective view of a schematic structure of a backlight unit 100 that includes the cold cathode fluorescent lamp 10. Note that FIG. 7 shows a cut-away view of a diffusion plate 108, a diffusion sheet 110, and lens sheet 112, described later.

The backlight unit 100 includes an outer case 106 that is constituted from a rectangular reflective plate 102 and side plates 104 that enclose the reflective plate 102. A reflective film (not depicted) has been formed on the reflective plate 102 and the side plates 104, the reflective film being made from silver, etc. that has been vapor-deposited on the plate material that is PET (polyethylene terephthalate) resin.

As the light source, a plurality of cold cathode fluorescent lamps 10 (8 lamps in the present example) are stored parallel to the long side of the reflective plate 102 inside the outer case 106 so that there are equivalent intervals in the direction of the short side.

Also, the diffusion plate 108 made from polycarbonate resin, the diffusion sheet 110 made from acrylic resin, and the lens sheet 112 made from polyester resin are provided in an open portion of the outer case 106.

Next, as an example of a liquid crystal display apparatus, a liquid crystal television using the backlight unit 100 is shown.

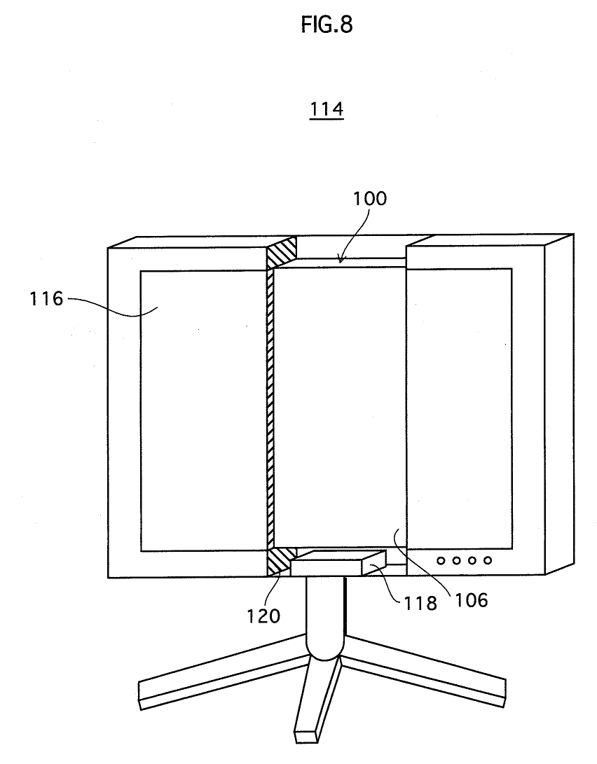

FIG. 8 shows the liquid crystal television 114 having a front portion cut away. The liquid crystal television 114 shown in FIG. 8 includes a liquid crystal display panel 116, a backlight unit 100, etc.

The liquid crystal display panel 116 is constituted from a color filter substrate, liquid crystals, a TFT substrate, etc., and forms a color image in accordance with an external image signal with use of a drive module (not depicted). The outer case 106 of the backlight unit 100 is provided behind the liquid crystal display panel 116, and illuminates the liquid crystal display panel 116 from behind.

An inverter 118 for lighting the cold cathode fluorescent lamps 10 is provided inside a housing 120 of the liquid crystal television 114 and outside the outer case 106.

This concludes the description of embodiment 1 of the present invention. However, the present invention is of course not limited to this, and variations such as the following are also included in the present invention.

(1) Although in embodiment 1, only the blue phosphor particles in the phosphor layer are covered with metal oxide (lanthanum oxide), the present invention is not limited to this, and the phosphor layer may be formed so that metal oxide also covers the red phosphor particles and the green phosphor particles.

Since a similar method for forming the phosphor layer is disclosed in the Japanese re-publication of PCT International Patent Application No. WO 2002/047112, a description of the details is omitted. Other than adding a metal oxide to the suspension liquid, the method for forming this type of phosphor layer is basically the same as the method for forming the phosphor layer in embodiment 1.

When coating the phosphor particles with yttrium oxide, the suspension liquid is made by adding a predetermined amount of phosphor particles, yttrium carbonate [Y(CₙH₂ₙ₊₁COO)₃] as a yttrium compound, CBB particles, and nitrocellulose (NC) as a thickener to butyl acetate as an organic solvent.

FIG. 2B shows an enlarged cross-section of a portion of a phosphor layer of a cold cathode fluorescent lamp and the vicinity thereof, the cold cathode fluorescent lamp having a phosphor layer 50 formed by applying, drying, and sintering the suspension liquid. Every color of the phosphor particles 26 has been coated with a coating 52 made of yttrium oxide. As shown in FIG. 2B, among the plurality of (innumerable) phosphor particles 26, some have been coated with the coating 52 over the entire surface, and although not depicted, some have been coated with the coating 52 on a portion of the surface, and the remaining portion of the surface is exposed. However, whether in whole (completely) or in part, the phosphor particles are covered by the coating 52. Also, the phosphor particles 26 have mainly been bonded together with use of a bonding agent 54.

Also, the inventors of the present invention manufactured fluorescent lamps having different total weight ratios of yttrium oxide “A” and total weight ratios of CBB “B”, where the total weight ratio of phosphor particles has been set at “100”, performed experiments and observation from the standpoint described below, and demarcated a preferable range for “A” and “B”. Detailed data is omitted here, and only the results only described below.

(i) An experiment was performed concerning the existence of phosphor layer fallout when the fluorescent lamp receives an impact externally (impact experiment).

As a result, the inventors found that defects in the phosphor layer do not readily occur when 0.1≦A, or 0.1≦B, and 0.4≦(A+B).

(ii) When the glass container was viewed from the outside, the color appeared to have changed to pale brown, and the inventors of the present invention found that this was the cause of decreased luminance. The inventors inferred that this is due to the following reason. A hydrocarbon, generally expressed as CₙH₂ₙ₊₂, is produced during the sintering part of the manufacturing process. Meanwhile, the CBB melts and vitrifies, at which point the CBB is likely to be absorbed into the hydrocarbon and to change to a brown color.

Here, compared to a conventional fluorescent lamp that uses only CBB as the bonding agent, a reduced luminance of more than 3[%] is considered unsatisfactory, and a reduced luminance of less than or equal to 3[%] is considered satisfactory.

As a result, it was found that from the standpoint of preventing decreased luminance, a preferable range is A≦0.6, or B≦0.6, and (A+B)≦0.7.

Therefore, from the two standpoints of preventing defects in the phosphor layer and preventing decreased luminance, yttrium oxide and CBB are mixed in a range such that 0.1≦A≦0.6 (or 0.1≦B≦0.6), and 0.4≦(A+B)≦0.7.

(2) Also, the phosphor layer may be formed in the following way. First, a layer (phosphor preparatory layer) is formed in accordance with a manufacturing method including the application, drying, and sintering processes described above, by using CBB in the range described in (1), (0.1≦B≦0.6), or only using yttrium oxide and phosphor particles and not using CBB. Thereafter, the suspension fluid made from butyl acetate, nitrocellulose, and CBB particles is applied and caused to saturate the phosphor preparatory layer, and then the phosphor layer is formed by drying and sintering the phosphor preparatory layer. According to the above, the amount of CBB can be increased to the extent that discoloration does not occur and the luminance is not reduced, thereby exhibiting more thorough prevention of defects in the phosphor layer.

(3) Although embodiment 1 describes a cold cathode fluorescent lamp (CCFL) as an example, the present invention is not limited to this, and is also applicable to a so-called external electrode fluorescent lamp (EEFL). The external electrode fluorescent lamp is a fluorescent lamp that has external electrodes provided on, for example, the outer circumference of both ends of the glass bulb, instead of having internal electrodes, and is a type of dielectric barrier discharge lamp that uses a glass tube wall for capacitance.

Also, the present invention is applicable to a hot cathode fluorescent lamp (HCFL) having a hot cathode as an internal electrode.

(4) Although silica (SiO₂) forms the protective film in embodiment 1, alumina (Al₂O₃) may also be used.

### Embodiment 2

In existing cold cathode fluorescent lamps in general use, the glass bulb is filled with a mixed gas whose partial pressure ratio of neon (Ne) gas is 95[%] and whose partial pressure ratio of argon (Ar) gas is 5[%], at a pressure of 60 [Torr]. It is known that lowering the pressure of the mixed gas improves luminous efficiency. However, when the charged pressure of the mixed gas is simply lowered, the luminance maintenance rate is reduced and the life is shortened.

In view of the above problem, embodiment 2 aims to provide a cold cathode fluorescent lamp that further increases luminous efficiency and does not pose any problems in terms of luminance maintenance rate when used to replace an existing cold cathode fluorescent lamp, and a backlight unit that uses the cold cathode fluorescent lamp as a light source.

The following describes embodiment 2 with reference to the drawings.

Note that mainly, other than the charged pressure of the mixed gas and the formation area of the phosphor layer (protective film) being different, a cold cathode fluorescent lamp 10A pertaining to embodiment 2 basically has the same structure as the cold cathode fluorescent lamp 10 of embodiment 1. Also, the backlight unit, apart from the cold cathode fluorescent lamp, has a similar structure to the backlight unit of embodiment 1. Accordingly, in embodiment 2, structural elements that are substantially equal to embodiment 1 have been given the same reference notations, and description thereof is omitted.

### 1. Structure of the Direct-Type Backlight Unit

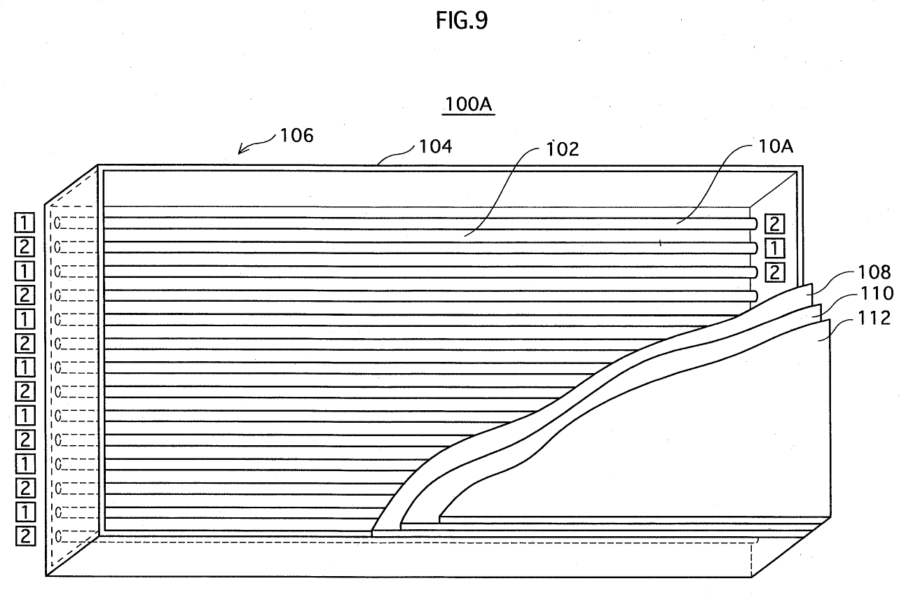

FIG. 9 is a perspective view of a schematic structure of a direct-type backlight unit 100A pertaining to embodiment 2, and is drawn similarly to FIG. 7.

The lamps 10A have a straight-tube shape, and fourteen of the lamps 10A are disposed alternately, having a predetermined interval therebetween, so that the axis in the length direction of the straight tube substantially conforms to the length direction (horizontal direction) of the outer case 106. Note that the meaning of “alternately” is described later.

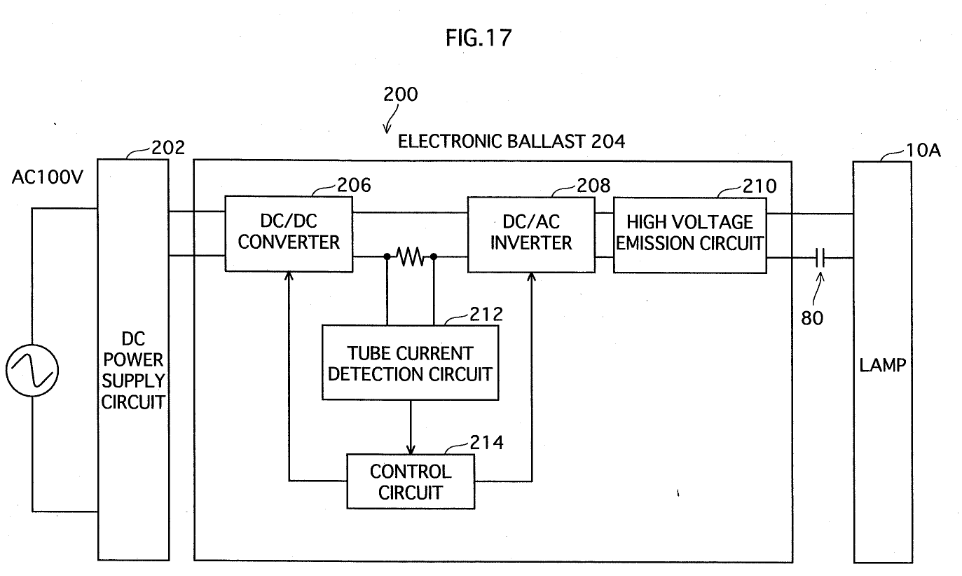

These lamps 10A are lit by a lighting apparatus 200 (FIG. 17) that is one of the constituent elements of the backlight unit 100A. The lighting apparatus 200 is described later.

### 2. Structure of the Cold Cathode Fluorescent Lamp and the Lighting Apparatus

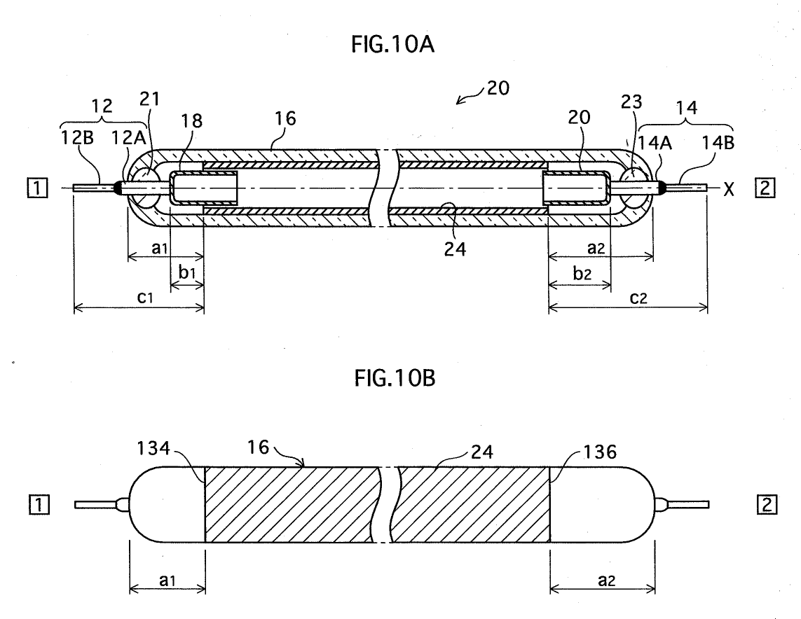

Next, the structure of the cold cathode fluorescent lamp 10A of embodiment 2 is described with reference to FIG. 10.

FIG. 10A shows a schematic structure of the cold cathode fluorescent lamp 10A having one portion cut away. FIG. 10B is a pattern diagram of an area on the glass bulb 16 on which the phosphor layer 24 has formed. Note that although the phosphor layer 24 has been formed so as to overlap the protective film as in embodiment 1, depiction of the protective film has been omitted from the drawings pertaining to embodiment 2, and the protective film is not referred to in the description.

Mercury in the glass bulb 16 occupies a predetermined ratio of the cubic capacity of the glass bulb 16, for example, such that the glass bulb 16 is filled to 0.6 [mg/cc], and the glass bulb 16 is filled to a predetermined filling pressure, for example 60 [Torr], with a noble gas such as argon or neon. Note that a mixed gas of argon and neon (Ar-5[%], Ne-95[%]) is used as the noble gas.

The phosphor layer 24 is uneven in the lengthwise direction of the glass bulb 16, and is for example thicker towards the second sealed portion side than the first sealed portion side. This unevenness in film thickness influences the light emitting property of the lamps 10A when lit.

Here, as described previously, decreasing the charged pressure of the noble gas is generally thought to improve the lamp efficiency. To confirm this, the inventors of the present invention performed an experiment to investigate how charged pressure influences efficiency.

The outer diameter of the glass bulb of the cold cathode fluorescent lamp used in the experiment is 3 [mm], the inner diameter is 2 [mm], and the total length is 450 [mm]. Also, the glass bulb has been filled with a mixed gas including neon and argon at a partial pressure rate of 90[%] and 10[%] respectively.

Cold cathode fluorescent lamps having different charged pressures (total pressures) of the noble mixed gas at 25[° C.] were manufactured. There were five types of charged pressure, 10 [Torr], 20 [Torr], 40 [Torr], 60 [Torr], and 80 [Torr]. There were also four types of drive current flowing in the cold cathode fluorescent lamps for the various charged pressures, 4 [mA], 6 [mA], 8 [mA], and 10 [mA]. In view of the temperature environment in the backlight unit, the surrounding temperature when the lamps are lit was set at 50[° C.].

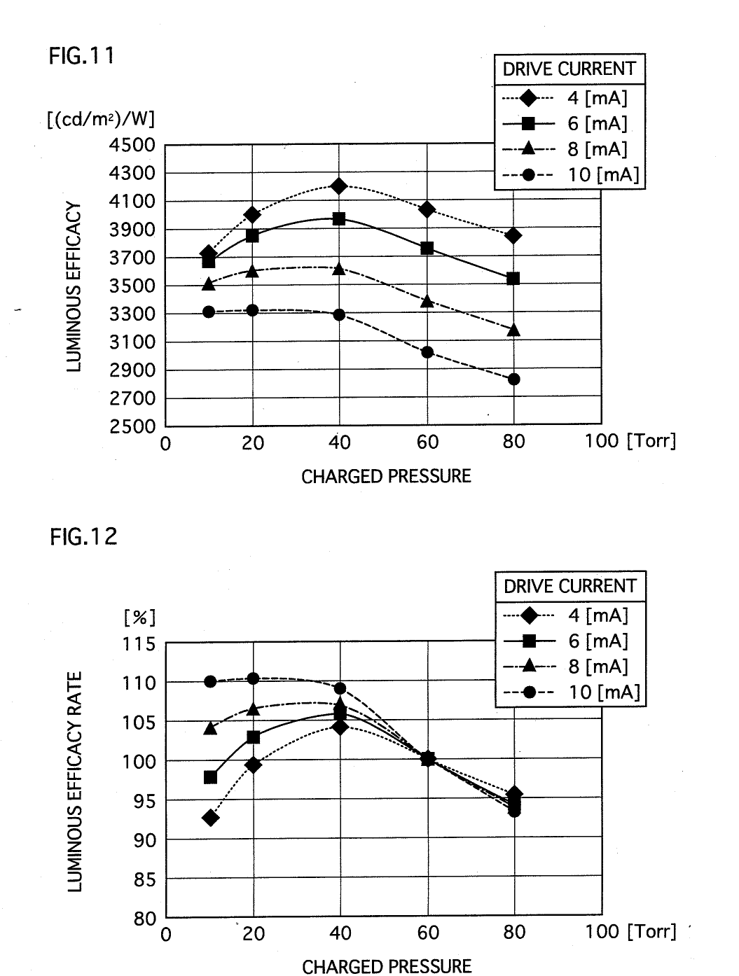

FIG. 11 shows the results of the experiment. Note that the efficiency [cd/m²] acquired from the cold cathode fluorescent lamps is divided by input power [W] to arrive at the luminance values in FIG. 11.

FIG. 11 illustrates that when the drive current is 10 [mA], the luminous efficacy gradually improves as the charged pressure is lowered from 80 [Torr] to 40 [Torr], leveling off at 40 [Torr].

On the other hand, when the drive current is 8 [mA], 6 [mA], or 4 [mA], lowering the charged pressure from 80 [Torr] results in gradually improved efficiency until 40 [Torr] is reached, at which point worsening of the efficiency can be seen. This shows that although lowering the charged pressure was generally thought to improve luminous efficiency, depending on the drive current, lowering the charged pressure too much can actually decrease luminous efficiency.

Since the charged pressure of the mixed gas in existing cold cathode fluorescent lamps is 60 [Torr], FIG. 12 was created based on FIG. 11 to illustrate to what extent luminous efficiency at 60 [Torr] differs in accordance with differences in charged pressure (and current). Here, a cold cathode fluorescent lamp whose charged pressure is 60 [Torr] is hereinafter referred to as a “reference lamp”.

FIG. 12 is a graph showing a percentage analysis of drive current values at various charged pressures compared to when the charged pressure is 60 [Torr].

FIG. 12 illustrates that to improve the luminous efficiency by 5[%] or more over the reference lamp when the drive current is 10 [mA], the charged pressure should be set at 50 [Torr] or less, for example. Also, for example, when the charged pressure is 40 [Torr], a drive current of 4 [mA] is not enough to improve the luminous efficiency by 5[%] or more over the reference lamp, and a drive current of 6 [mA] is enough. In other words, adjusting the combination between the charged pressure and the drive current enables improving the luminous efficiency by a predetermined rate over the reference lamp.

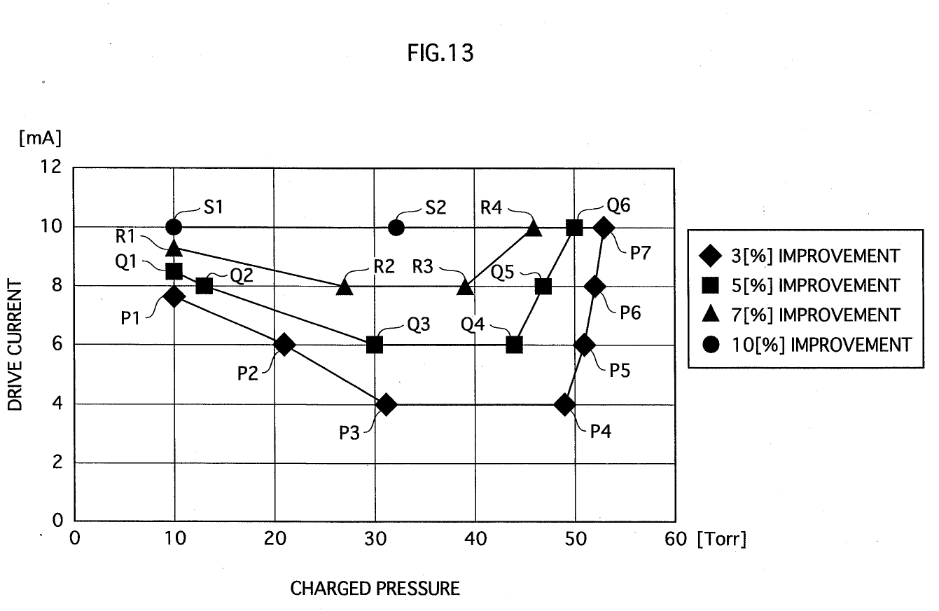

FIG. 13 was created based on FIG. 12 to show a range of values for each predetermined ratio when emission efficiency is improved over the reference lamp by at least the predetermined ratio, on an x-y orthogonal coordinate system in which charged pressure [Torr] of the mixed gas is plotted on the x axis and drive current values [mA] are plotted on the y axis. Here, the predetermined rates are set to be 3[%], 5[%], 7[%], and 10[%].

FIG. 13 shows a range of values for each predetermined ratio when emission efficiency is improved over the reference lamp by at least the predetermined ratio, on an x-y orthogonal coordinate system in which charged pressure [Torr] of the mixed gas is plotted on the x axis and drive current values [mA] are plotted on the y axis.

For example, in FIG. 13, when a combination of charged pressure and drive current value is in a range enclosed by a line drawn sequentially between points S1 “” (a black circle) to “♦” (a black diamond), the efficiency is improved by at least 3[%] over the reference lamp. Specifically, when a combination of charged pressure and drive current value is in a range enclosed by a line drawn sequentially between point S1, P1 to P7 and S1 (including the line), the luminous efficiency is improved by at least 3[%] over the reference lamp.

Similarly, in FIG. 13, when a combination of charged pressure and drive current value is in a range enclosed by a line drawn sequentially between points S1, points Q1 to Q6 and S1 (including the line), the efficiency is improved by at least 5[%] over the reference lamp.

Also, in FIG. 13, when a combination of charged pressure and drive current value is in a range enclosed by a line sequentially connecting point S1 to points R1 and R6 (including the line), the luminous efficiency is improved by at least 7[%] over the reference lamp.

Furthermore, in FIG. 13, when a combination of charged pressure and drive current value is set to have a value that is on a line segment connecting point S1 to point S2, the efficiency is improved by at least 10[%] over the reference lamp.

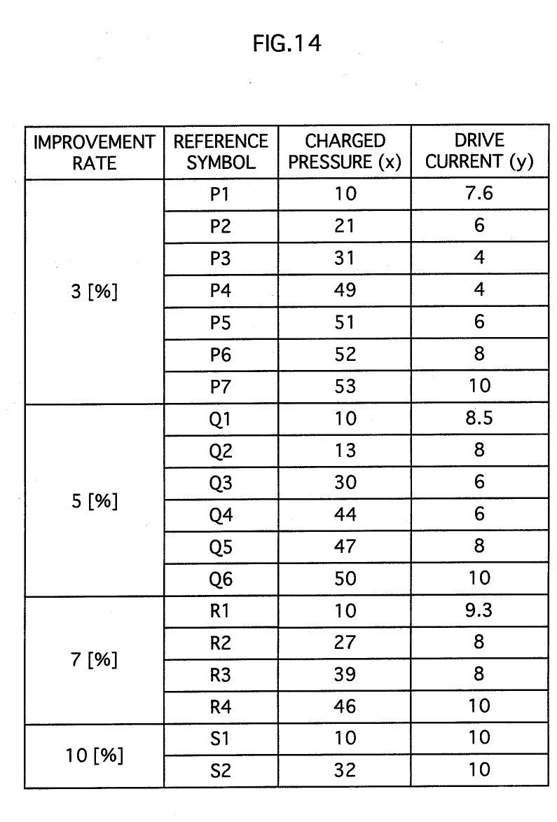

The values of the coordinate points are shown in FIG. 14.

For example, a case of improving the luminous efficiency 7[%] over the reference lamp, based on the coordinate values shown in FIG. 14, is described below. In the x-y orthogonal coordinate system, when the charged pressure [Torr] of the mixed gas that fills the glass bulb in the cold cathode fluorescent lamp is plotted on the x axis, and the value of the drive current [mA] that flows into the cold cathode fluorescent lamp is plotted on the y axis, in a range enclosed by a line sequentially connecting the points represented by (x,y) coordinates S1 (10,10), R1 (10,9.3), R2(27,8), R3(39,8), R4(46,10), S1(10,10) (including the line), a cold cathode fluorescent lamp can be achieved whose luminous efficiency has been improved by a rate of at least 7[%].

As described above, reducing the charged pressure in an appropriate range below the reference lamp (having a charged pressure of 60 [Torr] improves efficiency. However, it was found that when the charged pressure is reduced, the luminance maintenance rate decreases. Therefore, by performing this experiment, the inventors of the present invention discovered that a decrease in the luminance maintenance rate can be suppressed by adjusting the partial pressure rate of argon gas in the mixed gas.

The present experiment was performed at a drive current of 8 [mA] in an environment having a surrounding temperature of 25[° C.], with use of a cold cathode fluorescent lamp having a glass bulb whose outer diameter is 3.4 [mm], inner diameter is 2.4 [mm], and total length is 450 [mm].

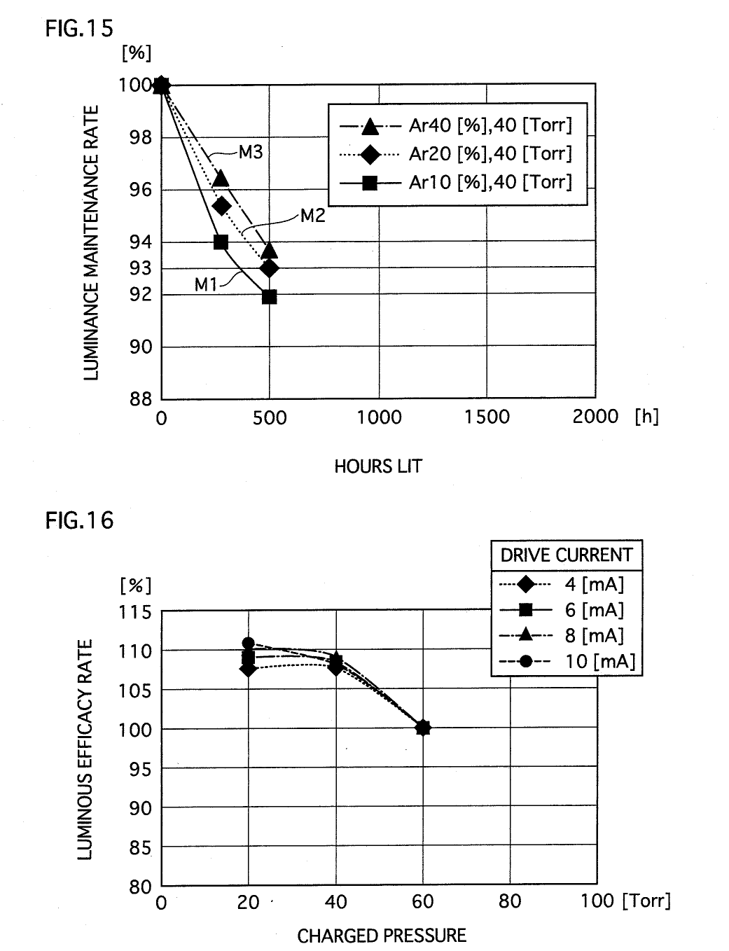

The results of the experiment are shown in FIG. 15.

In FIG. 15, an arc M1 between points indicated by “▪” (black squares) is a luminance maintenance rate arc of a cold cathode fluorescent lamp filled with a mixed gas of 10[%] argon and 90[%] neon at a charged pressure of 40 [Torr].

Similarly, an arc M2 between points indicated by “♦” (black diamonds) is a luminance maintenance rate arc of a cold cathode fluorescent lamp filled with a mixed gas of 20[%] argon and 80[%] neon at a charged pressure of 40 [Torr].

Similarly, an arc M3 between points indicated by “▴” (black triangles) is a luminance maintenance rate arc of a cold cathode fluorescent lamp filled with a mixed gas of 40[%] argon and 60[%] neon at a charged pressure of 40 [Torr].

FIG. 15 illustrates that the luminance maintenance rate varies in accordance with the partial pressure rate of argon.

Here, there is a practical demand for the luminance maintenance rate to be greater than or equal to 93[%] after 500 hours have passed, and the existing lamp noted in the “background art” column satisfies this demand.

Accordingly, in view of this, making the partial pressure rate of argon gas in the mixed gas greater than or equal to 20[%], that is to say, mixing argon gas in the gas that fills the lamp at a partial pressure rate greater than or equal to 20[%], can practicably achieve a satisfactory luminance maintenance rate, and does not pose any problems in terms of luminance maintenance rate when used to replace an existing lamp.

As described above, the range of combinations of charged pressure of the mixed gas and drive current for improving luminous efficiency by a predetermined percentage over the reference lamp (the mixed gas being at a charged pressure of 60 [Torr]) can be demarcated based on the experiment results shown in FIG. 13. Also, in view of the luminance maintenance rate, the partial pressure rate of the argon gas in the mixed gas has been set to be greater than or equal to 20[%].

Here, since the experiment results shown in FIG. 13 are based on a cold cathode fluorescent lamp including argon gas at a partial pressure rate of 10[%], achieving efficiency in the range of the above combinations is thought to pose a problem. Therefore, an experiment related to luminous efficiency was also performed on a cold cathode fluorescent lamp whose partial pressure rate of argon gas is 40[%].

The experiment was performed in an environment having a surrounding temperature of 50[° C.], with use of a cold cathode fluorescent lamp having a glass bulb whose outer diameter is 3.4 [mm], inner diameter is 2.4 [mm], and total length is 450 [mm].

The results of the experiment are indicated in FIG. 16. FIG. 16 corresponds to the above-referenced FIG. 12.

A comparison between FIG. 12 and FIG. 16 illustrates that when the partial pressure rate of argon gas is increased from 10[%] (FIG. 12) to 40[%] (FIG. 16), there is an overall improvement in a percentage analysis of efficiency over a baseline charged pressure of 60 [Torr]. Specifically, FIGS. 12 and 16 illustrate that the luminous efficiency also varies depending on the partial pressure rate of argon, and the luminous efficiency increases proportionately to the amount of argon in the mixed gas (the partial pressure rate).

Accordingly, when the range of combinations of charged pressure of the mixed gas and drive current has been demarcated according to FIG. 13, the partial pressure rate of argon gas is 10[%] and the efficiency is low, a higher luminous efficiency can be achieved by raising the partial pressure of argon gas higher (over 10[%]). Accordingly, demarcating the range of combinations of charged pressure of mixed gas and drive current according to FIG. 13 is not a problem.

Next, the lighting apparatus for lighting the cold cathode fluorescent lamp 10A is described.

FIG. 17 is a block diagram showing a structure of a lighting apparatus 200 for lighting a cold cathode fluorescent lamp 10A. Note that although only one of the cold cathode fluorescent lamps 10A is depicted in FIG. 17, a plurality of cold cathode fluorescent lamps 10A are connected in parallel in the lighting apparatus 200. Also, one of the lead wires of the cold cathode fluorescent lamps 10A is electrically connected to the lighting apparatus 200 via a ballast capacitor 80 that is provided in each one of the plurality of cold cathode fluorescent lamps 10A. The ballast capacitor 80 enables causing the plurality of cold cathode fluorescent lamps 10A to be lit in parallel by an electronic ballast (inverter) 204 described below.

As shown in FIG. 17, the lighting apparatus 200 is constituted from a DC power supply circuit 202 and the electronic ballast 204. The electronic ballast 204 is constituted from a DC/DC converter 206, a DC/AC inverter 208, a high voltage generation circuit 210, a tube current detection circuit 212, and a control circuit 214.

The DC power supply circuit 202 generates direct current voltage from a commercial alternating current power supply (100V), and supplies power to the electronic ballast 204. The DC/DC converter 206 converts the direct current voltage to a predetermined size of direct current voltage, and supplies power to the DC/AC inverter 108. The DC/AC inverter 108 generates an alternating rectangular current having a predetermined frequency and sends the alternating rectangular current to the high voltage generation circuit 210. The high voltage generation circuit 210 includes a transformer (not depicted), and the high voltage generated by the high voltage generation circuit 210 is applied to the cold cathode fluorescent lamps 10A.

Meanwhile, the tube current detection circuit 112 is connected to the input side of the DC/AC inverter 208, indirectly detects the lamp current (drive current) of the cold cathode fluorescent lamps 10A, and sends the detection signal to the control circuit 214. In accordance with the detection signal, the control circuit 214 refers to the reference current value set in an internal memory (not depicted), and controls the DC/DC converter 206 and the DC/AC inverter 208 so as to light the cold cathode fluorescent lamps 20 at the set current of the reference current value.

Accordingly, setting the reference current value of the internal memory to a drive current value demarcated according to FIG. 13 drives the cold cathode fluorescent lamps 10A at the drive current value (reference current value) of the predetermined current.

Returning to FIG. 10, as shown in FIGS. 10A and 10B, on the first sealed portion side of the glass bulb 16, b2 is longer than b1 (b2>b1) where b1 is the distance from a boundary 134 (a border between the phosphor layer area, where the phosphor layer 24 exists, and the non-phosphor layer area, where the phosphor layer 24 does not exist) and the base of the electrode 18, and b2 is the distance from a boundary 136 to the base of the electrode 20. The base of the electrode referred to here is the base portion where the electrode 18(20) is fixed to the lead wire 12(14).

Note that as a result of the positions of members other than the phosphor layer 24, namely the electrodes 18 and 20 and lead wires 12 and 14, being provided symmetrically on both the left and the right ends, c2 is longer than c1 (c2>c1) where c1 and c2 are the distances from the boundaries 134 and 136 to outer tips of the outer lead wires 12B and 14B, respectively.

Also, a2 is longer than a1 (a2>a1) where a1 is the distance from the boundary 134 to the end on the first sealed portion side (length of the non-phosphor layer area) and a2 is the length from the boundary 136 to the end on the second sealed portion side.

For example, the measurements thereof are as follows.

a1=8.0 [mm], a2=10.0 [mm], b1=5.0 [mm], b2=7.0 [mm], c1=14.0 [mm], and c2=16.0 [mm].

The following describes the reason for making the lengths between b1 and b2 different.

As described above, a phosphor layer has been formed on an inner face of a glass bulb. The phosphor layer has an uneven thickness in the lengthwise direction of the glass bulb. Since the fluorescent lamps used in backlight units are of a thin type whose a tube inner diameter is from 1.4 [mm] to 7.0 [mm], and whose thickness is from 0.2 [mm] to 0.6 [mm], the phosphor layer is particularly prone to unevenness.

Specifically, with respect to the lengthwise direction of the glass bulb, the film thickness of the phosphor layer is thick at one end and thin at the other end. When the lamps are lit, the difference in film thickness of the phosphor layer is expressed as a difference in luminance, and may result in luminance irregularities.

For this reason, in direct type backlight units, luminance irregularities are suppressed by alternating the lengthwise orientation of adjacent fluorescent lamps when installing the fluorescent lamps inside the housing.

“Alternated” means that, in adjacent ones of the lamps 10A each having a first sealed portion and a second sealed portion, the first sealed portions are on opposite ends from each other, and the second sealed portions are on opposite ends from each other. In FIGS. 9, 10, 18, 19 and 22, the first sealed portions and the second sealed portions of the lamps 10A are distinguished by boxed numbers “1” and “2”, respectively.

In a conventional manufacturing method for backlight units, an operator visually confirms an identifying mark (a lot number, etc.) that is provided on only one end of each lamp, detects lengthwise orientation, and arranges the lamps in the housing.

However, the conventional method using identifying marks requires a process and equipment for applying the identifying marks, thereby leading to higher costs.

Also, the conventional method is not well suited to automation of labor.

Therefore, the lengths b1 and b2 have been made different to provide a method for manufacturing the direct type backlight unit in which the orientation of a fluorescent lamp can be automatically detected by a simple method and a process and equipment for detecting identifying marks are not necessary.

Specifically, since b2 is longer than b1 as described above, the lengthwise orientations of the fluorescent lamps 10A (the glass bulb 16) pertaining to the present invention can be detected by using a sensor to detect whether either b2 or b1 fits in a predetermined range, or by using the sensor to detect the distances b2 and b1 and then obtaining a difference between the two distances. It is also possible to suppress costs since the process and equipment for applying identifying marks is unnecessary.

Also, since the phosphor layer 24 has been formed around the entire circumference of the glass bulb 16, detection can be performed from a single direction regardless of the revolution direction (rotation direction) of the glass bulb 16, and the structure of the sensing equipment can be simplified.

Furthermore, using the distance from the boundary between the phosphor layer area and the non-phosphor area to structural parts of the lamps such as electrodes and lead wires for detection enables structural parts generally provided in lamps to be used effectively for detecting orientation.

Note that since distances c1, c2, a1, and a2 also differ, detection and identification can also be performed similarly with use of such distances.

### 3. Manufacturing Method for Cold Cathode Fluorescent Lamps

Next, regarding a manufacturing method for the cold cathode fluorescent lamps 10A having the structure described above, the method is described focusing particularly on details of the formation of the phosphor layer and both sealed portions.

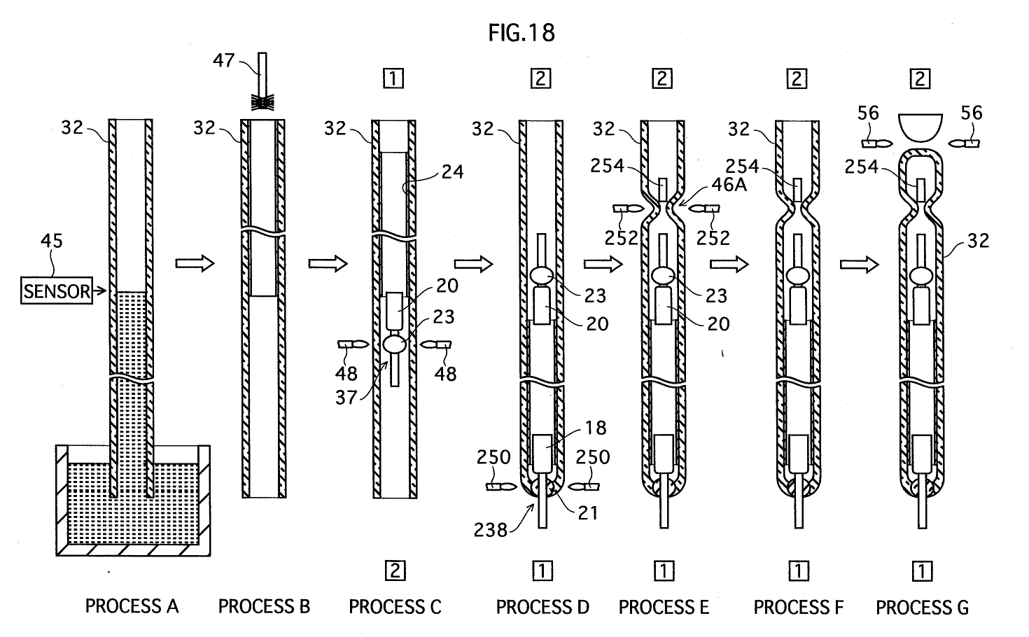

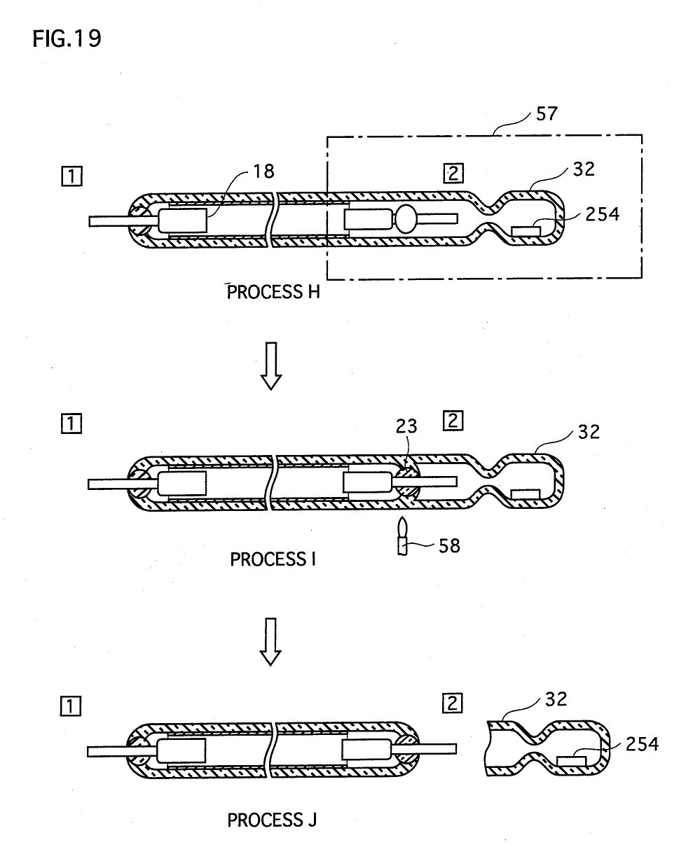

FIGS. 18 and 19 show manufacturing processes for the fluorescent lamps 10A.

First, a prepared straight tube shaped glass tube 32 is immersed into a tank containing a phosphor suspension liquid. Creating a negative pressure in the glass tube 32 allows the glass tube 32 to suction a portion of the phosphor suspension liquid from the tank, causing the phosphor suspension liquid to be applied to the inner face of the glass tube 32 (process A). A setting for this suction allows the liquid level to reach a predetermined height of the glass tube 32, by using an optical sensor 45 to detect the liquid level. Due to the influence of viscosity, surface tension, etc., of the phosphor suspension liquid, the margin of error of the liquid level height is fairly large, ±0.5 [mm].

Next, after drying the phosphor suspension liquid applied to the inner face of the glass tube 32, a brush 47 is inserted into the glass tube 32, and any unnecessary phosphor is removed from the end of the glass tube 32 (process B).

Thereafter, the glass tube is transferred to a furnace that is not depicted, and calcination is performed to obtain the phosphor layer 24.

After inserting an electrode unit 37 including the electrode 30 and the bead glass 23 into the glass tube 32 in which the phosphor layer has formed, temporary fastening is performed (process C). Temporary fastening refers to heating, with use of a burner 48, an outer circumference portion of the glass tube 32 where the bead glass 23 is to be positioned, in order to affix the outer circumference portion of the bead glass 23 to the inner circumference face of the glass tube 32 that corresponds to the heated portion. Only one portion of the outer circumference of the bead glass 23 is affixed in order to preserve airflow in the tube axis direction of the glass tube 32.

Next, after inserting an electrode unit 238 including the electrode 18 and the bead glass 21 into the glass tube 32 from the opposite side, the outer circumference portion of the glass tube 32 where the bead glass 21 is positioned is heated with use of a burner 250, and the glass tube 32 is hermetically sealed (a first seal) (process D). Note that the margin of error from the setting value of the sealing position of the first seal of is, at most, 0.5 [mm].

The insertion position of the electrode unit 37 in process C and the insertion position of the electrode unit 238 in process D are adjusted so that the lengths from both ends of the sealed glass bulb 16 to the respectively extending non-phosphor layer areas are different from each other. The electrode unit 238 on the first sealed portion side is inserted more deeply respective to a position overlapping the phosphor layer 24 area than the electrode unit 37 on the second sealed portion side.

After heating, with use of a burner 252, a portion of the glass tube 32 that is closer to the end than the electrode 20 and forming a constricted portion 46A, a mercury pellet 254 is inserted into the glass tube 32 (process E). The mercury pellet 254 is formed by impregnating mercury into a titanium-tantalum-iron sinter.

In process F, gas is discharged from the glass tube 32 and the glass tube 32 is filled with the noble gas. Specifically, the head of a gas exhaust apparatus, not depicted, is attached to the glass tube 32 on the mercury pellet 254 side. After ejecting the gas in the glass tube 32 to create a vacuum, the entire outer surface of the glass tube 32 is heated by a heating apparatus that is not depicted. Accordingly, impure gas in the glass tube 32 is discharged, including impure gas that has infiltrated the phosphor layer 24. After heating is stopped, the glass tube 32 is filled with a predetermined amount of noble gas.

After the glass tube 32 has been filled with the noble gas, the mercury pellet 254 side end of the glass tube 32 is heated by a burner 56 and sealed (process G).

Subsequently, as shown in FIG. 19, the mercury pellet 254 is induction-heated by a high-frequency oscillation coil (not depicted) disposed in the surrounding area of the glass tube 32, and the mercury is flushed out of the sinter (mercury ejection process). Thereafter, the glass tube 32 is heated in a furnace 57, and the flushed-out mercury is moved toward the electrode 18 on the first sealed portion side.

Next, the outer circumference portion of the glass tube 32 corresponding to the position where the bead glass 23 is heated by a burner 58, and the glass tube 46 is hermetically sealed (a second seal) (process I). The margin of error for the setting value of the sealing position of the second seal is 0.5 [mm].

Subsequently, an end of the glass tube 32 that is farther towards the mercury pellet 254 side than the second sealed portion is cut away (process J).

### 4. Manufacturing Method for the Backlight Unit

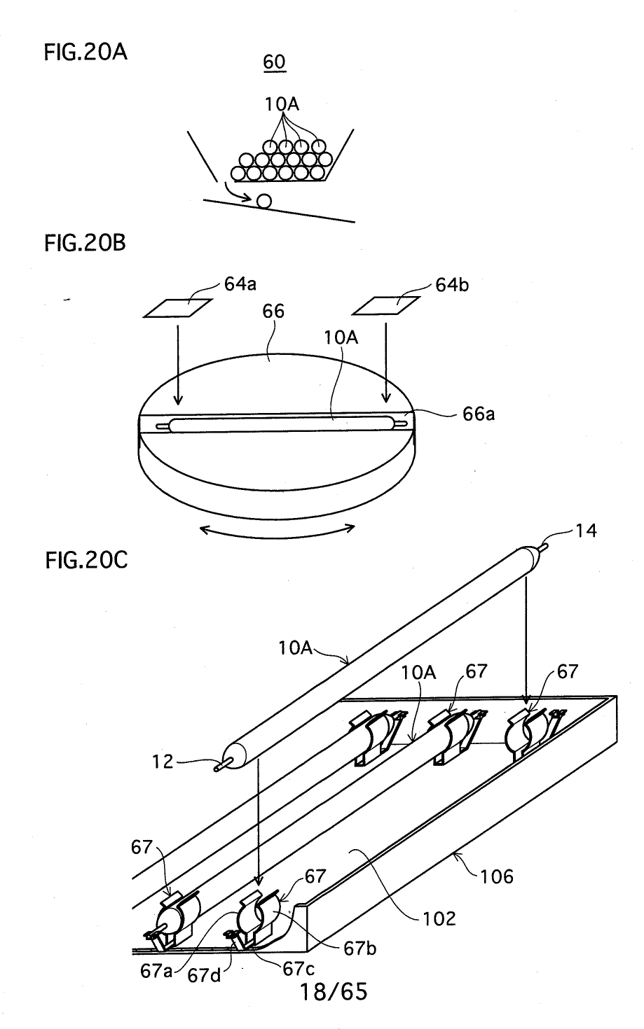

The following describes particularly a process of detecting the orientation of a lamp with reference to FIG. 20 in the manufacturing process of the backlight unit.

FIG. 20A is a schematic view of a lamp feeder 60. FIG. 20B shows the process of orienting the lamp. FIG. 20C shows the process of installing the lamp in the outer case 106.

The lamp feeder 60 is an apparatus for supplying the lamps 10A to a table 66 one at a time.

The table 66 includes a groove 66a in which one of the lamps 10A is disposed, and has a mechanism for rotating the table 66 360° in the direction indicated by the arrow.

The lamp 10A is disposed in the groove 66a, and sensors 64a and 64b have been disposed above positions corresponding to both ends of the lamp 10A. A sensor may be disposed on only one side of the lamp 10A.

The sensors 64a and 64b are, for example, image sensors that are a type of optical sensor, and detect the orientation of the lamp 10a by detecting a2 and a1 described above.

The lamp 10A is oriented by rotating the table 66 in accordance with an orientation, in the lengthwise direction of the lamp 10A, that was detected by the sensors 64a and 64b.

The oriented lamp 10A is held by a gripping member that is not depicted gripping the lead wire 12(14), and fitted into a socket 67 so as to have an opposite lengthwise orientation from adjacent ones of the lamps 10A.

As shown in FIG. 20C, sockets 67 have been disposed as a set in positions corresponding with mounting positions of the lamps 10A on a reflective plate 102 of the outer case 106.

The sockets 67 are electrically conductive, and have been formed from folded sheets of, for example, stainless steel or phosphor bronze. The sockets 67 include gripping plates 67a and 67b, a clutch 67c that clutches the gripping plates 67a and 67b on the bottom ends thereof, and a connecting plate 67d that projects from the clutch 67c.

Concave portions conforming to the outer diameter of the lamp 10A are provided in the gripping plates 67a and 67b.

The connecting plate 67d extends from the clutch 67c in an outward direction from the outer case 106, then extends diagonally to a predetermined height, and further extends in an outward direction of the outer case 106. A free end of the connecting plate 67d forms, for example, a V-shape that conforms to the outer diameter of the lead wire.

The lamps 10A are held in the sockets 67 by the spring action of the gripping plates 67a and 67b into whose concave portions the ends of the lamps 10A have been fit. At the same time, the lead wires 12 and 14 are connected both physically and electrically to the connecting plates 67d by the spring action of the concave portions of the free ends of the connecting plates 67d into which the lead wires 12 and 14 of the lamps 10A have been fit.

### 5. Variations

Variation 1

To improve the precision of orientation, one or more identifying marks pertaining to an orientation in the lengthwise direction may be printed on the outer circumference of the glass bulb 16 in an area outside the phosphor layer 24 area. The following describes such a case as variation 1 of embodiment 2.

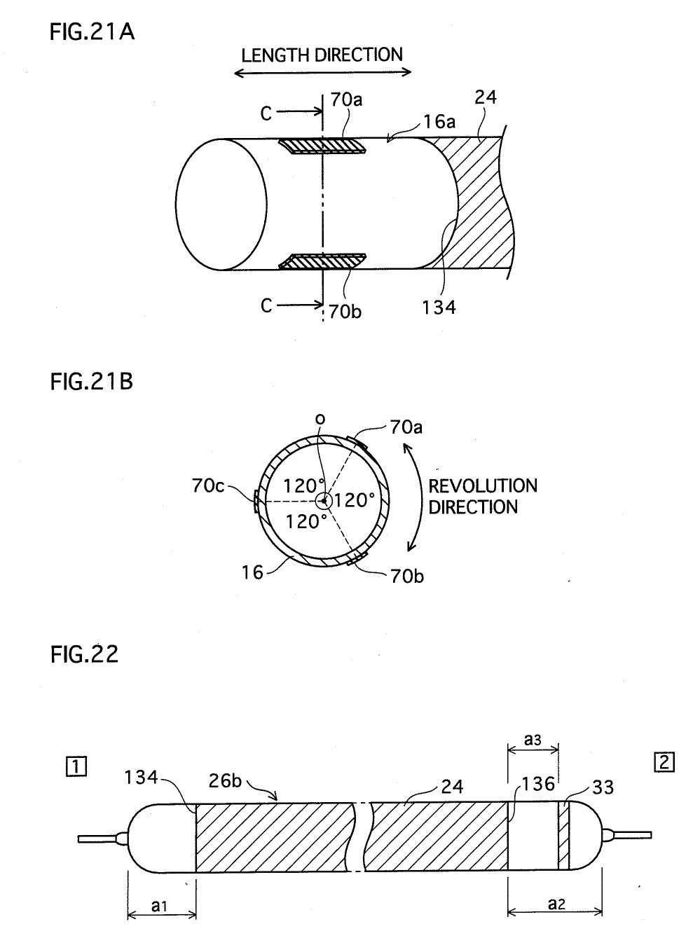

FIG. 21A shows a glass bulb 16a on which identifying marks have been printed, and FIG. 21B shows an end thereof sectioned along the line C-C.

Three identifying marks 70a, 70b, and 70c have been formed on the outer circumference of an end area of the glass bulb 16a.

The identifying marks 70a, 70b, and 70c are in substantially equivalent positions to each other in the lengthwise direction of the glass bulb 16a.

Note that the identifying marks 70a, 70b, and 70c are preferably formed on an outer circumference end area on the second sealed portion side whose non-phosphor layer area is longer than the first sealed portion side.

The identifying marks 70a to 70c are formed by, for example, screen-printing. Note that gravure printing or inkjet printing may be used in place of screen-printing.

In this way, using the glass bulb 16a on which the identifying marks 70a to 70c have been formed enables detecting an orientation in the lengthwise direction, for example by detecting a distance from the boundary 134 to the identifying marks 70a to 70c.

Also, when viewing a transverse section of the glass bulb 16a, central portions (main sections) of the identifying marks 70a to 70c are positioned at substantially 120[°] intervals from the center O of the glass bulb 16b. In this way, since the identifying marks 70a to 70c are positioned in such a way that a site targeted for measurement is visible regardless of the revolution direction (rotational direction) of the glass bulb 16a, one of the identifying marks 70a to 70c can be reliably detected from one direction with use of a sensor.

Note that printed characters may be used as the identifying marks 70a to 70c. The characters may be printed in the lengthwise direction of the glass bulb 16a or in the revolution direction of the glass bulb 16a. Also, lot numbers may be printed as the characters.

Variation 2

Also, a portion of the phosphor layer on the inner circumference (inner face) of the glass bulb 16a may be retained separately, and the retained portion may be used as the identifying mark of lengthwise direction orientation. The following describes such a case as variation 2 of the fluorescent lamp pertaining to embodiment 2.

As shown in FIG. 22, a phosphor layer 33 that is separate from the phosphor layer 24 has been formed on the second sealed portion side of the glass bulb 16b. Due to being in a position outside the discharge area between the electrodes 18 and 20, the phosphor layer 33 is a phosphor layer that does not substantially contribute to luminance.

In the present variation, for example, a distance a3 from the boundary 136 to the phosphor layer 33 can be used for detection. Also, since the identifying mark is the phosphor layer, luminance caused by ultraviolet irradiation can be used for detection, and a sensor having a simple structure can be used.

Variation 3

Even when identifying marks are not separately applied to the glass bulb 16, orientation detection in the lengthwise direction can be realized by modifying the structural members originally provided in the lamps. The following describes such a case as variation 3 of embodiment 2.

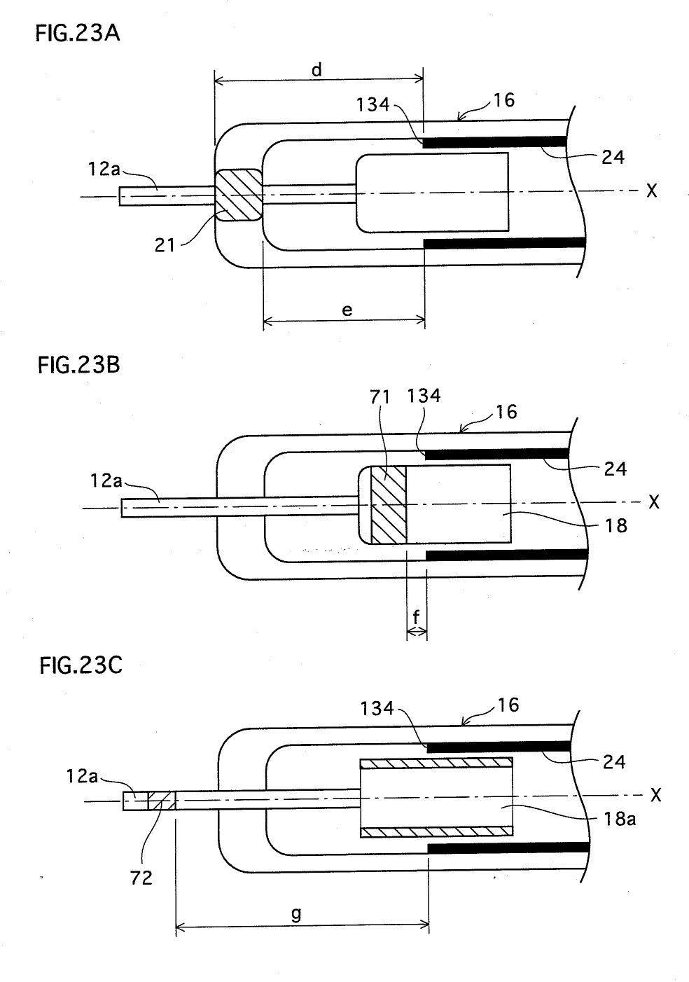

FIGS. 23A, 23B, and 23C are pattern diagrams showing a schematic structure of the glass bulb 16 pertaining to variation 3. FIG. 8A shows the exterior of the electrode 28, a bead glass, and a lead wire. FIG. 8B is a sectional view including the tube axis X of the glass bulb 16 and the phosphor layer 32, showing the exteriors of the lead wire 22a and the electrode 28. Also, FIG. 8C shows a section including the tube axis X in order to illustrate the shape of the electrode 28. Note that in FIGS. 8A, 8B, and 8C, similar structural elements to FIG. 2 have been given the same reference notations, and description thereof is omitted.

In the example of FIG. 23A, coloring is provided on the bead glass 21 for orientation detection (hatching in the drawing indicates coloration).

In such a case, distance d from the boundary 134 to the far end of the bead glass 21 and distance e from the boundary 134 to the near end of the bead glass 21 can be used for detection. Since more fade-resistant and vividly colored marks can be made on the bead glass 21 than on the outer circumference of the glass bulb 16, coloring the bead glass 21 enables improving sensor precision.

In the example of FIG. 23B, an identifying mark 71 has been applied to the lower center of the revolution direction of the cylinder-shaped electrode 18. In this example, distance f from the boundary 134 to the ring-shaped mark 71 can be used for detection. Since the identifying mark 71 can be detected from any direction regardless of the revolution direction of the glass bulb 16, the sensing equipment can be simplified.

In the example of FIG. 23C, the electrode 18a has an open-ended tube shape, unlike the bottomed-tube shape of the electrode 28. In this way, the shapes of electrodes that can be used are not limited to being a bottomed-tube shape, and can also be a tube or rod shape.

The electrode 18a has been secured by caulking the head of the lead wire 12a to the open ends of the electrode 18a.

Also, an identifying mark 72 has been applied in the revolution direction of the lead wire 12a. In this example, distance g from boundary 134 to the identifying mark 72 can be used for detection. Similarly to the identifying mark 71, the identifying mark 72 can also be detected from any direction regardless of the revolution direction of the glass bulb 16.

### 6. Additional Matter

(1) Difference in Length of Non-Phosphor Areas

As described above in embodiment 2, in the manufacturing process of the lamps 10A, the margin of error for detecting the liquid level of the phosphor suspension liquid in the glass tube is, at most, ±0.5 [mm], and the margins of error for each of the first and second sealed portions after being sealed are anticipated to be, at most, ±0.5 [mm].

Also, if an image sensor having two million [pixels] is used as the sensor, since one [pixel] can be set to 0.1 [mm], measurement precision can be realized in units of 0.1 [mm].

In view of such factors, the orientation in the lengthwise direction can be reliably detected with use of the sensor, provided that the difference in length between the non-phosphor layer areas on the glass bulb end side and on the other side is greater than or equal to 2 [mm].

Note that if the difference in length between the non-phosphor layer areas on the glass bulb end side and on the other side is greater than or equal to 3 [mm]; the orientation in the lengthwise direction can be detected more reliably with use of the sensor. In such a case, the image sensor may have a measurement precision of 0.5 [mm] units. Also, the upper limit of the difference in length is, for example, 8 [mm]. This is because if the difference in length is larger than 8 [mm], there is a long non-phosphor layer area that does not contribute to light emission, and maintaining an effective light emission length is difficult.

(2) Protective Layer

Although the fluorescent lamp described in embodiment 2 does not have a protective layer (protective film) on an inner face of the glass bulb to prevent depletion of mercury, etc., the present invention can also be applied to a fluorescent lamp that has a protective layer.

Specifically, the orientation in the lengthwise direction of the glass bulb can be detected by making a non-protective layer area extending from one end of the glass bulb and a non-protective layer area extending from the other end of different lengths, and detecting the difference in length with use of a sensor. In other words, the material of the layer formed on the inner face of the glass bulb is not limited to being a phosphor layer, and a protective layer can also be used.

(3) Types of Lamp

Although a cold cathode fluorescent lamp is described as an example in embodiment 2, the present invention can also be applied to a hot cathode fluorescent lamp or an external electrode type fluorescent lamp.

The external electrode type fluorescent lamp is a fluorescent lamp that does not have an electrode inside the glass bulb, and has electrodes on the outer circumference of both ends of the glass bulb. When the present invention is applied to the external electrode type fluorescent lamp, it is necessary to use a transparent material for the electrode or to position the electrode so as not to overlap with the phosphor layer, so that the boundary between the phosphor layer area and the non-phosphor layer area can be detected by a sensor.

(4) Shape of the Lamp

In the present embodiment, the shape of the lamp is a straight tube (FIG. 10). However, the present invention is also applicable when the lamp is a U-shape, a U-shape having three straight parts, or an L-shape.

### Embodiment 3

When lanthanum oxide coats the surface of the phosphor particles, the luminance maintenance rate is improved over when lanthanum oxide does not coat the surface of the same phosphor particles. However, merely coating with lanthanum oxide cannot prevent a reduction in luminance maintenance rate due to causes other than mercury attachment, and the improvement in luminance maintenance rate is limited. Also, when the coating amount of lanthanum oxide is increased to improve luminance maintenance rate, lanthanum oxide readily detaches from the surface of the phosphor particles, and since light emitted form the phosphor particles is blocked by the lanthanum oxide, the amount of light decreases, leading to a reduced initial luminance.

Embodiment 3 aims to provide a fluorescent lamp that prevents a reduced initial luminance and improves luminance maintenance rate when the lamp is lit.

Embodiment 3-1

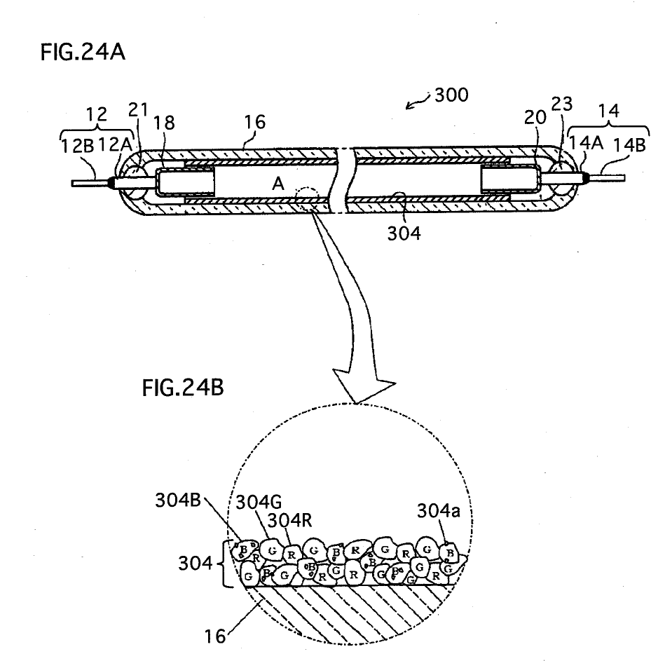

FIG. 24A is a cross-sectional view of a fluorescent lamp 300 (hereinafter simply “lamp 300”) including a tube axis thereof, and FIG. 24B is an enlarged cross-sectional view of section A of FIG. 24A. Mainly, other than the structure of the phosphor layer, the lamp 300 is similar to the cold cathode fluorescent lamp 10 pertaining to embodiment 1. Accordingly, structural elements that are the same have been given the same reference notations, and description thereof has been omitted. Depiction of the protective film has been omitted in all of the drawings pertaining to embodiment 3.

Mercury in the glass bulb 16 occupies a predetermined ratio of the cubic capacity of the glass bulb 16, for example, such that the glass bulb 16 is filled to 0.6 [mg/cc], and the glass bulb 16 is filled to a predetermined charged pressure, for example 60 [Torr] with a noble gas such as argon or neon. Note that a mixed gas of argon and neon (5[%] Ar, 95[%] Ne) is used as the noble gas.

Also, a phosphor layer 304 that, similarly to embodiment 1, overlaps the protective film (not depicted), has been formed on an inner face of the glass bulb 16. The phosphor particles used in the phosphor layer 304 are formed from rare earth phosphors, such as red phosphor (Y₂O₃:Eu³⁺) 304R, green phosphor (LaPO₄:Ce³⁺,Tb³⁺) 304G, and blue phosphor (BaMg₂Al₁₆O₂₇:Eu²⁺) 304B that convert ultraviolet radiation emitted from the mercury into red, green, and blue light respectively.

Here, from the standpoints of preventing reduced initial luminance at the time of lighting the lamps and improving the luminance maintenance rate, the content of impurities such as cerium oxide (CeO₂) magnesium aluminosilicate (MgAl₂O₄) and barium aluminosilicate (BaAl₂O₄) in the blue phosphor particles (BaMg₂Al₁₆O₂₇:Eu²⁺) is preferably less than or equal to 0.1 [wt %]. In other words, if the impurity content is more than 0.1 [wt %], the crystal properties of the blue phosphor particles 304B is reduced, and in particular, the luminance maintenance rate is thought to be reduced.

Also, as shown in FIG. 24B, among phosphor particles in the phosphor layer 304, the surfaces of the blue phosphor particles 304B may be covered by lanthanum oxide (La₂O₃) 304a as a metal oxide. This is because, since alumina (Al₂O₃) is included in the blue phosphor particles 304B, mercury is easily adsorbed, and the mercury adsorbed to the surface of the blue phosphor particles 304B blocks light emitted from the blue phosphor particles 304B, the red phosphor particles 304R, and the green phosphor particles 304G, and this leads to a reduction in the luminance maintenance rate of the fluorescent lamp 300.

Therefore, having fewer impurities in the blue phosphor particles 304B as described above, particularly when the impurity content is 0.1 [wt %] of the total weight of the blue phosphor particles, enables improving the luminance maintenance rate and preventing a reduction in the initial luminance when the fluorescent lamp is lit.

### Experiment 1

The following describes the particulars of the operation effect of the fluorescent lamp pertaining to embodiment 3-1 of the present invention, based on a comparative experiment performed with use of examples of different blue phosphor particles (BaMg₂Al₁₆O₂₇:Eu²⁺). In the comparison experiment, the inventors of the present invention manufactured single-color fluorescent lamps (hereinafter referred to as “specimen 1 of the present invention”, “comparative specimen 1”, and “comparative specimen 2”, respectively). The blue phosphor particles of specimen 1 of the present invention are hereinafter referred to as specimen 1-1 of the present invention. The blue phosphor particles of comparative specimen 1 and comparative specimen 2 are, respectively, referred to as comparative specimen 1-1 and comparative specimen 2-1.

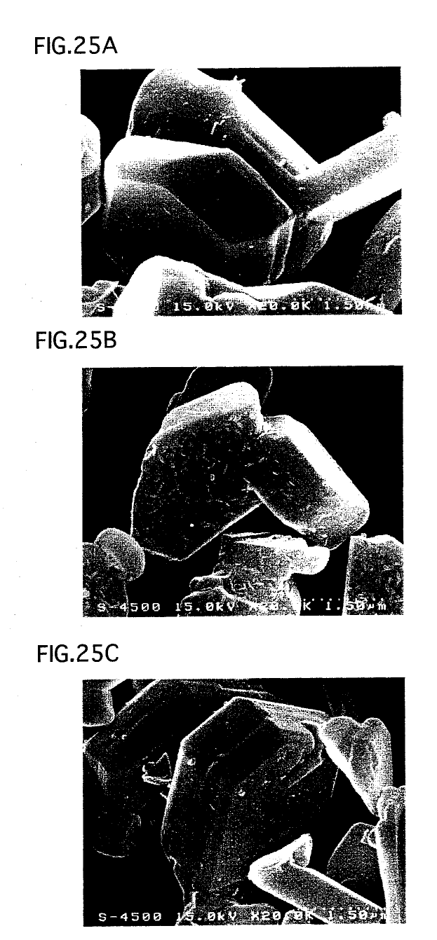

FIG. 25A is an SEM photograph of specimen 1 of the present invention, FIG. 25B is an SEM photograph of comparative specimen 1, and FIG. 25C is an SEM photograph of comparative specimen 2. Note that the SEM photographs were taken at a magnification rate of 20,000 [times] with use of a Hitachi product Model No. S4500.

As shown in FIG. 25A, the surface of specimen 1 of the present invention is lightly coated with lanthanum oxide. Note that the rice grain-shaped objects that can be seen sporadically on the surfaces of the blue phosphor particles in FIGS. 25A and 25B are lanthanum oxide.

As shown in FIG. 25B, the surface of comparative specimen 1 is almost completely coated with lanthanum oxide.

As shown in FIG. 25C, although comparative specimen 2 is constituted of the same blue phosphor particles as comparative specimen 1, the surfaces are not coated with lanthanum oxide.

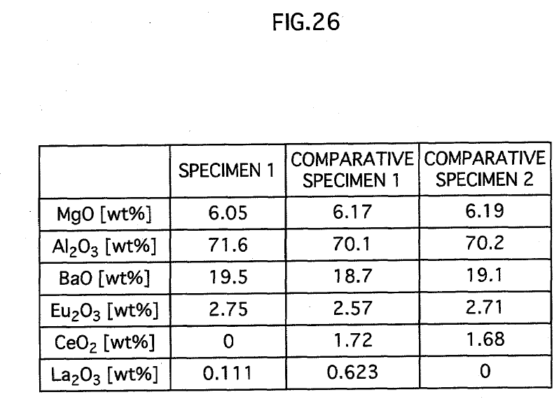

Next, FIG. 26 shows elemental analysis results of specimen 1 of the present invention, comparative specimen 1 and comparative specimen 2. Note that the element analysis was performed with use of a Rigaku Industrial Corporation product Model No. RIX-3100.

FIG. 26 illustrates that specimen 1 of the present invention, unlike comparative specimens 1 and 2, does not contain cerium oxide (CeO₂) that is an impurity.

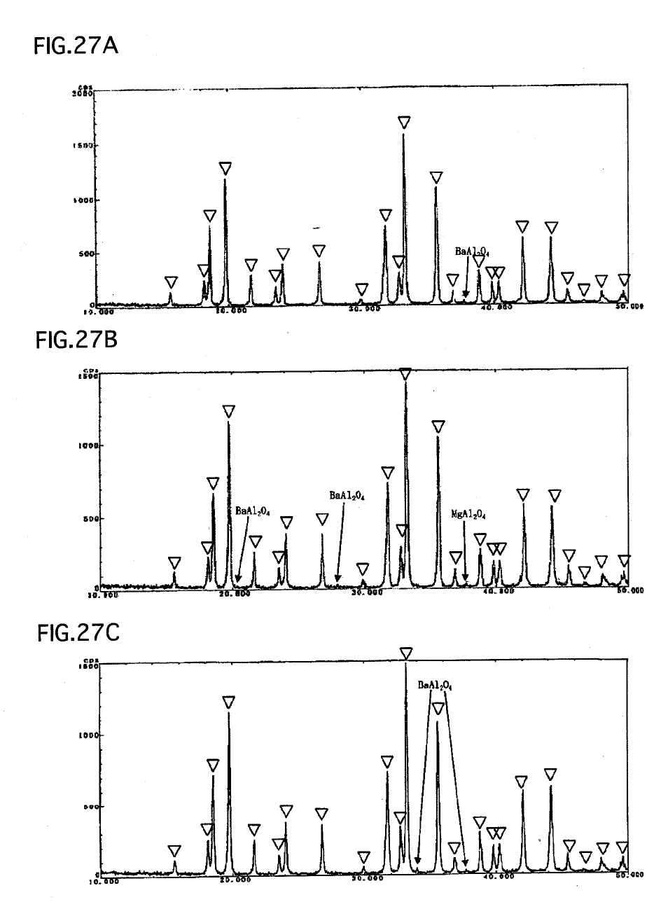

Next, FIG. 27A shows an X-ray diffraction pattern diagram of specimen 1 of the present invention, FIG. 27B shows an X-ray diffraction pattern diagram of comparative specimen 1, and FIG. 27C shows an X-ray diffraction pattern diagram of comparative specimen 2. Note that the X-ray diffraction was performed with use of a Rigaku Industrial Corporation product Model No. RINT1000.

FIGS. 27A, 27B and 27C illustrate that specimen 1 of the present invention contains less of the impurities magnesium aluminosilicate (MgAl₂O₄) and barium aluminosilicate (BaAl₂O₄) than comparative specimens 1 and 2. Note that in FIGS. 27a to 27C, ∇ (an upside down white triangle) is used to indicate barium-magnesium aluminate.

Other than differences in the phosphor particles used in the respective phosphor layers, specimen 1-1 of the present invention, comparative specimen 1-1 and comparative specimen 2-1 that are samples in the experiment have substantially the same structure as the lamp 300. Specifically, a cross section taken perpendicular to the tube axis of the glass bulb is substantially circular, the glass bulb is made of borosilicate glass, and the outer diameter thereof is 3.0 [mm], the inner diameter is 2.0 [mm], and the total length is approximately 340 [mm]. A phosphor layer has been formed on an inner surface of the glass bulb, and 1.5 [mg] of mercury and a mixed gas of argon and neon (Ar=5[%], Ne=95[%]) are enclosed in the glass bulb at a charged pressure of 60 [Torr].

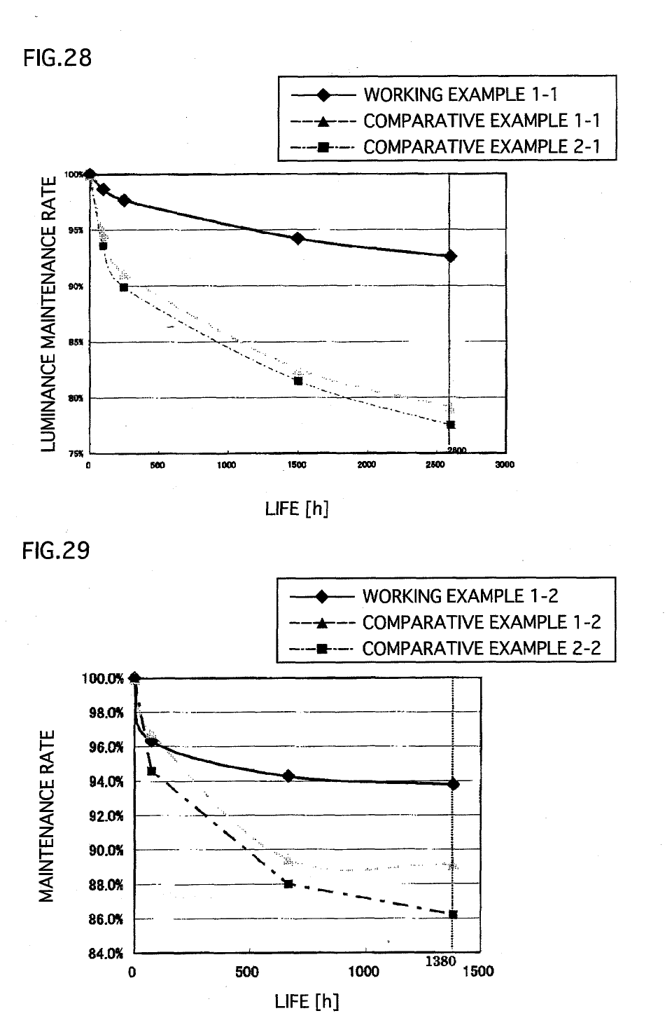

A lighting experiment was performed with use of the three samples described above. FIG. 28 is a graph indicating changes in luminance maintenance rate between specimen 1-1 of the present invention, comparative specimen 1-1 and comparative specimen 2-1 according to hours lit. As shown in FIG. 28, when 2600 [h] have passed, the luminance maintenance rate of specimen 1 of the present invention is 92.6[%] compared to comparative specimen 1 whose luminance maintenance rate is 79.1[%] and comparative specimen 2 whose luminance maintenance rate is 77.5[%]. Note that in this case, there is not a large difference between the initial luminances of specimen 1-1 of the present invention, comparative specimen 1-1 and comparative specimen 2-1.

### Experiment 2

Also, the inventors manufactured fluorescent lamps of a three-band type using the blue phosphor particles of specimen 1 of the present invention, comparative example 1, and comparative example 2, respectively, mixed with red phosphor particles (Y₂O₃:Eu³⁺) and green phosphor particles (LaPO₄:Ce³⁺,Tb³⁺) at a mixture ratio of 2:1:1. The lamps using the blue phosphor particles of specimen 1 of the present invention, comparative example 1, and comparative example 2 are, respectively, specimen 1-2 of the present invention, comparative example 1-2, and comparative example 2-2. FIG. 29 is a graph indicating changes in luminance maintenance rate between specimen 1-2 of the present invention, comparative specimen 1-2 and comparative specimen 2-2 according to hours lit.

FIG. 29 illustrates that when 1380 [h] have passed, compared to comparative specimen 1-2 whose luminance maintenance rate is 89.1[%] and comparative specimen 2-2 whose luminance maintenance rate is 86.2[%], the luminance maintenance rate of specimen 1-2 of the present invention is 93.8[%], and specimen 1-2 of the present invention has a higher luminance maintenance rate than comparative specimen 1-2 and comparative specimen 2-2.

Note that in this case, there is not a large difference between the initial luminance of specimen 1-2 of the present invention, comparative specimen 1-2 and comparative specimen 2-2.

In other words, specimen 1-2 of the present invention prevents reduced initial luminance when the lamps are lit and improves the luminance maintenance rate. Here, the reason is described below. FIGS. 26 and 27A to 27C illustrate that specimen 1 of the present invention contains less of the impurities cerium oxide (CeO₂), barium aluminosilicate (BaAl₂O₄), and magnesium aluminosilicate (MgAl₂O₄) than comparative specimens 1 and 2.

If cerium oxide is present in crystals of barium-magnesium aluminate, atoms that differ from the main atoms that constitute the crystals are present in the crystals, causing strain and reduction in the crystal properties, which is thought to cause a reduction in luminance maintenance rate.

Also, since barium aluminate and magnesium aluminate are formed as different crystal structures from barium-magnesium aluminate, different crystal structures are present in the barium-magnesium aluminate crystals, which is thought to cause fragility in the crystals, reduction in the crystal properties, and a reduction in luminance maintenance rate.

### Embodiment 3-2

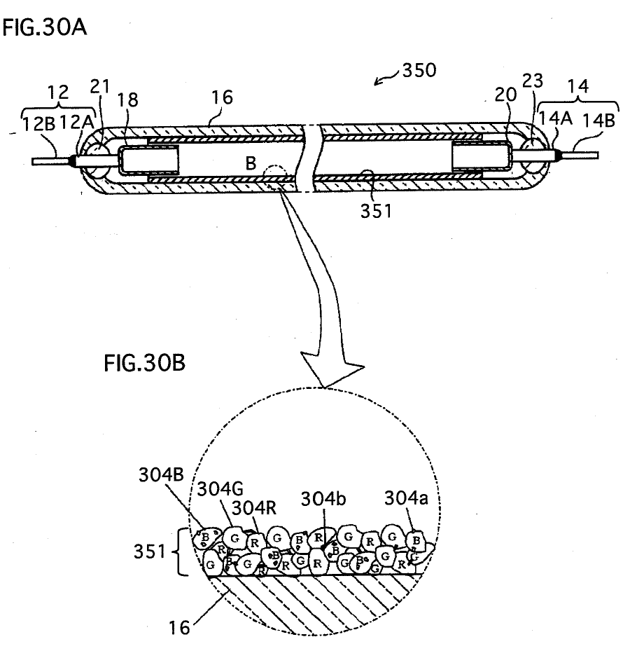

FIG. 30A is a cross-sectional view of a fluorescent lamp 350 pertaining to embodiment 3-2 of the present invention (hereinafter simply “lamp 350”) including the tube axis thereof, and FIG. 30B is an enlarged cross-sectional view of section B of FIG. 30A. As shown in FIG. 30A, the lamp 350 is a cold cathode fluorescent lamp. The lamp 350 has the same structure as the fluorescent lamp 300 pertaining to embodiment 3-1 of the present invention other than the phosphor layer. The following describes particulars of the phosphor layer, and the same reference notations have been given to other structural elements in FIGS. 30A and 30B as in FIGS. 24A and 24B, and description thereof is omitted.

As shown in FIG. 30B, phosphor particles 304R, 304G, and 304B (hereinafter referred to as “phosphor particles RGB”) in a phosphor layer 351 are spanned by rod-shaped bodies 304b that include a metal oxide. In particular, the narrow portions between the phosphor particles RGB are spanned by the rod-shaped bodies 304b. Here, the “rod-shaped bodies 304b” are columnar, having a diameter that is smaller than the spanned distance. The rod-shaped bodies 304b have a thickness of, for example, 1.5 [μm] or less. There are cases in which a pair of adjacent phosphor particles 304 RGB are spanned by a plurality of the rod-shaped bodies 304b. The presence of the rod-shaped bodies 304b narrows gaps between the phosphor particles RGB, and suppresses the penetration of mercury into the phosphor layer 351. This therefore suppresses the consumption of mercury from adsorption to the phosphor particles 304 RGB. Also, given that the metal oxide bodies disposed between the phosphor particles 304RG and spanning therebetween are rod-shaped, light converted by the phosphor layer 351 is readily transmitted outside the glass bulb 16. The fluorescent lamp 350 of the present embodiment achieves both suppressing consumption of mercury and high luminance.

The metal oxide included in the rod-shaped bodies 304b is preferably at least one type selected from among, for example, Y, La, Hf, Mg, Si, Al, P, B, V and Zr. Among these, Zr, Y, Hf and the like are preferable since their coupling energy with an oxygen atom exceeds 10.7×10⁻⁹ [J]. This 10.7×10⁻⁹ [J] corresponds to the photon energy of 185 [nm] ultraviolet radiation, which is one of the resonance lines generated along with the excitation of mercury. Using metal oxide compounds including metal in which the coupling energy with an oxygen atom exceeds 10.7×10⁻⁹ [J], for example ZrO₂, Y₂O₃, or HfO₂, improves the resistance of the metal oxide to exposure to 185 [nm] ultraviolet radiation. Also, using a metal oxide that includes Y₂O₃ further reduces the consumption of mercury, which is preferable.

Also, for example, SiO₂, Ai₂O₃, or HfO₂ may be used as the metal oxide compound included in the rod-shaped bodies. These have high transmissivity (nearly 100%) for light with a wavelength of 254 [nm]. Phosphors emit visible light by receiving 254 [nm] light. Therefore, using a metal oxide compound that has a high transmissivity for 254 [nm] light increases luminous efficiency, which is preferable.

Note that ZrO₂ has a transmissivity of approximately 95[%] for 254 [nm] light, and V₂O₅, Y₂O₃ and NbO₅ have a transmissivity of approximately 85[%] for 254 [nm] light. Y₂O₃ and ZrO₂ have a low transmissivity for light having a wavelength of 200 [nm] or less, namely less than 30% and 20% respectively. For this reason, Y₂O₃ and ZrO₂, which have a substantial blocking effect of 185 [nm] light that degrades phosphor, are preferable.

According to the above structure, the phosphor lamp pertaining to embodiment 3-2 of the present invention prevents reduced initial luminance when lit and further improves the luminance maintenance rate.

### Experiment 3

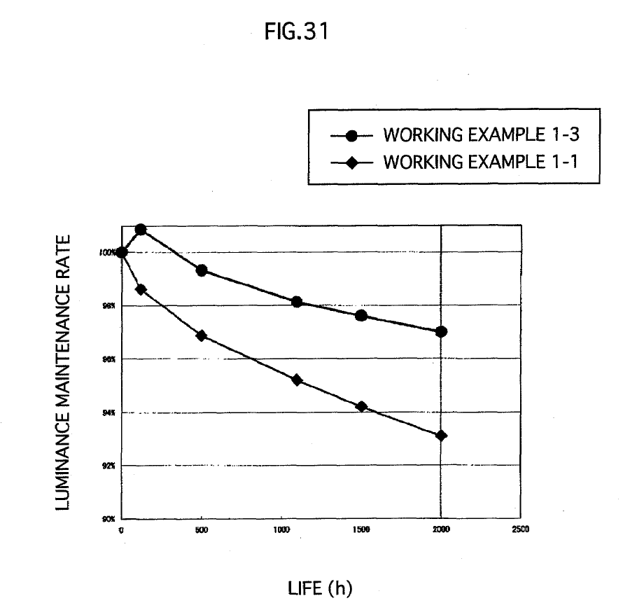

The particulars of effects of the fluorescent lamp 350 pertaining to embodiment 3-2 of the present invention are described below with reference to an experiment using blue phosphor particles (BaMg₂Al₁₆O₂₇:Eu²⁺) in which the fluorescent lamp 350 was compared. The inventors manufactured a specimen 1-1 of the present invention and a specimen 1-3 of the present invention that differs from specimen 1-1 of the present invention only in that rod-shaped bodies including a metal oxide span between phosphor particles in the phosphor layer. Specifically, yttrium oxide (Y₂O₃) that composes 0.3 [wt %] of the total weight composition of the phosphor particles in the phosphor layer was used as the metal oxide of the rod-shaped bodies. FIG. 31 is a graph indicating changes in luminance maintenance rates of specimen 1-2 of the present invention and specimen 1-1 of the present invention according to hours lit. Note that for the purpose of comparison, the graph also depicts changes in luminance maintenance rate according to hours lit for specimen 1-1 of the present invention used in experiment 1. As shown in FIG. 31, the luminance maintenance rate of specimen 1-1 of the present invention after 2000 [h] lit is 93.1[%], and the luminance maintenance rate of specimen 1-3 of the present invention is 97.0[%]. Furthermore, there was not a large difference between specimen 1-3 of the present invention and specimen 1-1 of the present invention in terms of initial luminance.

Accordingly, specimen 1-3 of the present invention prevents reduced initial luminance when lit and further improves luminance maintenance rate.

### Embodiment 4

One method of reducing the cost of the cold cathode fluorescent lamp is using, for example, a nickel (Ni) cathode. If a nickel electrode is used, the cost of the cold cathode portion can be reduced over using a molybdenum (Mo) electrode or a tungsten (W) electrode. However, problems with using a nickel electrode include low spatter resistance and a short lifetime. Technology such as the following has been disclosed to solve these problems.

Specifically, there is technology that uses a nickel-molybdenum alloy or a nickel-molybdenum clad as the cold cathode. This enables improving spatter resistance of the cold cathode and improving the lifetime.

However, although molybdenum improves spatter resistance, molybdenum is more expensive than nickel, and since a nickel-molybdenum electrode costs several times more than a nickel electrode, the cost reduction benefit of using a nickel electrode is lost.

Embodiment 4 was achieved in view of the above problem, and aims to provide a cold cathode fluorescent lamp that has a low cost and a high spatter resistance.

Mainly, other than the electrode material being different, the cold cathode fluorescent lamp of embodiment 4 is basically the same as the cold cathode fluorescent lamp of embodiment 1. Accordingly, description of the portions that are the same is omitted, and only the particulars of the different portions are described.

The electrodes 18 and 20 have been formed by adding (doping) yttrium oxide (Y₂O₃) at 0.46 [wt %] and silicon (Si) at 0.14 [wt %] to a nickel base material. Adding the yttrium oxide enables improving spatter resistance in the electrodes 18 and 20. Also, adding silicon enables preventing the electrodes 18 and 20 from oxidizing.

6. Method for Manufacturing the Electrode 18

Next, the method for manufacturing the electrode 18 is described. Note that since the electrode 20 is manufactured in the same way as the electrode 18, the description of the method for manufacturing the electrode 18 also applies to the method for manufacturing the electrode 20.

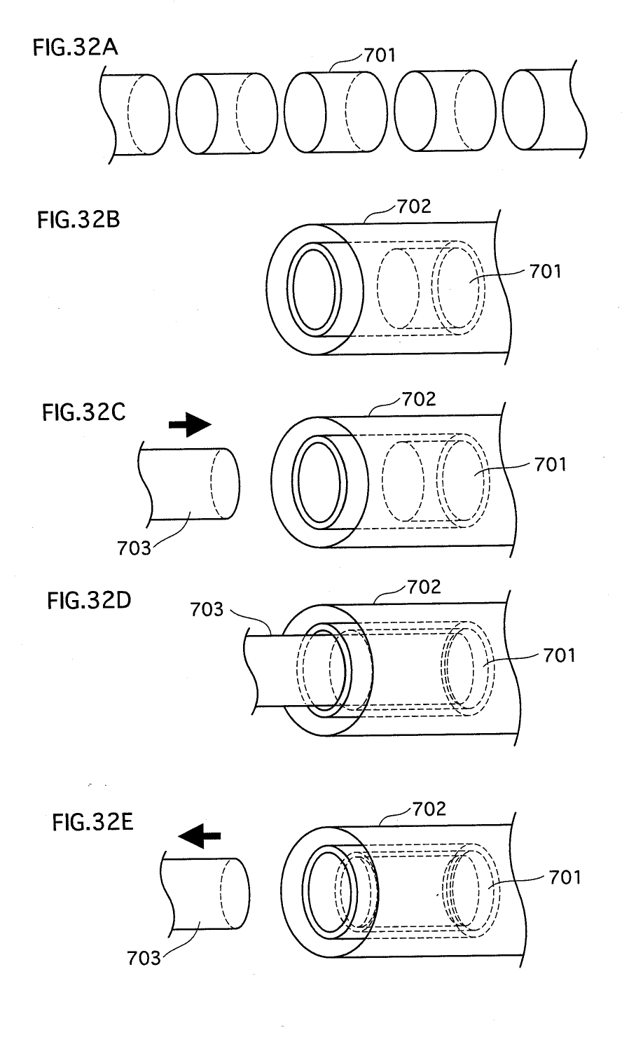

In the present embodiment, as described above, ingots made of nickel to which yttrium oxide and silicon have been added are processed into wires (wire drawing), and then the ingots are cold pressed by header processing. FIG. 32 shows the method for manufacturing the electrode 18. First, the wire-drawn ingot 701 is cut at a predetermined length (FIG. 7A).

Next, the cut ingot 701 is stored in the die 702 (FIG. 32B), and the ingot 701 is compressed one to several times in a press 703 (FIGS. 32C to 32E). Thereafter, the electrode 18 can be obtained by extracting the molded ingot 701 from the die 702 with use of an eject bar (not depicted).

The manufacturing cost of the electrode 18 can be reduced since the electrode 18 can be obtained in such a manner by cold forging. Also, the manufacturing cost can be reduced since nickel is softer than tungsten and niobium, and the electrode 3306 can be molded using fewer compressions.

### 7. Evaluation of Spatter Resistance

The following describes the results of evaluating the spatter resistance of the electrode pertaining to the present embodiment and a nickel electrode to which yttrium oxide was not added.

Each of the glass bulbs of the cold cathode fluorescent lamps used in the evaluation has a 2.4 [mm] outer diameter and a 2.0 [mm] inner diameter. Each of the hollow-type electrodes has a 1.7 [mm] outer diameter, a 1.5 [mm] inner diameter, and a length of 5.5 [mm]. The distance between the electrodes (interval from the farthest end of one electrode to the farthest end of the other electrode) is 330 [mm]. The cold cathode fluorescent lamps are filled with mercury to a saturated vapor pressure and with a 5[%] neon-argon mixed gas to 8 [kPa] (60 [Torr]). Also, a 60 kHz voltage having a sine waveform is applied, and the current magnitude is 6 [mA].

Under these conditions, five sample cold cathode fluorescent lamps were continuously lit for 5,000 [hours] at an atmospheric temperature of 25[° C.], and then average values of spatter amounts of the electrodes were obtained from the five sample lamps. The electrode pertaining to the present invention had a spatter amount of 1.8 [μg] compared to 2.8 [μg] in a pure nickel electrode. In other words, using the present invention enables reducing spatter amount by 35[%].

Note that in the present evaluation, the spatter amount was obtained by measuring, via chemical analysis, the amount of metallic film that had deposited on an inner wall of the glass bulb in the vicinity of the opening of the electrode.

Also, although the spatter amount, obtained in the same manner, of a pure niobium electrode is 0.8 [μg], which is even less than in the electrode pertaining to the present invention, in view of the fact that an aim of the present invention is to reduce both spatter amount and cost, this result in no way detracts from the effect of the present invention.

### 8. Variations

Although described based on embodiment 4, the present invention is of course not limited to embodiment 4. Variations such as the following are also included in the present invention.

(1) Although the above embodiment only describes an example of adding yttrium oxide at 0.46 [wt %] to nickel as a base material, the present invention is of course not limited to this. A similar effect to the present invention can be achieved provided that the added amount of yttrium oxide is in a range from 0.1 [wt %] to 1.0 [wt %] inclusive.

(2) Although the above embodiment only describes a case of adding yttrium oxide, the present invention is of course not limited to this. In addition to yttrium oxide, one or more of silicon, titanium (Ti), strontium (Sr) and calcium (Ca) may be added as deoxidizing agents. This enables preventing the electrode from oxidizing.

(3) Although the above embodiment only describes manufacturing the electrode 306 by header processing, the present invention is of course not limited to this, and the electrode may be molded by drawing processing in place of header processing.

(4) Although the above embodiment only describes a case of using hollow-type electrodes as cold cathodes, the present invention is of course not limited to this, and rod-shaped electrodes may be used in place of hollow-type electrodes. The effect of the present invention is the same regardless of the shape of the electrode.

### Embodiment 5

To improve start characteristics and lamp efficiency, there are cases in which electrodes used in cold cathode fluorescent lamps are covered by an emitter (electron emitting material) composed of an oxide of an alkali earth metal such as barium, calcium, or strontium (for example, see Japanese Patent Application Publication No. 2000-331643). An example of this type of emitter covering formation is given as follows. At the level of raw materials, the emitter component is prepared as a carbonate of an alkali earth metal, and the emitter component is applied to the electrode while in a suspension liquid state, the suspension liquid being the carbonate of the alkali earth metal dispersed in an organic solvent. An organic binder has been mixed in the suspension liquid so that the emitter component that is the carbonate of the alkali earth metal readily attaches to the electrode. Thereafter, the emitter component is heated, the carbonate of the earth metal decomposes to an oxide by heat decomposition, and the emitter is formed from the oxide of the earth metal. When the heating is performed, the organic binder is also oxidized and decomposed, and is thus eliminated.

The end of the lifetime of a cold cathode fluorescent lamp that does not have an emitter is decided by decreased luminance. However, when emphasis is placed on the start characteristic and efficiency of the lamp as described above, since an emitter is used, spatter from the emitter also causes the life of the cold cathode fluorescent lamp to end. Therefore, to lengthen the life of a cold cathode fluorescent lamp that uses an emitter, emphasis is placed on how to suppress spatter from the emitter. However, every year the level of demand for long life in fluorescent lamps increases, and now a conventional emitter composed of alkali earth metal oxides cannot sufficiently meet the demand for long life.

Embodiment 5 was achieved to solve the above problem, and aims to provide a fluorescent lamp that is highly efficient, has a long life, and includes an emitter that produces little spatter when the fluorescent lamp is in use.

In the present embodiment, since structures and materials of portions other than the electrodes are substantially the same as in previous embodiments, the following only describes the structure of the electrodes, which is a particular feature of the present embodiment.

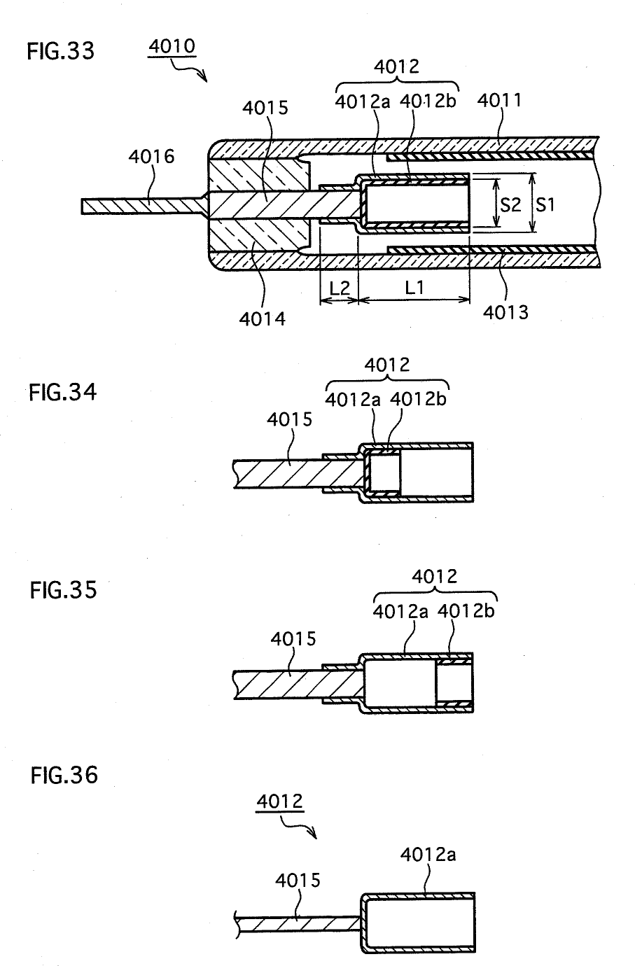

FIG. 33 is an enlarged cross-sectional view of a portion of an exemplary fluorescent lamp pertaining to embodiment 12. Note that FIG. 33 shows one end of the fluorescent lamp, and since the other end is the same as the end shown in FIG. 33, depiction thereof has been omitted.

As shown in FIG. 33, an electrode 4012 includes a metal sleeve 4012a and an emitter 4012b that at least partially covers the metal sleeve 4012a. The difference between the outer diameter S1 and the inner diameter S2 of the metal sleeve 4012a, in other words the thickness of the metal sleeve 4012a, is normally set to fall between 0.1 [mm] to 0.2 [mm]. Also, although the cup length L1 of the metal sleeve 4012a has been set to approximately three times the length of the base section L2, the cup length is not limited to this.

Note that although FIG. 33 shows an example of the emitter 4012b being formed on the inner face of the metal sleeve 4012a, the formation position of the emitter 4012b is not limited to this, provided that the emitter 4012b is formed on a portion of the metal sleeve 4012a. However, providing the emitter 4012b on at least the inner face of the metal sleeve 4012a enables preventing the emitter 4012b from spatter due to ion bombardment resulting from the cold cathode operation, and thus enables longer preservation of the emitter effect.

Also, there is a correlation between the spatter described above and charged gas pressure. When charged gas pressure is low, spatter readily occurs at the relative bottom of the metal sleeve 4012a. When charged gas pressure is high, spatter readily occurs in a vicinity of the opening of the metal sleeve 4012a. When the charged gas pressure is low pressure that is at or below 1 [Torr], as shown in FIG. 34, the emitter 4012b is preferably formed on the bottom face portion of the metal sleeve 4012a and on an inner side face to a ⅓ height upward from the bottom face of the metal sleeve 4012a. Also, when the charged gas pressure is high pressure that is greater than or equal to 10 [Torr], as shown in FIG. 35, the emitters 4012b are preferably formed on an inner face to a ⅓ depth downward from the opening of the metal sleeve 4012a. Furthermore, when the charged gas pressure is medium pressure that exceeds 1 [Torr] and is under 10 [Torr], the emitters 4012b are preferably formed on an inner side face at least to a ⅓ height or depth, downward and upward respectively, from the opening. Since the emitter 4012b has a great deal of spatter resistance, changing the formation position of the emitter 4012b in accordance with the charged gas pressure enables preventing scattering (spatter) of the metal sleeve 4012a due to ion bombardment.

Note that although the example of a cup-shaped electrode is shown in FIG. 33, a rod-shaped electrode can also be used. In such a case, the relationship between the spatter and the charged gas pressure is such that when the charged gas pressure is high (greater than or equal to 10 [Torr]), spatter occurs easily on the ends of the rod-shaped electrodes and on the side faces to a ⅓ depth from the ends. When the charged gas pressure is medium to low (under 10 [Torr]), spatter occurs easily on the ends of the rod-shaped electrodes and to a ⅔ depth from the ends. Accordingly, when using rod-shaped electrodes, emitters having great spatter resistance are preferably disposed in positions on the rod-shaped electrodes on which spatter easily occurs, similarly to when cup-shaped electrodes are used.

The metal sleeve 4012a is formed from a metal that is heat-resistant to a temperature greater than or equal to the sintering temperature of the emitter (for example, 550[° C.]). For example, nickel, stainless steel, cobalt, or iron can be used as the material for the metal sleeve 4012a. An inner lead wire 4015 that is made of tungsten or the like has been inserted into the metal sleeve 4012a and welded to one end of the metal sleeve 4012a. The inner lead wire 4015 passes through the glass bead 4014 and connects to an outer lead wire 4016.

Note that although an example is shown in FIG. 33 of inserting the base portion of the metal sleeve 4012a into the inner lead wire 4015 and joining the metal sleeve 4012a and the inner lead wire 4015 together by welding to form the electrode 4012, the electrode 4012 can also be the metal sleeve 4012a and the inner lead wire 4015 formed as a single piece, as shown in FIG. 36.

Also, the centerline average roughness (Ra) of the surface of the metal sleeve 4012a is preferably between 1 [μm] and 10 [μm]. This is because the effect of suppressing deficiency in the emitter 4012b is greatest in this range.

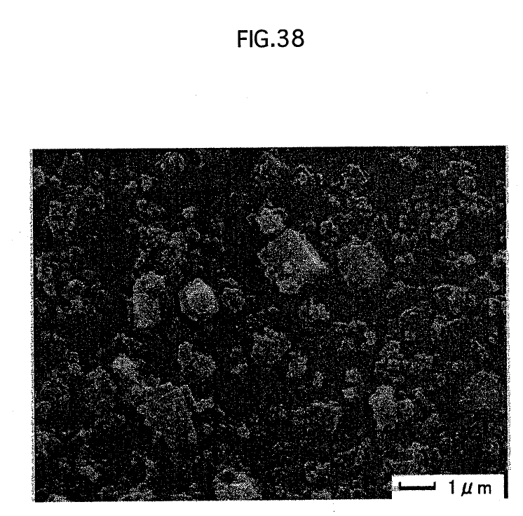

The primary particles of the emitter 4012b are formed from single crystals, and are formed from single-crystal magnesium oxide microparticles, the average particle diameter of such single crystals being less than or equal to 1 [μm]. These single-crystal magnesium oxide microparticles are produced by a gas-phase oxidation reaction between metallic magnesium vapor and oxygen, and have, for example, the cubic single-crystal structure shown in the electron microscope photograph of FIG. 38.

The emitter 4012b is formed by applying an emitter application liquid to the metal sleeve 4012a, the emitter application liquid being a mixture of the single-crystal magnesium microparticles, a binder, and a solvent, and then performing heat processing. For example, nitrocellulose, ethylcellulose, or polyethylene oxide can be used as the binder. Also, for example, butyl acetate or an alcohol expressed in the chemical formula CₙH₂ₙ₊₁OH (n=1 to 4) can be used as the solvent.

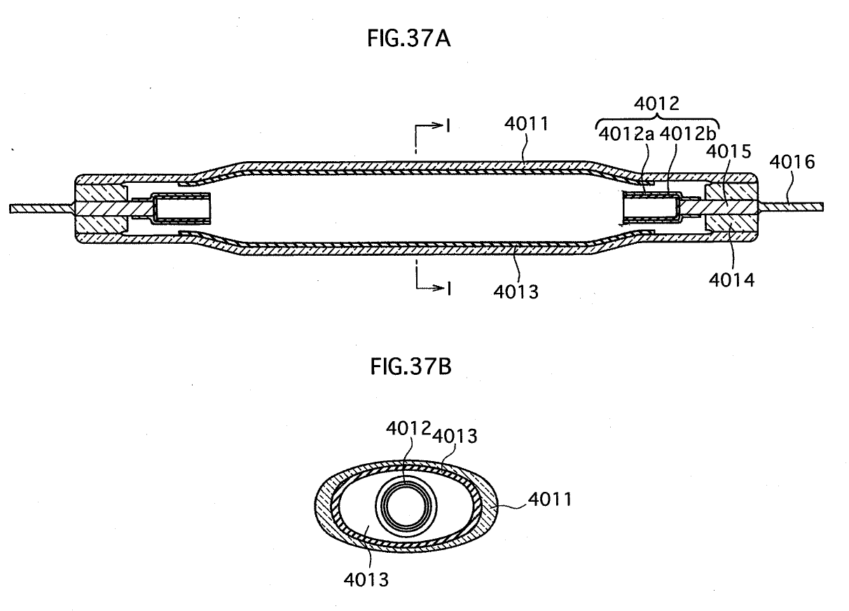

Also, although FIG. 33 depicts the straight tube shaped fluorescent lamp 4010, the fluorescent lamp of the present invention is not limited to this, and a curved tube having a U-shape or a U-shape with three straight parts may also be used. Also, the fluorescent lamp 4010 is not limited to being a cylindrical type lamp having a circular cross section. For example, a flattened type lamp having an elliptical cross section, as shown in FIG. 37A, may also be used. Note that FIG. 37B shows a cross section taken along line I-I′.

### Working Examples of Embodiment 12

The following specifically describes exemplary cold cathode fluorescent lamps of embodiment 12 with use of working examples.

### Working Example 1

Working example 1 describes an example of a fluorescent lamp 10 that is similar to fluorescent lamps described in previous embodiments. With reference to FIG. 33, in the fluorescent lamp 4010, a tungsten inner lead wire 4015 having a 0.6 [mm] outer diameter is inserted in one end of the nickel metal sleeve 4012a which has a 1.7 [mm] outer diameter (S1), a 1.5 [mm] inner diameter (S2), a 5.5 [mm] cup length (L1), and a 1.5 [mm] base portion length (L2). The inner lead wire 4015 and the metal sleeve 4012a are joined together in the fluorescent lamp 4010 by pinch-sealing one end of the metal sleeve 4012a.

The glass bulb 4011 has a 2.4 [mm] outer diameter, a 2.0 [mm] inner diameter, and is formed from borosilicate glass. Electrodes 4012 have been disposed on respective ends of the glass bulb 4011. The electrodes 4012 include the emitter 4012b that is formed from single-crystal magnesium oxide microparticles whose the original particles are single crystals, the average particle diameter of such single crystals being less than or equal to 1 [μm].

Also, both ends of the glass bulb 4011 are sealed by glass beads 4014 that are formed from borosilicate glass, and the inner lead wire 4015 passes through the glass bead 4014 and connects to the stainless steel outer lead wire 4016. The distance between the ends of the pair of electrodes 4012 has been set at 330 [mm]. Also, a phosphor film 4013 has been formed on the inner face of the glass bulb 4011, and the interior thereof is filled with a mixed gas of argon and neon to a pressure of 8 [kPa] as well as mercury.

For the phosphor film 4013, phosphors of three wavelength types, including a blue phosphor composed of europium-activated barium-magnesium aluminate [BaMg₂Al₆O₂₇:Eu²⁺] (abbreviation: BAM-B), a green phosphor composed of cerium and terbium activated lanthanum phosphate [LaPO₄:Ce³⁺,Tb³⁺] (abbreviation: LAP), and a red phosphor composed of europium-activated yttrium oxide [Y₂O₃:Eu³⁺] (abbreviation: YOX), were mixed at a weight ratio of BAM-B:LAP:YOX=4:3:3.

The fluorescent lamp of working example 1 was created by the following method.

To begin with, the emitter 4012 was formed on an inner face of the metal sleeve 4012a by the following method. First, single-crystal magnesium oxide microparticles were prepared, the average particle diameter of the single crystals being less than or equal to 1 [μm]. Thereafter, the emitter application fluid was prepared by dispersing 10 [mg] of the microparticulate single-crystal magnesium oxide into 20 [liters] of a mixed solution of nitrocellulose (the binder) and butyl acetate (the solvent) (the nitrocellulose being 1.5 [wt %] of the butyl acetate solution). Next, the emitter application liquid was applied by a spray method to the inner face of the metal sleeve 4012a, and allowed to dry naturally in the air.

Thereafter, the electrode 4012 including the emitter 4012b was formed by affixing the single-crystal magnesium oxide microparticles to the metal sleeve 4012a by heating the metal sleeve 4012a to which the emitter application fluid had been applied to approximately 550[° C.] in an argon atmosphere reduction furnace, and removing the binder and solvent.

Next, the electrodes 4012 were disposed on respective ends of the glass bulb 4011 to which the phosphor film 4013 was applied, and first only one of the electrodes 4012 was sealed by heating via the glass bead 4014 in an argon atmosphere. Next, mercury and a mixed gas of argon and neon was introduced to the glass bulb 4011 to 8 [kPa], and lastly the other electrode 4012 and the glass bulb 4011 are sealed via the glass bead 4014 by heating the glass bead 4014, creating the fluorescent lamp of working example 1.

### Comparative Example 1

The fluorescent lamp of comparative example 1 was created in the same way as working example 1, except that the metal sleeve 4012a used did not have the emitter 4012b formed thereon.

### Comparative Example 2

The fluorescent lamp of comparative example 2 was created in the same way as working example 1, except that magnesium oxide microparticles having an 18 [μm] average particle diameter were used in place of single-crystal magnesium oxide microparticles.

Measurement of Lamp Voltage

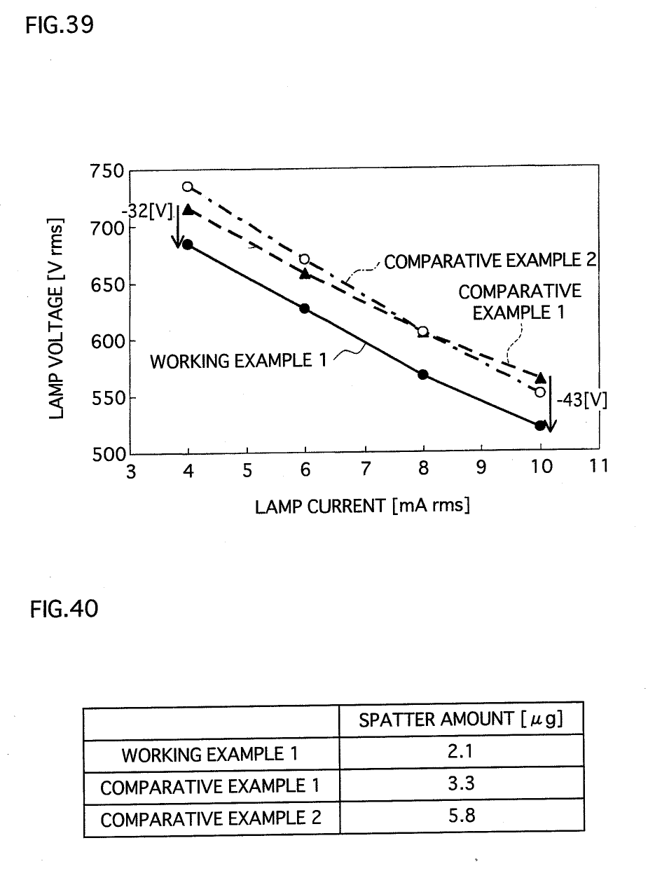

Lamp voltage (effective value: Vrms) was measured by lighting the fluorescent lamps of working example 1 and comparative examples 1 and 2 with use of a high-frequency lighting circuit under the conditions of a 25[° C.] surrounding temperature, 4 [mArms] (effective value) lamp current, and 60 [kHz] lighting frequency. Also, the lamp voltage was measured after similarly changing the lamp currents to 6 [mArms], 8 [mArms], and 10 [mArms]. The results are shown in FIG. 39.

As illustrated in FIG. 39, working example 1 enables reducing the lamp voltage by between 32 [Vrms] and 43 [Vrms] over comparative examples 1 and 2.

### Measurement of Spatter Amount

Spatter amount was measured by lighting the fluorescent lamps of working example 1 and comparative examples 1 and 2 with use of a high-frequency lighting circuit for 6000 [hours] under the conditions of a 25[° C.] surrounding temperature, 6 [mArms] (effective value) lamp current, and 60 [kHz] lighting frequency. Here, spatter amount refers to the total quantity of scattered component of the emitter 4011 and the metal sleeve 4012a that are deposited on, and adhere to, the inner wall of the glass bulb 4011, after such ingredients have scattered due to ion bombardment resulting from the cold cathode operation. The scattered quantity was extracted by immersing both ends of the glass bulb 4011 near the electrodes 4012 in acid, and dissolving the scattered quantity in the acid. The spatter amount was obtained by analyzing the solution in which the scattered quantity has been dissolved with use of ICP mass spectrometry.

FIG. 40 is a table showing the results of a comparative measurement of spatter amounts.

As illustrated in FIG. 40, working example 1 has a lower spatter amount than comparative examples 1 and 2, leading to a longer life of the fluorescent lamp. Note that the MgO component from the scattering of the emitter 4012b and the Ni component from the scattering of the metal sleeve 4012a are included in the spatter amounts of working example 1 and comparative example 2, and only the Ni component from the scattering of the metal sleeve 4012a is included in the spatter amount of comparative example 1.

Although the glass bulb 4011 has been formed from borosilicate glass in the above description, a similar effect can be achieved if a silica protective film has been formed on an inner surface of a glass bulb manufactured from soda glass.

### Embodiment 6

Before describing the structures of embodiments 6 to 9, the background of arriving at the structures is described below.

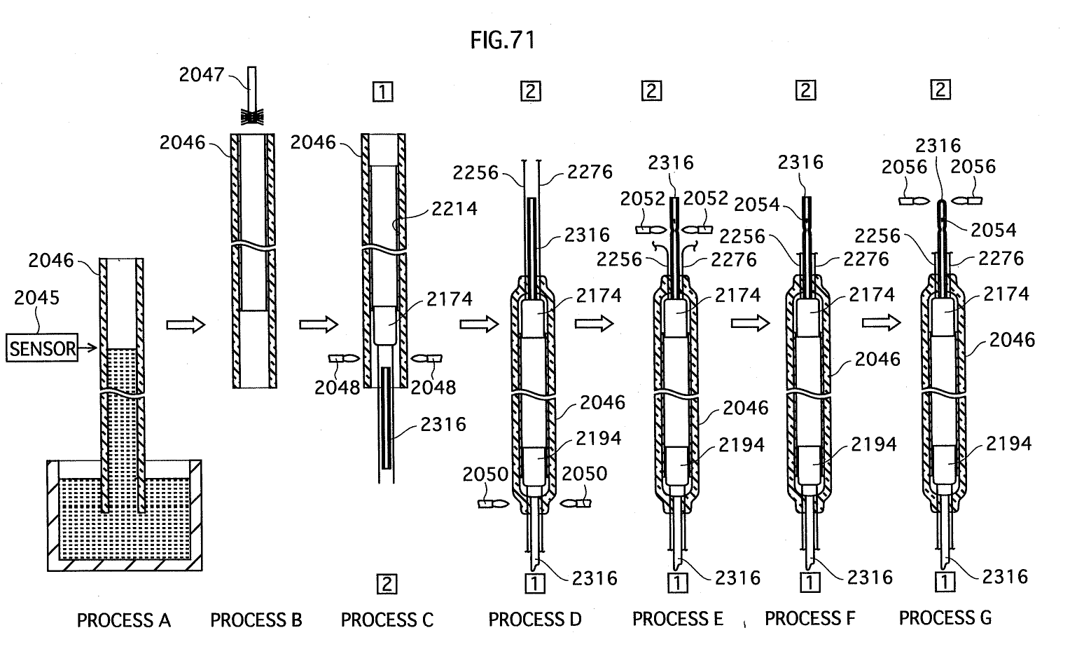

In recent years, in order to improve production efficiency in response to increased demand for liquid crystal display apparatuses, manufacturers of liquid crystal display apparatuses have been begun to automate insertion of cold cathode fluorescent lamps 6901 in backlight units. In the automatic insertion of the cold cathode fluorescent lamps 6901 shown in FIG. 51, ease of connecting a lead wire 6905 and a socket is important. To such purpose, a socket 6006 as shown in FIG. 71 is used. The socket 6006 is formed from sheets of stainless steel or phosphor bronze, and includes a fitting portion 6006a into which the lead wire 6905 has been fitted. The fitting portion 6006a is elastically deformed so as to be stretched open, and the lead wire 6905 is fit into the fitting portion 6006a. As a result, the lead wire 6905 that has been fitted into the fitting portion 6006a and gripped by the restoring force of the fitting portion 6006a does not readily detach. This structure enables easily fitting the lead wire 6905 into the fitting portion 6006a and preventing detachment thereof.

However, when the lead wire 6905 is fitted into the fitting portion 6006a, force is applied to a portion of the lead wire 6905 that projects from a tube end of a glass bulb 6902, such force including a component substantially perpendicular to the wire axis of the lead wire 6905. Since the fulcrum is an outward base portion 6905 (hereinafter referred to as the base portion 6905b of the lead wire) where the lead wire 6905 is attached to a glass bulb 6902 externally to a sealed portion 6902a, the sealed portion 6902a of the glass bulb 6902 bears the load, and cracks may form.

To prevent such cracks from forming, a ceramic or resin heat-resistant sealing member 6907 has been proposed that covers the outside of the sealed portion 6902a as shown in FIG. 51 (for example, see Japanese Patent Application No. H10-112287).

However, cracks may form in the sealed portion 6902a of the glass bulb 6902 even if the ceramic or resin heat-resistant sealing member 6907 covers the outside of the sealing portion 6902a of the glass bulb 6902.

In view of the above problem, a fluorescent lamp is proposed in embodiments 6 to 7 that sufficiently prevents cracks from forming in a sealed portion of a glass bulb, for example when fitting a lead wire in a socket.

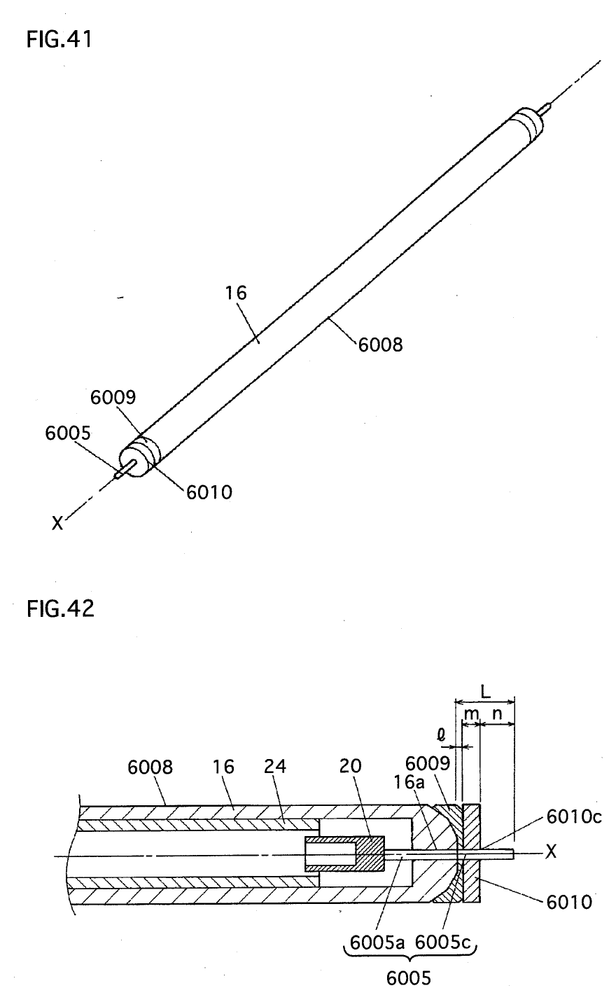

The fluorescent lamp of embodiment 6 of the present invention is shown in FIG. 41. An enlarged cross-sectional view of a relevant portion of the lamp of FIG. 41 including the tube axis is shown in FIG. 42. Note that although the fluorescent lamps of embodiments 6 to 9 each have a protective film similar to the fluorescent lamp 10 (FIG. 1) of embodiment 1, depiction of the protective film has been omitted from all of the drawings pertaining to embodiments 6 to 9.

As shown in FIG. 41, the fluorescent lamp pertaining to embodiment 2 is a straight tube shaped cold cathode fluorescent lamp 6008 for use in a backlight (hereinafter called a “lamp 6008”), and includes the glass bulb 16, electrodes (not depicted) provided in the glass bulb 16 on both ends thereof, the lead wire 6005 of which one end is connected to one of the electrodes and the other end extends outside a tube end of the glass bulb 16, and a member 6010 that is attached outside the tube end of the glass bulb 16 via a buffer 6009. Note that similarly to embodiment 1, the lengths of the non-phosphor layer 24 areas on one end of the glass bulb 16 and the other end are different from each other.

The glass bulb 16 is made of soda glass, and a cross section sectioned perpendicular to the tube axis X direction is circular. The total length is 730 [mm], the outer diameter is 4 [mm], the inner diameter is 3 [mm], and the thickness is 0.5 [mm].

The lead wire 6005 includes, for example, a tungsten (W) inner lead wire 6005a and a nickel (Ni) outer lead wire 6005c that bonds easily to solder or the like, and a joint surface between the inner lead wire 6005a and the outer lead wire 6005c is in substantially the same plane as the outer surface of the glass bulb 16. Specifically, one end of the inner lead wire 6005a is electrically and mechanically connected to the bottom of the hollow electrode 20, and most of the other end that is connected to the outer lead wire 6005c has been sealed to the glass bulb 16. Substantially an entirety of the outer lead wire 6005c is positioned outside the glass bulb 16. A cross section of the inner lead wire 6005a is substantially circular. The total length is 3 [mm] and the wire diameter is 1.0 [mm]. A cross section of the outer lead wire 6005c is substantially circular. The total length L is 10 [mm], and the wire diameter is 0.8 [mm].

Note that the structure of the lead wire 6005 is not limited to the above structure. For example, the inner lead wire 6005a and the outer lead wire 6005c may be structured as one wire that is not separated, or the inner lead wire 6005a or the outer lead wire 6005c may be composed of even more connected lines.

The substantially disc-shaped member 6010 has been mounted on an outer side of the tube end of the glass bulb 16, specifically the end face, via the buffer 6009 that is composed of a heat-resistant elastic adhesive of epoxy resin or the like. The outer lead wire 6005c that projects out of the glass bulb 16 and extends in a straight line therefrom has been fitted in the member 6010. The member 6010 is, for example, formed from nickel (Ni). For example, the outer diameter is 4 [mm], and the thickness m is 5 [mm]. Furthermore, a through hole 6010c having a diameter of 0.8 [mm] is provided in a central portion of the member 6010 for the outer lead wire 6005c to be fitted therein. Here, the member 6010 has less elasticity than the buffer 6009. For example, the elasticity of Ni is approximately 200 [GPa], and the elasticity of a buffer 6009 composed of, for example, a heat-resistant elastic adhesive of epoxy resin is approximately 10 [Mpa]. Note that elasticity here indicates Young's modulus.

When the inner lead wire 6005a and the outer lead wire 6005c have been soldered together by, for example, laser welding, and a ball-shaped joint bulge has formed at the joined portion, the distance between the end of the member 6010 on the glass bulb 16 side and the tube end of the glass bulb 16 is preferably 0.5 [mm]. This is to cause the member 6010 to be securely attached on the outside of the end of the glass bulb 16 via the buffer 6009. Also, a preferable length of the portion of the lead wire 6005 that projects from the member 6010 is 5 [mm]. This is to ensure stability of contact with the socket 6006 (see FIG. 71).

Note that the buffer 6009 and the member 6010 are not limited to the above structures. For example, rubber (elasticity: approximately from 1.5 [MPa] to 5.0 [MPa]), polyethylene (elasticity: approximately 0.7 [GPa]) and the like can be used to form the buffer 6009. Although a highly adhesive material such as elastic adhesive is preferable for the buffer 6009, when adhesiveness is low between the buffer 6009 and the member 6010, joining the member 6010 and the outer lead wire 6005c with use of solder or the like helps affixing the member 6010 to the outer lead wire 6005c. Also, for example, aluminum (elasticity: approximately 70 [GPa]) or copper (elasticity: approximately 130 [GPa]) can be used as the member 6010. Note that the elasticity difference between the buffer 6009 and the member 6010 is preferably greater than or equal to one place value.

As described above, the structure of the fluorescent lamp pertaining to embodiment 6 enables preventing cracks from forming in the sealed portion 16a of the glass bulb 16, even if force including a component substantially perpendicular to the wire axis of the lead wire 6005 is applied thereto, for example when fitting the lead wire 6005 into the socket 6 or due to the shock of transfer after incorporating the lamps 6008 into the backlight unit. Specifically, since the fulcrum of the force exerted on the lead wire 6005 is the place where the lead wire 6005 and the member 6010 have been joined, the force is only transferred to the sealed portion 16a of the glass bulb 16 via the buffer 6009, thus enabling reducing the load on the sealed portion 16a.

As an aside, similarly to embodiment 1, a first sealed section side and a second sealed section side of the lamps 6008 can be distinguished by appropriately marking one or both of the members 6010, or changing the color of at least one portion of the members 6010.

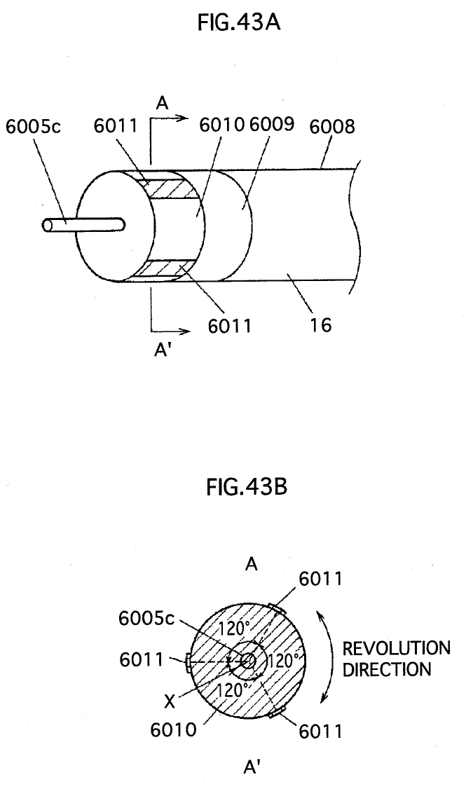

FIG. 43 shows an example of marking a side face of the member 6010 in the revolution direction. FIG. 43A is a perspective view of one end of the lamp 6008, and FIG. 43B shows a cross section taken along A-A′.

Also, when the difference in length of the members 6010 in the tube axis X direction is greater than or equal to 2 [mm], the orientation of the lamps 6008 can be detected by the difference in length.

Also, making the members 6010 at least partially different in color from each other and using a sensor to detect the difference in color enables increasing the reliability of detection over a case of detecting the mark 6011 with use of a sensor as described above.

Furthermore, detecting the manufacturer of a lamp is also possible when a lot number, manufacturing number or the like has been marked on the member 6010 on an end face on the opposite side from the glass bulb 16, or on a side face in the revolution direction.

### Embodiment 7

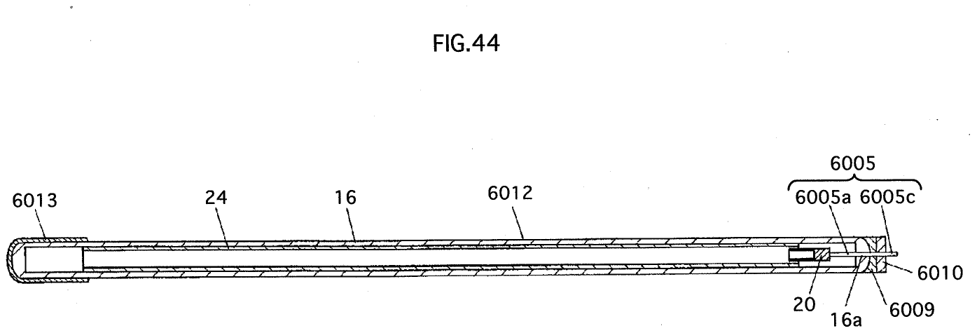

FIG. 44 is a cross-sectional view of a fluorescent lamp of embodiment 7 of the present invention including a tube axis thereof. A fluorescent lamp 6012 pertaining to the present embodiment is an external/internal electrode type fluorescent lamp (hereinafter referred to simply as “lamp 6012”) that has been formed to combine the benefits of both a cold cathode fluorescent lamp and an external electrode-type fluorescent lamp. An external electrode 6013 has been formed on an end of the lamp 6012, and an internal electrode 20 similar to the electrode 20 of the fluorescent lamp pertaining to embodiment 2 has been disposed on the other end. Otherwise, the lamp 6012 has the same structure as the fluorescent lamp of embodiment 6. Also, similarly to embodiment 1, the lengths of the non-phosphor layer 32 areas are different on one end and on the other end of the glass bulb 26. Accordingly, in the following description of the external electrode 6013, members that are the same as in lamps 20 (see FIG. 2) have been given the same reference notations, and description thereof is omitted.

The external electrode 6013 is composed of, for example, aluminum leaf, and has been adhered to the glass bulb 16, with use of an electrically conductive adhesive formed by mixing a metallic powder with silicon resin (not depicted), so as to cover the outer circumference face of the end of the glass bulb 16. Note that fluoride resin, polyimide resin, epoxy resin or the like may be used instead of silicon resin in the electrically conductive adhesive. Also, the external electrode 6013 may be formed by ultrasonically dipping the solder.

Also, instead of being formed from aluminum leaf adhered to the glass bulb 16 with use of an electrically conductive adhesive, the external electrode 6013 may be formed by applying a silver paste to an entirety of the electrode forming portion of the glass bulb 16, or by covering the tube end of the glass bulb 16 with a metal base.

As described above, the fluorescent lamp structure pertaining to embodiment 3 enables preventing cracks from forming in the sealed portion 26a of the glass bulb 26 even if force including a component substantially perpendicular to the wire axis of the lead wire 6005 is applied, for example when fitting the lead wire 6005 into the socket 6, or due to the shock of transfer after incorporating the lamps 6012 into the backlight unit. Specifically, since the fulcrum of the force exerted on the lead wire 6005 is the place where the lead wire 6005 and the member 6010 have been joined, the force is only transferred to the sealed portion 26a of the glass bulb 26 via the buffer 6009, thus enabling reducing the load on the sealed portion 26a.

Variations of Embodiments 6 to 7

Although described based on specific examples indicated in embodiments 6 to 7 described above, the present invention is of course not limited to the specific examples indicated in such embodiments. Variations such as the following are also included in the present invention.

1. Variation 1

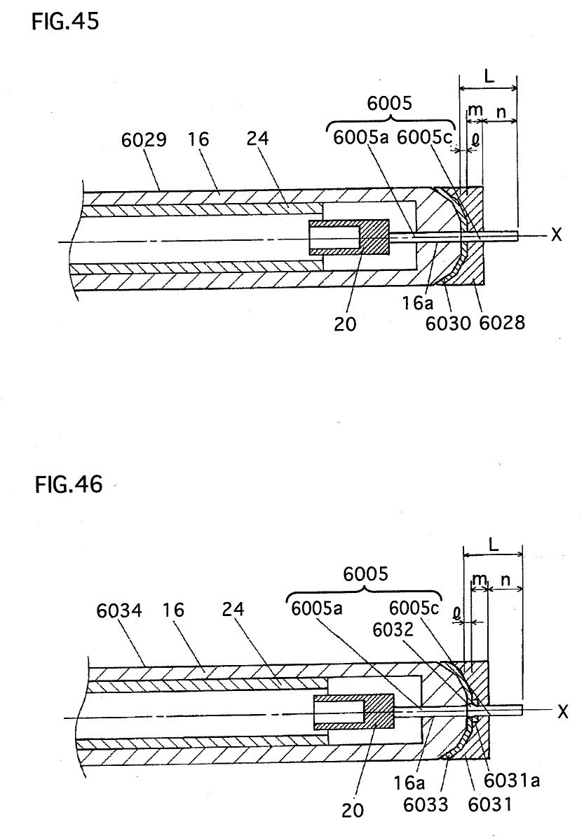

As one working example, the face of a member 6028 may have a concave shape on the glass bulb 16 side, as shown in FIG. 45. In such a case, the area of the end face of the glass bulb 16 side of the member 6028 is larger than when the face is substantially planar, thus enabling greater diffusion of force on the member 6028 that is transmitted from the member 6028 to the tube end of the glass bulb 16 when fitting the lead wire 6005 of the fluorescent lamp 6029 into the socket 6006, and further reducing the risk of cracks in the sealed portion 26a of the glass bulb 16. Also, since the tube end of the glass bulb 16 normally has a rounded shape, this structure enables fixing the member 6028 more securely than when the member 6028 has a planar end face on the glass bulb 26 side. Furthermore, using a resin-based adhesive for a buffer 6030 enables forming the resin-based adhesive in a thinner layer and improving adhesion between the member 6028 and the glass bulb 16.

2. Variation 2

Also, as another working example, a concave part 6031a may be formed on a portion of the face of the member 6031 on the glass bulb 16 side, into which the lead wire 6005 has been fitting as shown in FIG. 46. Generally speaking, the inner lead wire 6005a and the outer lead wire 6005c have been joined by laser welding for example, and a ball-shaped joint bulge 6032 has formed at the joined portion. In view of this, as shown in FIG. 46, forming the concave part 6031a in the member 6031 enables fitting the joint bulge 6032 into the concave part 6031a and applying the buffer 6033 more thinly when elastic adhesive is used as the buffer 6033, thereby improving adhesiveness between the member 6031 and the glass bulb 16.

3. Variation 3

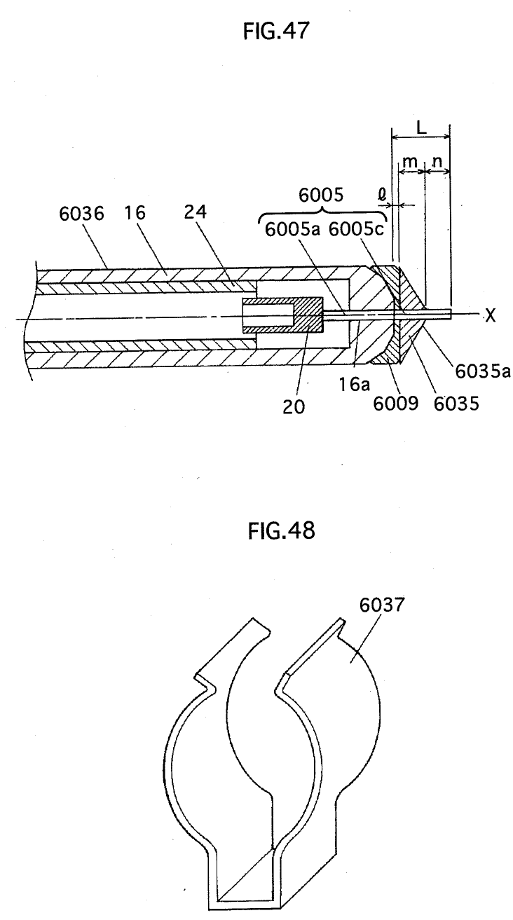

Also, as another working example, the member 6035 may be substantially conical in shape, and may be mounted to the glass bulb 16 in such a way that an incline 6035a is on the opposite side from the glass bulb 16, as shown in FIG. 47. This structure enables enlarging the marked area without increasing the measurements of the member 6035, and by marking the incline 6035a, increases detectability of the identifying marks. Also, when the member 6035 is formed from metal, for example, an excessive increase of heat dissipation effect can be suppressed more than when the member 6035 has a disc shape having a same thickness in the tube axis X direction, mercury quasi-clustering in the vicinity of the electrode 20 can be prevented from occurring due to a temperature drop in the vicinity of the electrode 20, and the life of the fluorescent lamps 6036 can be prolonged.

4. Variation 4

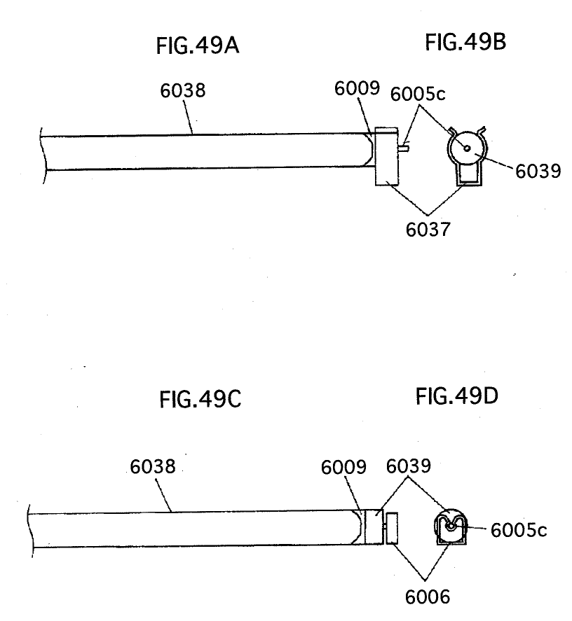

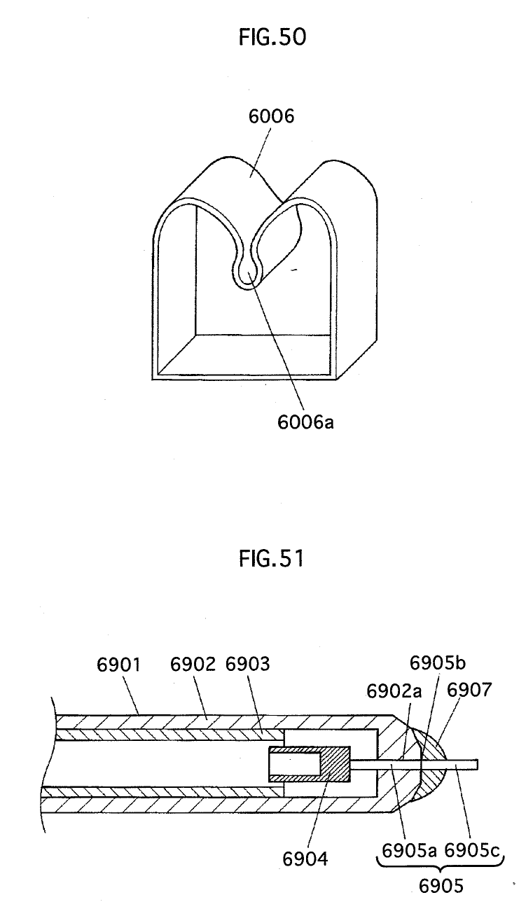

Also, as another working example, forming a member 6039 (see FIG. 49) from a conductive material and electrically connecting the outer lead wire 6005c to the member 6039 with use of solder, etc. enables fitting into an external electrode type fluorescent lamp socket 6037 as shown in FIG. 48. Also, when the electrically conductive material is metal, depending on the size thereof, an excessive rise in temperature of the electrode 20 can be suppressed due to the heat dissipation effect. FIGS. 49A, 49B, 49C, and 49D show the mounting conditions of a fluorescent lamp 6038 in the sockets 6006 and 6037. FIG. 49A is a front view showing the cold cathode fluorescent lamp 6038 being installed in the external electrode socket 6037, and FIG. 48B is a side view of the socket. Also, FIG. 18C is a front view of the cold cathode fluorescent lamp 6038 being inserted into the cold cathode fluorescent lamp socket 6006 (see FIG. 49), and FIG. 49D is a side view of the socket. As shown in FIGS. 49A to 49D, the fact that the member 6039 is conductive enables providing fluorescent lamps 6038 that are compatible with different types of sockets 6006 and 6037 for cold cathode fluorescent lamps and external electrode type fluorescent lamps.

### Embodiment 8

Embodiments 8 to 13 provide a fluorescent lamp that suppresses the load on the glass bulb ends while being supported and employs a sealing method that enables an electrical connection.

Before describing the structure of embodiment 8, the background of arriving at the structures is described below.

Conventionally, fluorescent lamps used in backlights for liquid crystal display apparatuses, etc. have been becoming more and more compact in response to the demand for compactness in liquid crystal display apparatuses, etc.

Conventional compact fluorescent lamps for backlights employ a so-called bead glass sealing technique in which the glass bulb ends that are constituent elements of the lamps are sealed during the manufacturing process with use of a cylindrical bead glass. A discharge lamp is supported in the lighting position of the housing by a lead-in wire projecting externally to the glass bulb from the bead sealed end, thereby electrically connecting the discharge lamp and the housing (see Japanese Patent Application 2005-183011 and Japanese Patent Application 2005-294019). Power is supplied to an electrode in the discharge lamp and the discharge lamp is lit through this lead-in wire.

Also, there is a fluorescent lamp in which a base of a bottomed cylinder is disposed so as to cover the so-called bead glass sealed end (see Japanese Patent No. 3462306, Japanese Utility Model Application No. S64-48851, and Japanese Patent Application Publication No. H07-262910), the lamp is supported in the housing by the base, and is electrically connected to an electrical contact on the housing side.

In recent years, even in liquid crystal display apparatuses, there is a demand for larger liquid crystal monitors for personal computers, liquid crystal television receivers, etc., and in response to this demand, there is also a demand for large-size, large-diameter fluorescent lamps for backlights.

The sealing process for a large-diameter glass bulb, in response to the demand for large size described above, requires newly preparing a large-diameter bead glass when bead glass sealing is employed. In addition to the difficulty of manufacturing a bead glass with a large outer diameter and a small inner diameter, bead glasses must also be prepared to have different measurements according to the variations of glass bead diameter, leading to higher cost. Therefore, the inventor is considering using so-called pinch sealing in place of bead sealing in the glass bulb sealing process.

Pinch sealing is well suited for sealing the above-described large-diameter bulb since a bead glass is not required.

However, when pinch sealing is employed on a fluorescent lamp for a backlight, after pinch-sealing the lead-in wire, it is necessary to seal the glass bulb end to a gas exhaust tube, the gas exhaust tube being a tube for supplying gas to, and discharging gas from, the glass bulb under normal pressure, and since a site where the lead-in wire can be disposed is smaller than when bead sealing is used, a thinner lead-in wire is necessary, thus increasing the risk of the lead-in wire bending or breaking, and being unable to support the discharge lamp.

In the pinch-sealing technique, the glass bulb end is covered by the base and pinch sealed, and the fluorescent lamp is supported by the base and electrically connected to the electrical contact on the housing side. Therefore, processing strain on the end is greater than in the bead sealing technique. When the end that experiences great processing strain is covered by the base, cracks develop along the end due to stress caused by differences in temperature in the base and the glass bulb end depending on whether the lamp is lit or unlit. There is a risk of a hindrance to lighting the lamp due to the discharge gas, which had been sealed inside the interior of the glass bulb, leaking from the cracked places.

Embodiment 8 was achieved in view of the above problem, and provides a fluorescent lamp that suppresses the load on the glass bulb end while being supported and is electrically connectable, and a lighting apparatus that includes such a fluorescent lamp.

The following describes a cold cathode fluorescent lamp and backlight unit (lighting apparatus) pertaining to embodiment 8 with use of the drawings. The present embodiment describes an example of a cold cathode fluorescent lamp as the fluorescent lamp.

1. Structure of Direct Type Backlight Unit

Since the structure of a direct type backlight unit 2005 pertaining to the present embodiment is basically similar to the structure of the backlight unit 1 shown in FIG. 1, description of the overall structure thereof has been omitted.

FIG. 52 is a perspective view of a relevant portion of a backlight unit 2005. On a bottom wall 11a of an inner face 11 of the outer case 106, a socket 2084 has been provided in a position corresponding to a peripheral area of the optical sheet 16, and bases 2072 of a cold cathode fluorescent lamp 2007 have been fitted into respective sockets 2084 so as to be held by, and electrically connected to, the sockets 2084.

2. Structure of the Cold Cathode Fluorescent Lamp

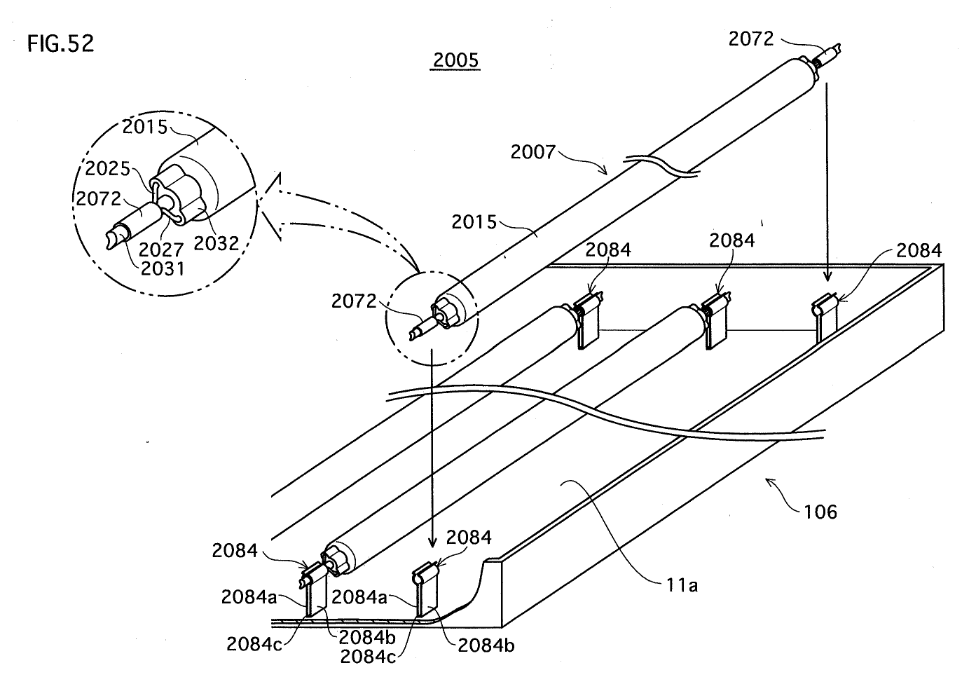

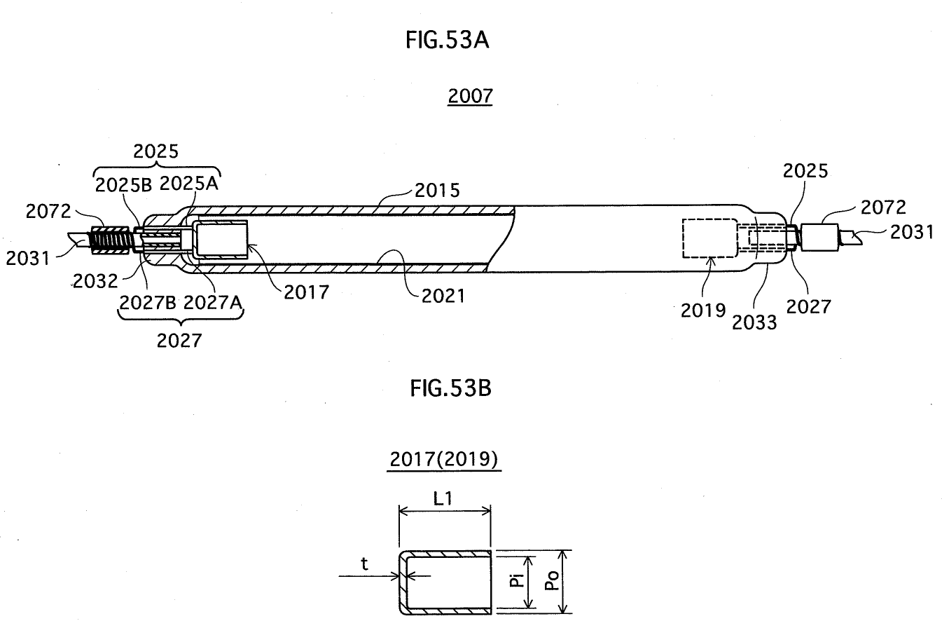

Next, the structure of the cold cathode lamp 2007 pertaining to the present embodiment (hereinafter simply referred to as “the lamp 2007”) is described with reference to FIG. 53. FIG. 53A shows the overall structure of the cold cathode fluorescent lamp 2007 having one portion cut away. FIG. 53B shows a cross section of the electrodes 2017 and 2019.

The lamp 2007 includes a glass bulb (glass container) 2015 that has a straight tube shape whose cross section is substantially circular. For example, the glass bulb 2015 has a 6.0 [mm] outer diameter and a 5.0 [mm] inner diameter, and is made from soda glass or borosilicate glass. In the present embodiment, soda glass is used. The measurements of the lamp 2007 described below are values corresponding to the measurements of the glass bulb 2015 that has a 6.0 [mm] outer diameter and a 5.0 [mm] inner diameter. Needless to say, these values are an example and should not be construed as limiting the embodiment.

Mercury in the glass bulb 2015 occupies a predetermined ratio of the cubic capacity of the glass bulb 2015, for example, such that the glass bulb 2015 is filled to 0.6 [mg/cc], and the glass bulb 2015 is filled to a predetermined filling pressure, for example 20 [Torr] (20×133.32 [Pa]), with a noble gas such as argon or neon. Note that argon gas is used as the noble gas mentioned above.

Also, a phosphor layer 2021 has been formed on an inner face of the glass bulb 2015. The phosphor layer 2021 includes red phosphor, green phosphor, and blue phosphor that convert ultraviolet radiation emitted from the mercury into red, green, and blue light respectively.

The phosphor layer 2021 is uneven in the lengthwise direction of the glass bulb 2015, and is for example thicker towards the second sealed portion side than the first sealed portion side. This unevenness in film thickness influences the light emitting property of the lamps 2007 when lit.

Furthermore, pinch-sealed portions 2032 and 2033 have been formed on respective ends of the glass bulb 2015. Two lead-in wires 2025 and 2027 extend externally from the sealed portions 2032 and 2033 of the glass bulb 2015.

The lead-in wires 2025 and 2027 are connected wires constituted from an inner lead wire 2025A (2027A) made of, for example, Dumet wire, and an outer lead wire 2025B (2027B) made of nickel. The inner lead wire 2025A (2027B) has a 0.3 [mm] wire diameter and a 10 [mm] total length, and the outer lead wire 2025B (2027B) has a 0.3 [mm] wire diameter and a [mm] total length.

Note that also, for example, gas exhaust tubes 2031 whose outer diameters are 2.4 [mm] and inner diameters are 1.6 [mm] have been sealed to the sealed portions 2032 and 2033.

A hollow type nickel (Ni) electrode 2017 (2019) has been fixed to a tip of the inner lead wire 2025A (2027A). The fixing is performed by laser welding, for example.

The electrodes 2017 and 2019 have the same shape, and the measurements of each portion shown in FIG. 53B are as follows. The electrode length L1 is 12.5 [mm], the outer diameter pO is 4.70 [mm], the inner diameter pi is 4.20 [mm], and the thickness t is 0.10 [mm].

When the lamps 2007 are lit, electrical discharge occurs between an inner face of the tube of the bottomed-tube shaped electrode 2017 and an inner face of the tube of the similarly bottomed tube shaped electrode 2019.

The shapes of the electrodes 2017 and 2019 are not limited to this, and may be rod or plate shaped. Although the number of the lead-in wires 2025 and 2027 relative to the sealed portions 2032 and 2033 of the glass bulb 2015 may be one each, sealing two lead-in wires 2025 and 2027 each enables more reliably supporting the electrodes 2017 and 2019 with the lead-in wires 2025 and 2027 that are thinner than a case of bead-sealing, and is also preferable due to ease of positioning during manufacture when aligning the axis position of the electrodes 2017 and 2019 to the axis position of the glass bulb 2015.

The internal end of each gas exhaust tube 2031 is in contact with space in the glass bulb 2015, and is positioned closer to a sealed portion 2032 or 2033 side than the electrodes 2017 and 2019 that are mounted on the tips of the lead-in wires 2025 and 2027.

The external end of each gas exhaust tube 2031 projects to a predetermined distance externally from the sealed portions 2032 and 2033. For example, the ends extend to 8 [mm] from the outer ends of the sealed portions 2032 and 2033 respectively, and are tipped off and sealed.

Note that the glass bulb 2015 is not completely sealed at the previously described “sealed portions 2032 and 2033”. After gas is supplied to and discharged from the inner space of the glass bulb 2015 under normal pressure via the gas exhaust tubes 2031 that have been sealed by the sealed portions 2032 and 2033, each outer end of the gas exhaust tube 2033 is sealed, and the glass bulb 2015 is completely sealed.

Also, the lead-in wires 2025 and 2027 that extend from the glass bulb 2015 are wound around respective portions extending externally from the sealed portions 2032 and 2033 of the gas exhaust tube 2033, the bases 2072 are fixed in such a way as to cover the lead-in wires 2025 and 2027 and the extending portions of the gas exhaust tube 2031 that the lead-in wires 2025 and 2027 are wound around, thereby hermetically sealing the respective bases 2072 of the lead-in wires 2025 and 2027 and the extending portions of the gas exhaust tube 2031.

Unlike supporting the cold cathode fluorescent lamps only by the lead-in wires and electrically connecting the lamps to the lead-in wires and an electrical contact on the outer case side, this structure enables suppressing a load that would cause the lead wires 2025 and 2027 to break while supporting the lamps 2007 and electrically connecting the lamps 2007 to the lead-in wires 2025 and 2027 and the socket 2084 on the outer case 106 side (see FIG. 52), since the bases 2072 are fixed respectively to the extending portions of the gas exhaust tube 2031 while contact is maintained with the lead-in wires 2025 and 2027.

Furthermore, employing this structure enables suppressing, more than in conventional bead sealing, the load on the glass bulb 2015 end that experiences great processing strain, and electrically connecting the lamp 2007 to the socket 2084 on the outer case 106 side while supporting the cold cathode fluorescent lamp 2007.

The bases 2072 are sleeve-shaped, and although before being affixed, the inner diameter thereof is smaller than the outer diameter of the gas exhaust tube 2031 after the lead-in wires 2025 and 2027 have been wound, the inner diameter has been widened, and the gas exhaust tube 2031 has been fitted affixed by elastic force. The method for affixing the bases 2072 is not limited to this, and instead affixing may be performed with use of solder or an electrically conductive adhesive when, before being affixed, the inner diameter of the bases 2072 is larger than the outer diameter of the gas exhaust tube 2031 after the lead-in wires 2025 and 2027 have been wound. Also, the bases 2072 are not limited to the shape described above, and may be cap-shaped.

Forming a slit in the sleeve-shaped bases 2072 from one open side end to another open side end parallel to the sleeve axis direction is preferable, and facilitates insertion and fixing by elastic force.

Although in the present embodiment, the lead-in wires 2025 and 2027 have been wound around the projecting portions of the gas exhaust tube 2031 and the bases 2072 have been affixed thereon, the present invention is not limited to this, and the bases 2072 may be affixed to the extending portions of the gas exhaust tube 2031 when the unwound lead-in wires 2025 and 2027 extend from the sealed portions 2032 and 2033 of the glass bulb 2015.

Winding the lead-in wires 2025 and 2027 around the extending portions of the gas exhaust tube 2031 enables more reliable electrical connection between the lead-in wires 2025 and 2027 and respective bases 2072 than when the bases 2072 are affixed onto the lead-in wires 2025 and 2027 that, unwound, extend outward. In particular, using sleeve-shaped bases 2072 that have slits enables preventing the bases 2072 from failing to enclose the lead-in wires 2025 and 2027, and is preferable from the standpoint of improving yield.

Affixing the bases 2072 to the gas exhaust tube 2031 with use of solder or electrically conductive adhesive enables reducing the load to the gas exhaust tube 2031 farther than insertion and affixation by elastic force, and is therefore preferable. Affixation with use of electrically conductive adhesive enables reducing the heat load on the gas exhaust tube 2031 farther than affixing with solder, and is therefore preferable.

In the present embodiment, the bases 2072 are separate from the sealed portions 2032 and 2033 of the glass bulb 2015, and are affixed to respective ends of the gas exhaust tubes 2031 while covering the lead-in wires 2025 and 2027.

Specifically, the bases 2072 are affixed at a distance greater than or equal to 0.5 [mm] from one end of the glass bulb 2015 on the sealed portion 2032 and 2033 sides.

Processing strain on the portions of the gas exhaust tube 2031 covered by the sealed portions 2032 and 2033 of the glass bulb 2015 occurs during formation of the sealed portions 2032 and 2033. Since the gas exhaust tube 2031 and the glass bulb 2015 are fundamentally different materials, a large number of tiny air gaps are likely to exist at the point of contact. Accordingly, when the lead-in wires 2025 and 2027 have been wound around the gas exhaust tube 2031 so as to bring the bases 2072 into contact with the sealed portions 2032 and 2033, stress occurs at the point of contact due to a temperature difference occurring between the bases 2072 and the gas exhaust tube 2031 when the lamps are lit or extinguished, and cracks readily develop on the point of contact due to the generated stress. There are cases in which the sockets 2084 cannot support the cold cathode fluorescent lamps, and discharge gas that fills the interior of the glass bulb leaks from the cracks, thereby hindering lighting the lamps.

Since the bases 2072 in the present embodiment are affixed while the end on the glass bulb 2015 side is separate from the sealed ends 2032 and 2033 of the glass bulb 2015, generation of the stress described above can be suppressed, the cracks at the point of contact can be suppressed, the cold cathode fluorescent lamps 2007 can be supported by the sockets 2084 of the outer case 106, and a discharge gas leak as described previously can be suppressed, and therefore such a structure is preferable.

The present embodiment is also preferable since the bases 2072, being sleeve-shaped, are mounted without covering the ends on the respective sides of the gas exhaust tube 2031 external to the glass bulb 2015, unlike when the bases 2072 are cap-shaped.

Since the ends of the gas exhaust tubes 2031 outside the glass bulb 2015 are tipped off and sealed after gas is supplied to, and discharged from, the space inside the glass bulb 2015 as described above, processing strain occurs on the ends. When the bases 2072 are made to cover the ends that experience processing strain, stress occurs on the ends due to a difference in temperature between the bases 2072 and the gas exhaust tube 2031 when the lamp is lit or extinguished, cracks develop easily on the ends due to the stress, and there are cases when discharge gas leaks out of the cracks in the glass bulb, leading to hindrances in lighting the lamps.

Since the sleeve-shaped bases 2072, when affixed to the gas exhaust tube 2031, do not cover the ends of the gas exhaust tube 2031 on the outer ends of the glass bulb 2015, the stress described above can be suppressed, the development of cracks at the contact point can be suppressed, and discharge gas leaks as described above can be suppressed, so the present embodiment is preferable.

### Embodiment 8 Summary

As described above, since the bases 2072 are affixed to respective protruding portions of the gas exhaust tube 2031 so as to cover the lead-in wires 2025 and 2027, the present embodiment enables supporting and electrically connecting the cold cathode fluorescent lamp 2007 to the lead-in wires 2025 and 2027 and the socket 2084 on the outer case 106 side, and suppressing the load on the lead-in wires 2025 and 2027 more than when the cold cathode fluorescent lamps are supported by lead-in wires and the cold cathode fluorescent lamps are electrically connected to the lead-in wires and an electrical contact on the outer case 106 side.

Furthermore, since employing this structure when affixing the bases 2072 enables avoiding the sealed portions 2032 and 2033 formed by pinch-sealing, the load on the end of the glass bulb 2015, on which processing strain is great, can be suppressed more than in conventional bead sealing, and the cold cathode fluorescent lamp 2007 can be supported and electrically connected to the lead-in wires and the socket 2084 on the outer case 106 side.

Accordingly, the cold cathode fluorescent lamp 2007 pertaining to the present embodiment suppresses the load on the lead-in wires 2025 and 2027 and the end of the glass bulb 2015 while being supported and electrically connected.

Also, since in the present embodiment, the bases 2072 are separated from the sealed portions 2032 and 2033 of the glass bulb 2015 and are affixed to respective portions of the gas exhaust tube 2031 in a state of covering the lead-in wires 2025 and 2027, stress on the gas exhaust tube 2031 can be suppressed, the load on the gas exhaust tube 2031 can be suppressed, and the cold cathode fluorescent lamps 2007 can be electrically connected and supported more reliably.

Moreover, since the sleeve-shaped bases 2072, when affixed to the gas exhaust tube 2031, do not cover the ends of the gas exhaust tube 2031 on the outer ends of the glass bulb 2015, stress on the gas exhaust tube 2031 can be suppressed, the load on the gas exhaust tube 2031 can be suppressed, and the cold cathode fluorescent lamps 2007 can be electrically connected and supported more reliably.

### Variations of Embodiment 8

Variations of embodiment 8 are described below.

Variation 1

As shown in FIG. 54, a cold cathode fluorescent lamp 5100 of variation 1 has a hole provided in advance in a position where lead wires 5104 are anticipated to join to an outer face of the bottom of the electrode 2019. After inserting the lead wires 5104 into the hole, the electrode 2019 and the lead wires 5104 are joined by laser welding or the like.

This structure enables improving the stability of the joint between the electrode 2019 and the lead wires 5104.

Variation 2

As shown in FIG. 53, a fluorescent lamp 2008 of variation 2 (hereinafter, may be referred to simply as “lamp 2008”) is an internal/external electrode fluorescent lamp that has an external electrode 2009 on an exterior face of one end and an internal electrode 2019 in the interior of the other end.

The lamp 2008 has the external electrode 2009 on the external face of one end, and except for this accompanying structure, has a structure substantially the same as the cold cathode fluorescent lamp depicted in FIG. 22. Accordingly, the details of the external electrode 2009 and the accompanying structure are described, and description of other parts is omitted.

The external electrode 2009 is formed from, for example, aluminum leaf, and has been adhered to the glass bulb 2015, with use of an electrically conductive adhesive formed by mixing a metallic powder with silicon resin (not depicted), so as to cover the outer circumference face of the end of the glass bulb 2015. Note that fluoride resin, polyimide resin, epoxy resin or the like may be used instead of silicon resin in the electrically conductive adhesive.

Also, the external electrode 2009 may be formed by applying silver paste on the outer circumference of an electrode shaping portion of the glass bulb 2015, instead of sticking the aluminum leaf to the glass bulb 2015 with use of the electrically conductive adhesive, and a metallic base may be fitted on the end of the glass bulb 2015.

Note that although in the example shown in FIG. 55, the gas exhaust tube 2031 has only been provided on the inner electrode 2017 side, the gas tube 2031 may also be provided on the outer electrode 2009 side, or on both sides.

Variation 3

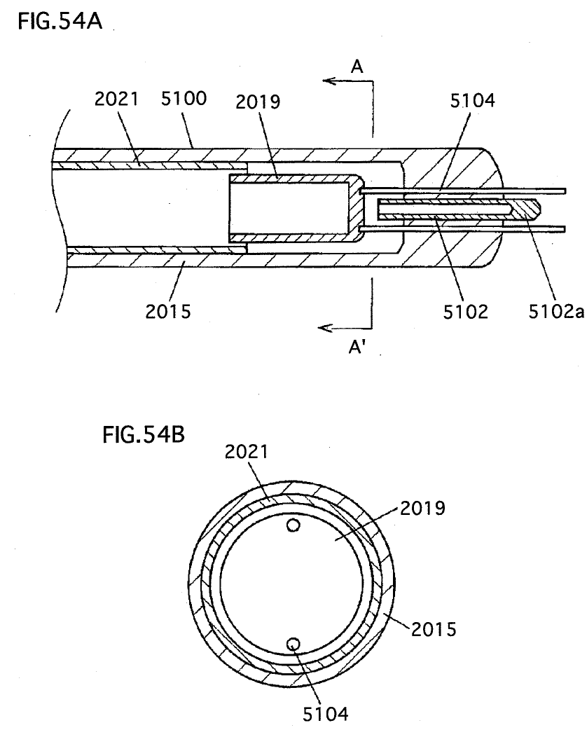

FIG. 56A is a cross-sectional enlarged front view of a relevant portion of a fluorescent lamp, and FIG. 56B shows a cross section taken along B-B′. In the fluorescent lamp 5107, an end of one lead wire 5106 extending in a tube axis direction is bent in an L-shape in a direction parallel to the outer face of the bottom of the electrode 2019, and substantially an entirety of this bent portion 5106a is in contact with the outer face of the bottom of the electrode 2019. This structure enables enlarging the contact area between the lead wire 5106 and the outer face of the bottom of the electrode 2019, and increasing the stability of the joint between the lead wire 5106 and the electrode 2019.

Variation 4

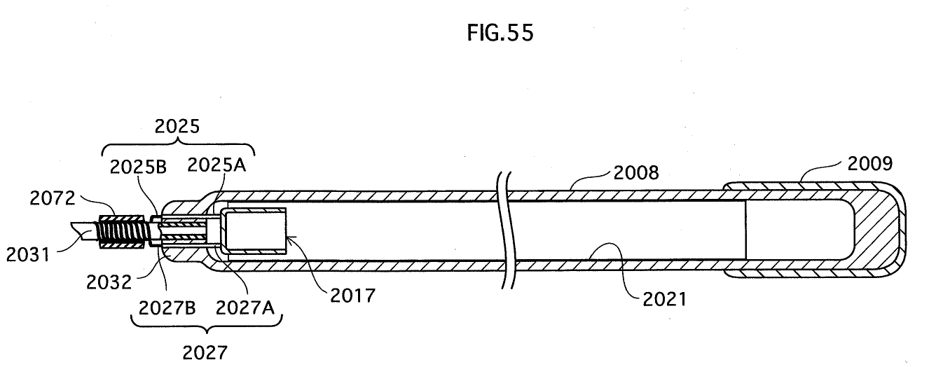

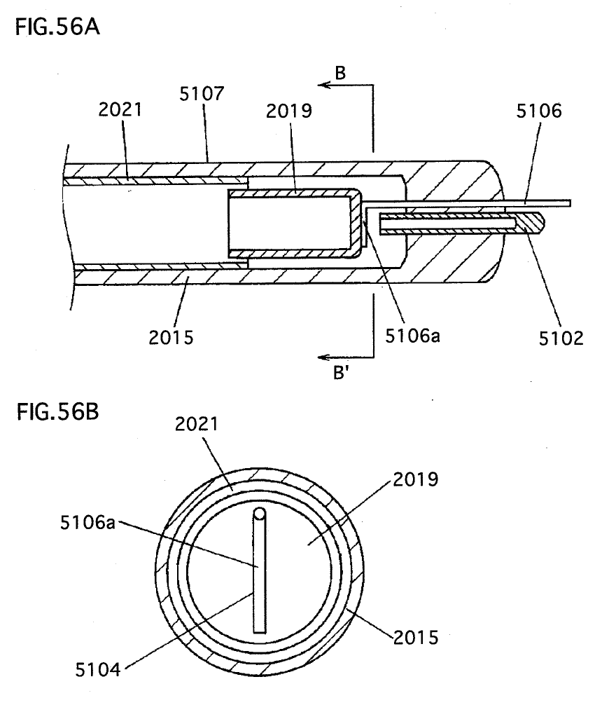

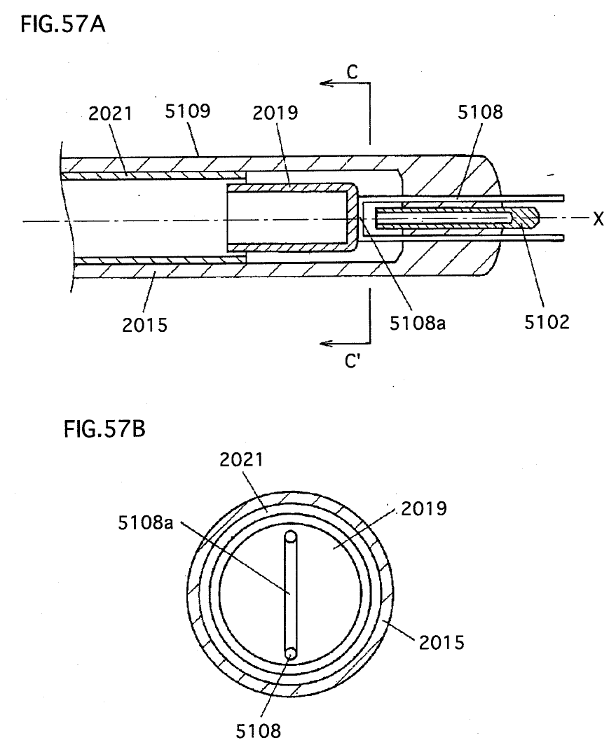

FIG. 57A is an enlarged cross-sectional front view of a relevant portion of a fluorescent lamp pertaining to variation 4, including the tube axis of variation 2, and FIG. 57B shows a cross section taken along C-C′. In such a case, one lead wire 5108 is folded into a U-shape having three straight parts, and substantially an entirety of an intermediate part 5108a, which is between the two folded parts, has been joined together with an outer face of the bottom of the electrode 2019. In other words, the lead wire 5108 has either linear or surface contact with the intermediate part 5108a of the electrode 2019. This structure increases the contact area between the lead wire 5108 and the outer face of the bottom of the electrode 2019, and enables increasing the stability of the joint between the lead wire 5108 and the electrode 2019. Also, the two straight parts of the lead wire 5108 excluding the intermediate part 5108a are sealed in the glass bulb 2015, and are supported by the glass bulb 2015. This structure enables suppressing axis slippage in the electrode 2019 that is supported by the glass bulb 2015, specifically, preventing the central axis in the lengthwise direction of the electrode 2019 from tilting away from the tube axis X of the glass bulb 2015.

Variation 5

Variation 5 differs from variation 4 in the shape of the lead wire. Specifically, variation 5 is different in that the intermediate part 5110a that is between the two folded parts of the straight U-shaped lead wire 5110, while remaining parallel to the outer face of the bottom of the electrode 2019, bends in a zigzag shape.

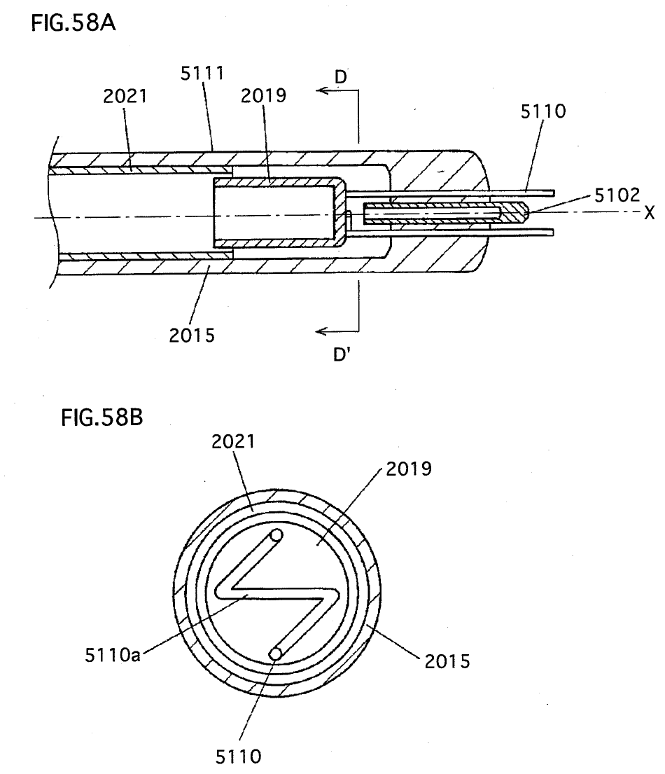

FIG. 58A is an enlarged cross-sectional front view of a relevant portion of a fluorescent lamp pertaining to variation 5, including the tube axis thereof, and FIG. 58B shows a cross section taken along D-D′. In such a case, one lead wire 5110 is first folded into a U-shape having three straight parts, and further an intermediate part 5110a that is between the two folded parts bends twice, so as to form a zigzag shape while remaining parallel to the outer face of the bottom of the electrode 2019. In other words, the intermediate part 5110a is folded substantially in a Z-shape. This structure further enables increasing the contact area between the lead wire 5110 and the outer face of the bottom of the electrode 2019, thereby further increasing the stability of the joint between the lead wire 5110 and the bottom face of the electrode 2019, and preventing the central axis in the lengthwise direction of the electrode 2019 from tilting away from the tube axis X of the glass bulb 2015. Note that although the lead wire 5110 shown in FIGS. 58A and 58B is folded twice while the intermediate part 5110a that is between the two folded parts remains parallel to the outer face of the bottom of the electrode 2019, the number of times the lead wire 5110 is folded and the shape after being folded are not limited to these. For example, the intermediate part 5110a may form a concentrically circular path around the outer face of the bottom of the electrode 2019, or may form a star or spiral shape.

Variation 6

The fluorescent lamp pertaining to variation 6 differs from the fluorescent lamp pertaining to variation 1 in the shape of the electrode and the connection condition between the electrode and the lead wire. Specifically, variation 6 is different in that the electrode 2019 has a convex part 2019a that projects from the outer face of the bottom of the electrode, and the lead wire 5110 is joined substantially linearly or surface-to-surface to the side face of the convex part 2019a.

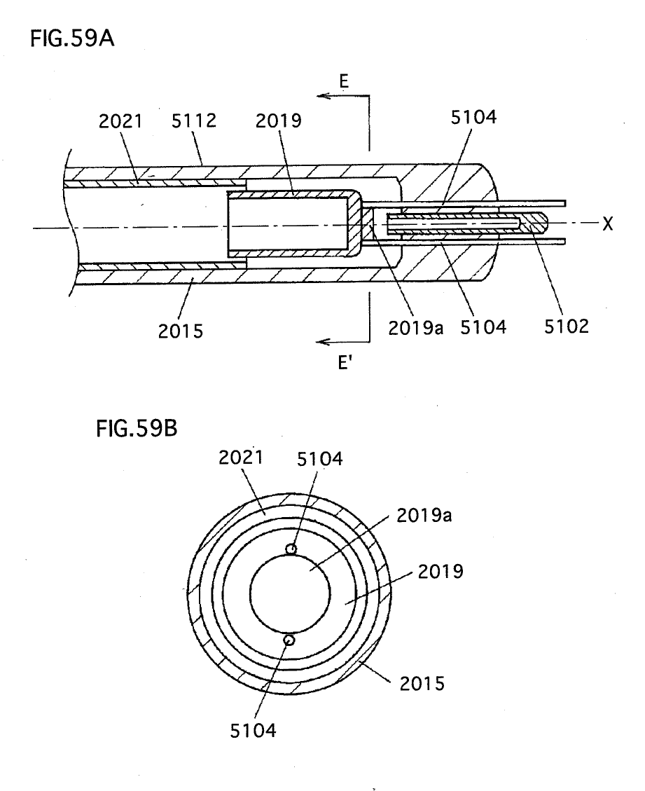

FIG. 59A is an enlarged cross-sectional front view of a relevant portion of a fluorescent lamp pertaining to variation 6, including the tube axis thereof, and FIG. 59B shows a cross section taken along E-E′. In variation 6, the electrode 2019 has a column-shaped convex part 2019a that projects from the outer face of the bottom of the electrode, and two lead wires 5104 are joined to the respective side faces of the convex part 2019a. This increases the area of the surface contact between the lead wires 5104 and the outer side of the bottom of the electrode 2019, and enables increasing the stability of the connection between the lead wires 5104 and the electrode 2019. Note that in FIG. 59, the lead wires 5104 appear to be connected to the side faces of the convex part and to the bottom face of the electrode, and the lead wires 5104 may also be connected to one end face of the glass bulb 2015 and to the bottom face of the electrode. In such a case, the stability of the connection between the lead wires 5104 and the electrode 2019 can be improved further over a case of connection only to the side faces of the convex part. Also, a groove having a width as large as the wire diameter of the lead wires 5104 may be formed in the side face of the convex part 2019a, and fitting the lead wires 5104 into the groove to form a connection enables preventing the position of the connection between the lead wires 5104 and the electrode 2019 from slipping.

Variation 7

The fluorescent lamp pertaining to variation 7 differs from variation 6 in the shape of the lead wire and the connection condition between the electrode and the lead wire. Specifically, variation 7 differs in that the lead wire is wound around the side face of the convex part of the electrode.

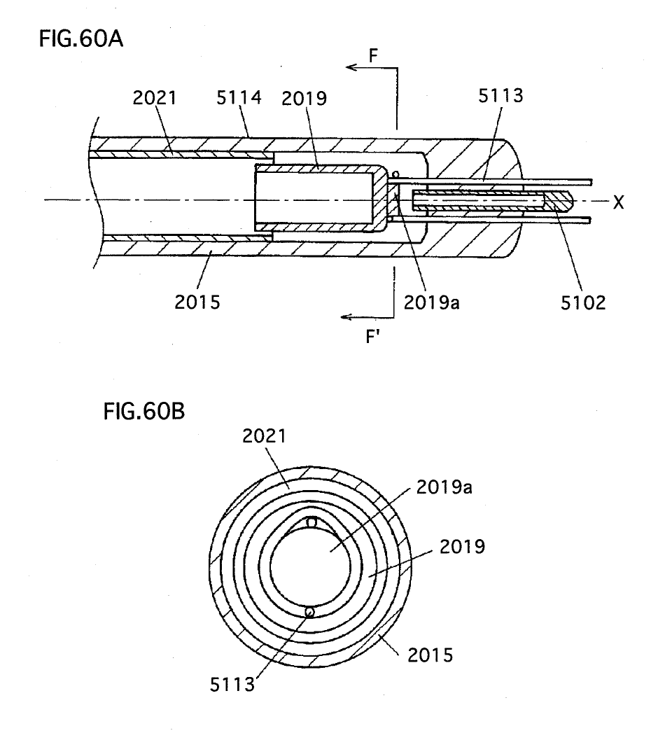

FIG. 60A is an enlarged cross-sectional view of a relevant portion of a fluorescent lamp pertaining to variation 7, including the tube axis thereof, and FIG. 60B shows a cross section taken along F-F′. In variation 7, the electrode 2019 has a column-shaped convex part 2019a that projects from the outer face of the bottom of the electrode, and lead wires 5113 have been wound around the side face of the convex part 2019a so that the electrode 2019 and the lead wires 5113 are connected substantially linearly or surface-to-surface. This further increases the stability of the connection between the lead wires 5113 and the electrode 2019, and enables preventing the central axis of the electrode 2019 in the lengthwise direction from tilting away from the tube axis X of the glass bulb 2015. Note that the number of times that the lead wires 5113 is wound around the convex portion 2019a and the direction of winding, etc. are not limited to the arrangement shown in FIGS. 60A and 60B.

Variation 8

Variation 8 of the fluorescent lamp differs from variation 4 in the shape of the electrode and the connection condition between the electrode and the lead wire. Specifically, variation 8 differs in that a convex part having a groove on an end face has been formed on the outer side of the bottom of the electrode, and the lead wire has been inserted into the groove to be connected either linearly or surface-to-surface to the electrode.

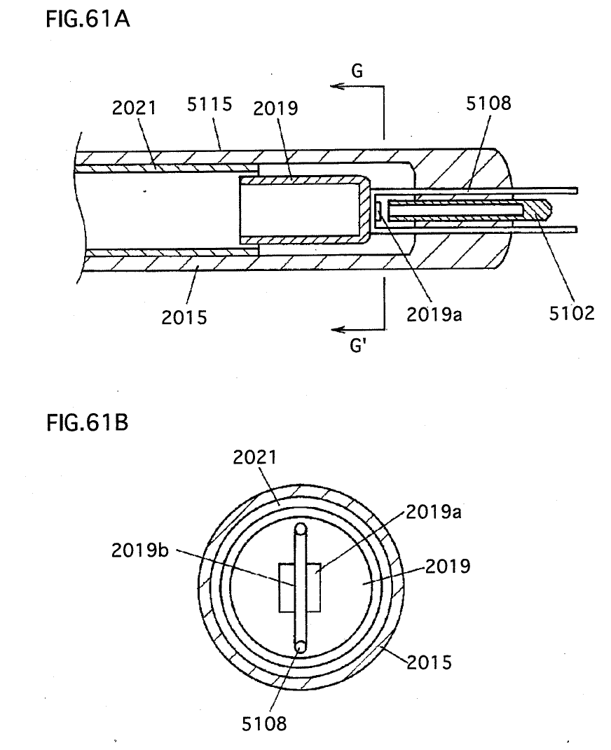

FIG. 61A is an enlarged cross-sectional front view of a relevant portion of a fluorescent lamp pertaining to variation 8, including the tube axis thereof, and FIG. 61B shows a cross section taken along G-G′. Variation 8 includes a convex part shaped as a rectangular solid that extends from the outer side of the bottom of the electrode 2019, and a groove 2019b has been formed on an end face thereof. The intermediate part 5108a, which is substantially the same as in variation 4, has been inserted into the groove 2019b, and the electrode 2019 and the lead wire 5108 are connected, by welding, for example. The width of the groove 2019b is, for example, substantially the same as the wire diameter of the lead wire, for example, 0.4 [mm].

Note that after inserting the intermediate part 5108a of the lead wire 5108 into the groove 2019b, the lead wire 5108 and the electrode 2019 can easily be connected by caulking the convex part from outside. Furthermore, welding after caulking enables further strengthening the connection between the lead wire 5108 and the electrode 2019.

Also, the convex portion 2019a may also be a columnar shape, a spindle shape, a tetrahedron, a hexahedron, etc., in addition to a rectangular solid shape. Particularly in the case of a rectangular solid shape or a cube, a jig used to perform caulking is more stable and less likely to slip when a groove is provided parallel to the side face and caulking is performed after inserting the lead wire 5108 into the groove.

Variation 9

Variation 9 of the fluorescent lamp differs from variation 8 in the position of the groove in the convex portion of the electrode. Specifically, variation 9 differs in that instead of being provided on the end face of the convex part, the groove is provided on the side face thereof.

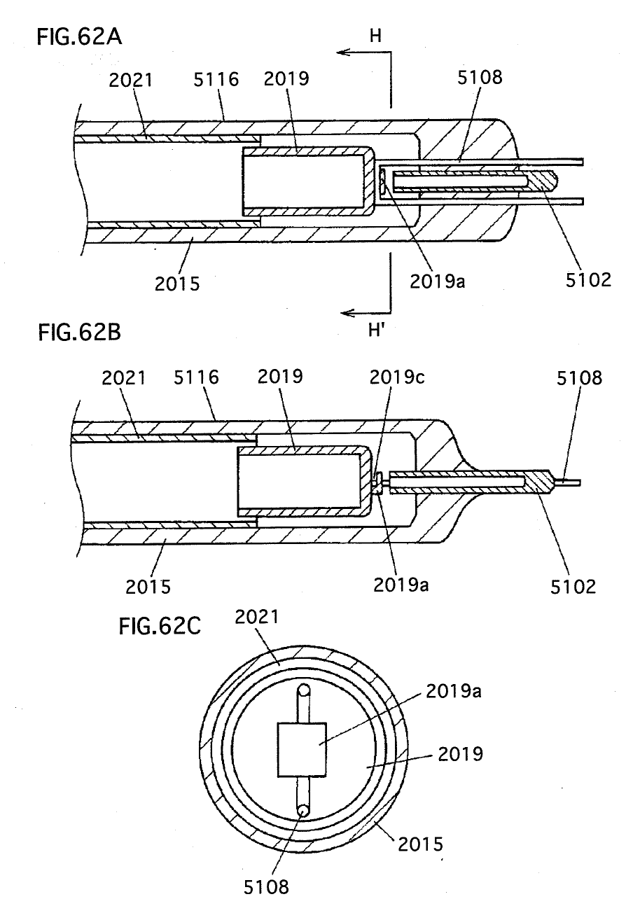

FIG. 62A is an enlarged cross-sectional front view of a relevant portion of a fluorescent lamp pertaining to variation 9, including the tube axis thereof, FIG. 62B is an enlarged cross-sectional bottom view of a relevant portion of the fluorescent lamp, and FIG. 31C shows a cross section taken along H-H′. In variation 9, instead of the groove 2019b being formed in the end face of the convex portion 2019a as in variation 8, a groove 2019c has been formed in the side face of the convex portion 2019a. The lead wire 5108 is substantially the same as in variation 4, the intermediate part 5108a has been inserted in the groove 2019c, and the electrode 2019 and the lead wire 5108 have been connected, by welding for example.

Such a case enables strengthening the connection between the electrode 2019 and the lead wire 5108 in the direction of the tube axis of the glass bulb 2015.

Variation 10

The fluorescent lamp of variation 10 pertaining to embodiment 4 of the present invention differs from variation 8 in the shape of the groove in the convex portion of the electrode. Specifically, variation 10 is different in that shapes of opposing inner faces of the groove are concavo-convex.

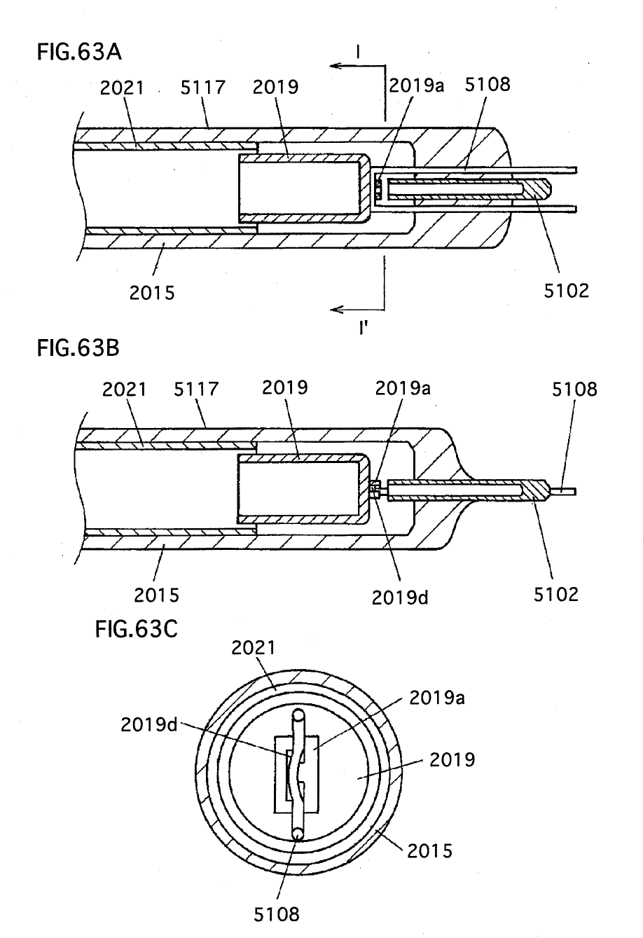

FIG. 63A is an enlarged cross-sectional front view of a relevant portion of a fluorescent lamp pertaining to variation 10, including the tube axis thereof, FIG. 63B is an enlarged cross-sectional bottom view, and FIG. 63C shows a cross section taken along I-I′.

Variation 10 has a convex part 2019a that is substantially the same as in variation 8. Furthermore, although similarly to variation 7, a groove 2019d has been formed in an end face of the convex part 2019a, the shapes of the opposing inner faces are concavo-convex.

The lead wire 5108 is substantially the same as in variation 2, the intermediate part 5108a has been inserted into the groove 2019d, and is gripped by the concavo-convex inner faces of the grooves 2019d.

This enables further strengthening the connection between the electrode 2019 and the lead wire 5108.

Variation 11

The fluorescent lamp of variation 11 differs from variation 9 in the shape of the groove in the convex portion of the electrode. Specifically, variation 11 differs in that the shapes of the opposing inner faces of the groove are concavo-convex.

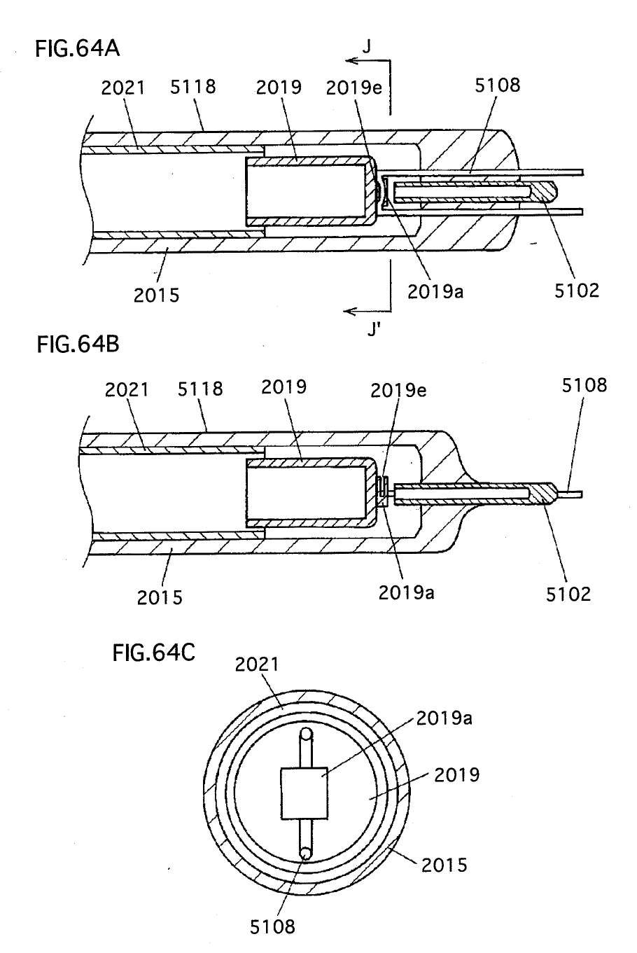

FIG. 64A is an enlarged front cross-sectional view of a relevant portion of a fluorescent lamp pertaining to variation 11, including the tube axis thereof, FIG. 64B is an enlarged cross-sectional bottom view, and FIG. 64C shows a cross section taken along J-J′.

Variation 11 has a convex portion 2019a that is substantially the same as in variation 10. Furthermore, although similarly to variation 7, the groove 2019d has been formed in a side face of the convex portion 2019a, the shapes of the opposing inner faces in the groove are concavo-convex.

The lead wire 5108 is substantially the same as in variation 2, the intermediate part 5108a has been inserted in the groove 2019d, and is gripped by the convexo-concave inner faces of the groove 2019e.

This enables further strengthening the connection between the electrode 2019 and the lead wire 5108 in an axis direction of the glass bulb 2015.

### Embodiment 9

Since the present embodiment differs from embodiment 4 in employing a hot cathode fluorescent lamp as the fluorescent lamp in place of a cold cathode fluorescent lamp, only the differences from embodiment 4 are described, and description of other structures is omitted.

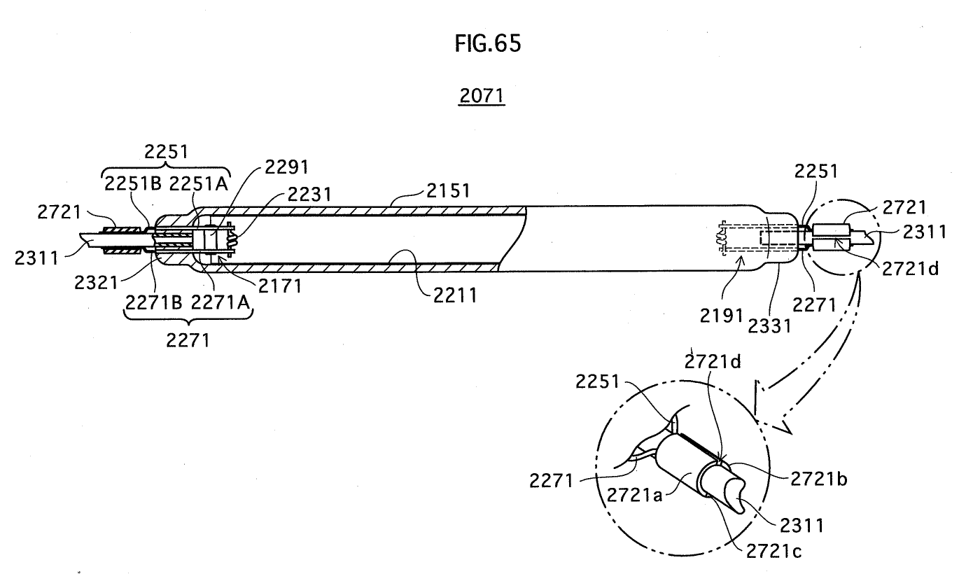

FIG. 65 is an enlarged view of the relevant portion of a hot cathode fluorescent lamp 2071 pertaining to the present embodiment. As shown in FIG. 65, the hot cathode fluorescent lamp 2071 has been formed by filling a straight tube shaped glass bulb 2151 with a discharge medium and disposing electrodes 2171 and 2191 in proximity to the ends of the glass bulb 2151.

In the present embodiment, lead-in wires 2251 and 2271 extending out of the glass bulb 2151 are substantially linearly connected to portions of a gas exhaust tube 2311 that extend out of the sealed portions 2321 and 2331 of the glass bulb 2151, respectively. Bases 2721 have been affixed so as to cover these projecting portions of the gas exhaust tube 2311 and the lead-in wires 2251 and 2271, and the lead-in wires 2251 and 2271 are in close contact with the bases 2721 and the gas exhaust tube 2311.

As shown in the enlarged view of the relevant portion in FIG. 65, the bases 2721 are constituted from conductive parts 2721a and 2721b and an insulating part 2721c, and have a slit 2721d. The insulating part 2721c and the slit 2721d electrically insulate the conductive parts 2721a and 2721b in the sleeve-shaped base 2721. For example, on one end, the lead-in wire 2251 is in close contact with the conductive part 2721b of the base 2271 and the gas exhaust tube 2311, and on the other end, the lead-in wire 2271 is in close contact with the conductive part 2721a of the base 2721 and the gas exhaust tube 2311. By employing this structure, when power is supplied from the socket 2084 on the outer case 106 side (see FIG. 52) upon lighting the lamp, power can be passed through a filament 2231 and the filament 2231 can be heated without causing a short circuit between the lead-in wires 2251 and 2271, and subsequently can prompt electrical discharge to occur between the electrodes 2171 and 2191. Note that the sleeve shape of the base 2721 is maintained even after affixing the base 2721. In other words, the base 2721, when affixed, has the slit 2721d. Since this structure is employed in the base 2721, the conductive parts 2721a and 2721b can remain electrically insulated from each other even after the base is affixed.

Solder or electrically conductive adhesive is used in the method for affixing the bases 2721. Affixing with use of an electrically conductive adhesive is preferable, since this results in a lower heat load on the gas exhaust tube 2331 than when affixed with use of solder.

When the base is affixed with use of solder or conductive adhesive, a base may be used that has been formed by joining together a material that has a property of electrically insulating the conductive parts 2721a and 2721b from each other. When such a base is used, since there is no slit, mechanical strength of the base can be improved over the base 2721 having the slit 2721d.

### Embodiment 9 Summary

Although the hot cathode fluorescent lamp 2071 is used as the fluorescent lamp in the present embodiment unlike the cold cathode fluorescent lamp used in embodiment 8, similarly to embodiment 8, the bases 2721 respectively cover the lead-in wires 2251 and 2271 while being affixed to the projecting portions of the gas exhaust tube 2311, and therefore the present embodiment enables suppressing, more than in conventional bead sealing, the loads on the lead-in wires 2251 and 2271 and on the glass bulb 2151 experiencing great processing strain while supporting the hot cathode fluorescent lamp 2071, and electrically connecting the hot cathode fluorescent lamp 2071 to the socket 2084 on the outer case 106 side.

Accordingly, similarly to embodiment 8, the hot cathode fluorescent lamp 2071 pertaining to the present embodiment suppresses the load on the lead-in wires 2251 and 2271 and the end of the glass bulb 2151 while being supported and electrically connected.

Also, similarly to embodiment 8, in the present embodiment, since the bases 2721 have been separated from the sealed portions 2321 and 2331 of the glass bulb 2151 and affixed to respective portions of the gas exhaust tube 2311 while covering the lead-in wires 2251 and 2271, the hot cathode fluorescent lamps 2071 can be electrically connected and supported more reliably.

In addition, similarly to embodiment 8, the present embodiment uses the sleeve-shaped base 2721, and since the base 2721 has been affixed to the gas exhaust tube 2311 without covering the outer end of the gas exhaust tube 2311, the hot cathode fluorescent lamps 2071 can be electrically connected and supported more reliably.

### Embodiment 10

The main characteristics of the present embodiment pertain to the arrangement position, etc. of the base that is a structural member of the cold cathode fluorescent lamp, and since other structures are substantially similar to embodiment 8, only the characteristic portions are described, and further description is omitted.

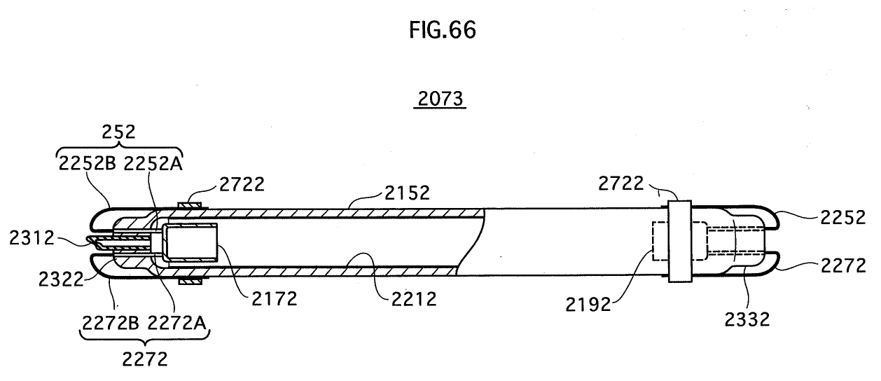

FIG. 66 is an enlarged view of a relevant portion of the cold cathode fluorescent lamp 2073 (hereinafter may be simply called “lamp 2073”) in the present embodiment. As shown in FIG. 66, there is a shorter distance from the sealed portions 2322 and 2332 of the glass bulb 2152 to the end of the gas exhaust tube 2312 on the outer side of the glass bulb 2152 in the cold cathode fluorescent lamps 2073 than in embodiment 8, and the cold cathode fluorescent lamps 2073 are tipped off and sealed similarly to embodiment 8.

In the present embodiment, lead-in wires 2252 and 2272 that project out from the glass bulb 2152 have been folded, and the bases 2722 are in contact with the glass bulb body, specifically in a position that covers the electrodes 2172 and 2192 enclosed by the glass bulb 2152 and avoids the sealed portions 2322 and 2332 of the glass bulb 2152 and the vicinity thereof. In this position, the lead-in wires 2252 and 2272 are in close contact with the glass bulb 2152 and the bases 2722.

Affixing the bases 2722 to portions of the glass bulb 2152 that cover the electrodes 2172 and 2192 and avoid the sealed portions 2322 and 2332 of the glass bulb 2152 while maintaining contact with the lead-in wires 2252 and 2272 enables the cold cathode fluorescent lamps 2073 to be supported and electrically connected to the lead-in wires 2252 and 2272 and the socket 2084 on the housing 10 side, and suppresses creating a load that would break the lead-in wires 2252 and 2272 more than when the cold cathode fluorescent lamps are supported by the lead-in wires and are electrically connected to the lead-in wires and the electrical contact on the housing side.

Furthermore, employing this structure enables suppressing, more than in conventional bead sealing, the load on the glass bulb 2152 that experiences great processing strain while supporting the cold cathode fluorescent lamps, and electrically connecting the cold cathode fluorescent lamps 2073 to the socket 2084 on the outer case 106 side.

Also, employing this structure is preferable since the length in the lengthwise direction of the gas exhaust tube 2312 can be made smaller than in embodiment 8, and the rate of the portion of the cold cathode fluorescent lamp 2073 that does not emit light can be made smaller.

Although the bases 2722 have been affixed to portions of the glass bulb 2152 that cover the electrodes 2172 and 2192 respectively, since the size of gaps from the electrodes 2172 and 2192 to the inner face of the glass bulb 2152 is extremely small, phosphor layers 2212, even if formed on inner faces of the glass bulb 2152 that are opposite from outer walls of the tube-shaped electrodes 2172 and 2192, do not emit light.

Since disposing the bases 2722 and the lead-in wires 2252 and 2272 further inward in the glass bulb 2152 than the ends of the electrodes 2172 and 2192 on the glass bulb 2152 side blocks light emission from the lamps 2073, the bases 2722 and the lead-in wires 2252 and 2272 are preferably disposed further outward in the glass bulb 2152 than the inner ends of the electrodes 2172 and 2192.

The base 2722 is sleeve-shaped, and although the inner diameter thereof, before being affixed, is smaller than the total of the wire diameter of one of the lead-in wires 2252 and 2272 and the outer diameter of the glass bulb 2152, the base 2722 is spread open, fit around one of the lead-in wires 2252 and 2272 and affixed thereto by elasticity. The method for affixing the base 2722 is not limited to this, and the base 2722 may also be affixed with use of solder or conductive adhesive.

Although in the present embodiment, the lead-in wires 2252 and 2272 are held between the bases 2722, and portions of the glass bulb 2152 cover the electrodes 2172 and 2192 such that the axis direction of the lead-in wires 2252 and 2272 is the same as the axis direction of the glass bulb 2152, the present invention is not limited to this. The lead-in wires 2252 and 2272 may be wound around portions of the glass bulb 2152 that cover the electrodes 2172 and 2192, and held between the portions of the glass bulb 2152 and the bases 2722.

Holding the lead-in wires 2252 and 2272 between the above portions of the glass bulb 2152 and the bases 2722 enables a more reliable electrical connection to the bases 2722 than a case in which the lead-in wires 2252 and 2272 are held in an extended state. In particular, using sleeve-shaped bases 2722 that have slits enables preventing the bases 2722 from failing to enclose the lead-in wires 2252 and 2272, and is preferable from the standpoint of improving yield.

Affixing the bases 2722 to the glass bulb 2152 with use of solder or conductive adhesive is preferable, since the load on the glass bulb 2152 can be reduced over a case of fastening with use of elasticity, and using conductive adhesive is preferable since the heat load on the glass bulb 2152 can be reduced over a case of using solder.

### Embodiment 10 Summary

As described above, in the present embodiment, since the bases 2722 have been affixed to portions of the glass bulb 2152 that cover the electrodes 2172 and 2192 while maintaining contact with the lead-in wires 2252 and 2272 and avoiding the sealed portions 2322 and 2332 of the glass bulb 2152, the cold cathode fluorescent lamps 2073 can be supported and electrically connected to the lead-in wires 2252 and 2272 and the socket 2084 on the outer case 106 side, and a load that would break the lead-in wires 2252 and 2272 can be suppressed more than when the cold cathode fluorescent lamps are supported by the lead-in wires and are electrically connected to the lead-in wires and the electrical contact on the housing side.

Furthermore, employing this structure enables suppressing, more than in conventional bead sealing, the load on the glass bulb 2152 that experiences great processing strain, while supporting the cold cathode fluorescent lamp 2083 and electrically connecting the cold cathode fluorescent lamp 2073 to the socket 2084 on the housing 10 side.

Accordingly, in the cold cathode fluorescent lamp 2073 pertaining to the present embodiment, the load on the lead-in wires 2252 and 2272 and the end of the glass bulb 2152 is suppressed while the cold cathode fluorescent lamp 2073 is supported and electrically connected.

Also, employing this structure is preferable since the length of the gas exhaust tube 2312 can be made smaller in a longitudinal direction than in embodiment 8, and the percentage of the portion of the cold cathode fluorescent lamp 2073 that does not emit light can be made smaller.

### Embodiment 11

Since the present embodiment differs from embodiment 10 only in employing a hot cathode fluorescent lamp as the fluorescent lamp in place of a cold cathode fluorescent lamp, only portions that differ are described below.

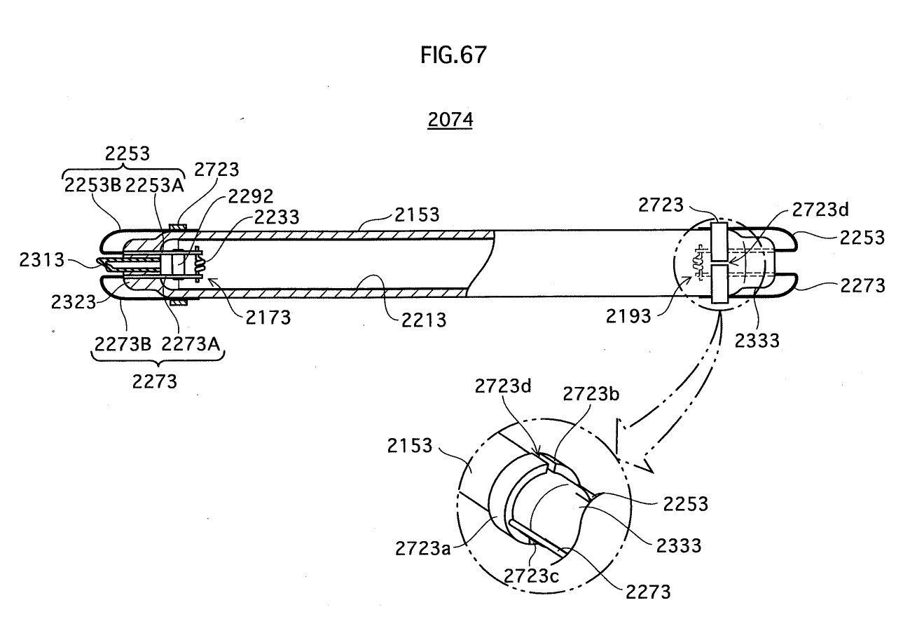

FIG. 67 is an enlarged view of a relevant portion of the hot cathode fluorescent lamp 2074 pertaining to the present embodiment. As shown in FIG. 67, in the hot cathode fluorescent lamp 2074, the straight tube shaped glass bulb 2153 is filled with a discharge medium, and electrodes 2173 and 2193 have been disposed in the vicinity of the ends of the glass bulb 2153.

In the present embodiment, lead-in wires 2253 and 2273 that project out from the glass bulb 2153 have been folded, and the bases 2723 have been affixed to the glass bulb 2153 body, specifically in a position that covers the electrodes 2172 and 2192 enclosed by the glass bulb 2153 and avoids the sealed portions 2323 and 2333 of the glass bulb 2153 and the vicinity thereof. The lead-in wires 2253 and 2273 are in close contact with the bases 2723 and the glass bulb 2153.

The electrodes 2173 and 2193 include glass stems 2292 that respectively support the lead-in wires 2253 and 2273 in the inner space of the glass bulb 2153, and a filament 2233 that joins the inner ends of the lead-in wires 2253 and 2273 to each other. The bases 2723 have preferably been affixed to the body of the glass bulb 2153 so as to cover the stems 2292 that constitute the electrodes 2173 and 2193.

This is because, since there is a wider gap between the filament 2233 and the inner face of the glass bulb 2153 than in embodiment 10, the phosphor layer 2213, if formed on an inner face of the glass bulb 2153 opposing the electrodes 2173 and 2193, would contribute to light emission.

Electrons contributing to light emission are generated between the filaments 2233 of electrodes 2173 and 2193, and since there is a wider gap between the filaments 2233 and the inner face of the glass bulb 2153 than in embodiment 10, electrons contributing to light emission are highly likely to enter the gap. Accordingly, the bases 2723 and the outward ends of the lead-in wires 2253 and 2273 are preferably disposed as far toward the ends of the glass bulb 2153 (the sealed ends 2323 and 2333) as possible while still being able to be reliably affixed to the glass bulb 2153.

Although in the present embodiment, the bases 2723 are preferably disposed as described above, if the bases 2723 can be reliably affixed to a non-phosphor layer 2213 area that exists on the glass bulb 2153, affixing the bases 2723 to that area is most preferred.

As shown in the partial enlarged view of FIG. 67, the bases 2723 are constituted from conductive parts 2723a and 2723b and an insulating part 2723c, and also have a slit 2723d. The insulating part 2723c and the slit 2723d electrically insulate the conductive parts 2723a and 2723b in the sleeve-shaped bases 2723. For example, on one end, the lead-in wire 2253 is in close contact with the conductive part 2723b of the base 2723 and the glass bulb 2153, and on the other end, the lead-in wire 2273 is in close contact with the conductive part 2723b of the base 2723 and the glass bulb 2153. By employing this structure, when power is supplied from the socket 2084 on the outer case 106 side upon lighting the lamp, power can be passed through a filament 2233 and the filament 2233 can be heated without causing a short circuit between the lead-in wires 2253 and 2273, and subsequently can prompt electrical discharge to occur between the electrodes 2172 and 2192. Note that the sleeve shape of the base 2723 is maintained even after affixing the base 2723. In other words, the base 2723, when affixed, has the slit 2723d. Since this structure is employed in the base 2723, the conductive parts 2723a and 2723b can remain electrically insulated from each other even after the base is affixed.

Solder or electrically conductive adhesive is used in the method for affixing the bases 2723. Affixing with an electrically conductive adhesive is preferable, since this results in a lower heat load on the glass bulb 2153 than when affixed with use of solder.

### Embodiment 11 Summary

Although the hot cathode fluorescent lamp 2074 is used as the fluorescent lamp in the present embodiment unlike the cold cathode fluorescent lamp 2073 used in embodiment 10, similarly to embodiment 10, the bases 2723 have been affixed to the glass bulb 2153 body, specifically locations that respectively cover the electrodes 2173 and 2193 enclosed by the glass bulb 2153 while avoiding the sealed portions 2323 and 2333 of the glass bulb 2153 and the vicinity thereof, and therefore the present embodiment enables suppressing, more than in conventional bead sealing, the loads on the lead-in wires 2253 and 2273 and on the glass bulb 2153 that experience great processing strain while supporting the hot cathode fluorescent lamp 2084, and electrically connecting the hot cathode fluorescent lamp 2074 to the socket 2084 on the outer case 106 side.

Accordingly, similarly to embodiment 10, the hot cathode fluorescent lamp 2074 pertaining to the present embodiment is supportable and electrically connectible, and suppresses the load on the lead-in wires 2253 and 2273 and the end of the glass bulb 2153.

### Embodiment 12

Characteristic features of the present embodiment are that the bases have been omitted from the constituent elements of the cold cathode fluorescent lamps, and to supply power to the electrodes enclosed in the glass bulb, the lead-in wires that project out from the glass bulb have been directly brought into contact with the socket that is the electrical contact on the backlight unit side. Since other aspects of the structure are substantially similar to embodiment 8, only the characteristic portion is described, and description of other parts is omitted.

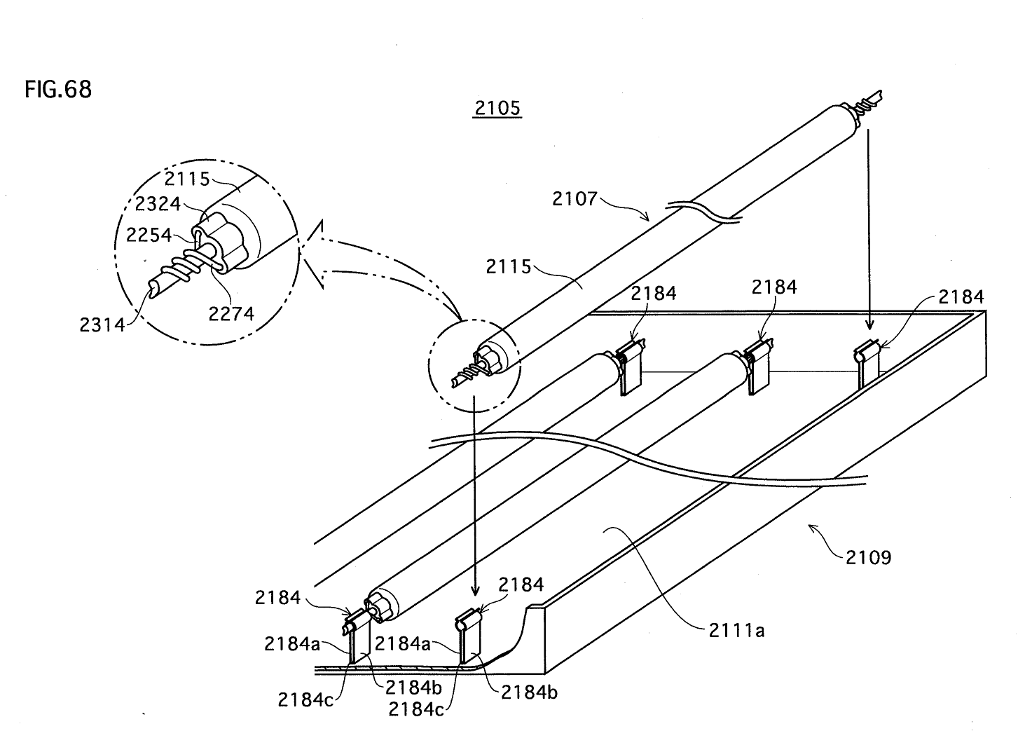

FIG. 68 is a perspective view of a relevant portion of a backlight unit 2105, and one portion of an optical sheet or the like has been omitted to show the interior thereof. As shown in FIG. 68, on a bottom wall 2111a of a housing 2109 that is part of the backlight unit 2105, a socket 2184 has been provided in a position corresponding to a peripheral area of the optical sheet or the like.

Also, lead-in wires 2254 and 2274 that extend from the sealed portions 2324 and 2334 of the glass bulb 2155 end that is part of the cold cathode fluorescent lamp 2107 are wound around the similarly extending gas exhaust tube 2314, and the extending portions of the gas exhaust tube 2314 having the lead-in wires 2254 and 2274 wound thereon are fitted into the sockets 2184, so that the cold cathode fluorescent lamp 2107 is held by, and electrically connected to, the housing 2109.

One of each set of the sockets 2184 has been set to be unipolar, and the two lead-in wires 2254 and 2274 that extend from both ends of the glass bulb 2115 can be set to be unipolar.

Each of the sockets 2184 in the backlight unit 2105, due to having respective extending portions of the gas exhaust tube 2314 fit therein while maintaining contact with the lead-in wires 2254 and 2274, support the cold cathode fluorescent lamps 2107 and electrically connect to the lead wires 2254 and 2274, and a load that would break the lead-in wires 2254 and 2274 can be suppressed more than when the cold cathode fluorescent lamps are supported by the lead-in wires and are electrically connected to the lead-in wires and the electrical contact on the housing side.

Furthermore, this structure enables the cold cathode fluorescent lamps 2107 to be supported by the sockets 2184 and electrically connected thereto, and a load on the end of the glass bulb 2115 that experiences processing strain can be suppressed more than in conventional bead sealing.

Although in the present embodiment, the extending portions of the gas exhaust tube 2314 having the lead-in wires 2254 and 2274 wound thereon have been fitted into the sockets 2184 of the housing 2109, the present invention is not limited to this, and the lead-in wires 2254 and 2274 may be joined to the sockets 2184 while the lead-in wires 2254 and 2274 extend from the sealed portions 2324 and 2334 of the glass bulb 2115. In such a case, inserting the lead-in wires 2254 and 2274 into the sockets 2184 after being temporarily fastened to a double-sided insulating tape having a width that is smaller than the length in the lengthwise direction of the sockets 2184 that has been wound around the gas exhaust tube 2314 is preferable since the lead-in wires 2254 and 2274 can be reliably inserted into the sockets 2184.

Winding the lead-in wires 2254 and 2274 around the extending portions of the gas exhaust tube 2314 enables reliable electrical connection to the sockets 2184, particularly since the sockets 2184 are sleeve-shaped and the lead-in wires 2254 and 2274 can be prevented from spilling out. Therefore, winding the lead-in wires 2254 and 2274 is preferable, from a standpoint of increasing yield, over inserting unwound, extended lead-in wires 2254 and 2274 and the gas exhaust tube 2314 into the sockets 2184 at the same time.

Although in the present embodiment, pressure is applied to the sockets 2184, and the pressure is used to fasten together the sockets 2184 and the extended portions of the gas exhaust tube 2314 on which the lead-in wires 2254 and 2274 have been wound, fastening with use of solder or conductive adhesive is preferable since the load on the gas exhaust tube 2314 can be reduced over a case of fastening with the pressure, and using conductive adhesive is preferable over using solder since the heat load on the gas exhaust tube 2314 can be reduced.

In the present embodiment, the sockets 2184 are separated from the sealed portions 2324 and 2334 of the glass bulb 2115. The gas exhaust tube 2314 has been fitted into the inner face of the sockets 2184, which is in contact with the lead-in wires 2254 and 2274.

Specifically, ends of the sockets 2184 on the sides closest to the sealed portions 2324 and 2334 are 0.5 [mm] or more away from the sealed portions 2324 and 2334 of the glass bulb 2115, and the gas exhaust tube 2314 has been fitted into the sockets 2184.

There is processing strain on portions of the gas exhaust tube 2314 that are covered by the sealed portions 2324 and 2334 of the glass bulb 2115 when the sealed portions 2324 and 2334 are being formed. Since the gas exhaust tube 2314 and the glass bulb 2115 are fundamentally different materials, a large number of tiny air gaps are likely to exist at the point of contact. Accordingly, when the gas exhaust tube 2314 is fitted into the sockets 2184 so that the sockets 2184 are in contact with the sealed portions 2324 and 2334, there is stress on the connected portions due to differences in temperature in the sockets 2184 and the gas exhaust tube 2314 depending on whether the lamp is lit or unlit. The stress may cause cracks to develop easily, and discharge gas filling an inner part of the glass bulb may leak from the cracks, hindering lighting the lamp.

The present embodiment is preferable since the sockets 2184 are separated from the sealed portions 2324 and 2334 of the glass bulb 2115, thereby enabling suppressing stress, development of cracks, and the discharge gas leak described above.

The present embodiment, since the sockets 2184 have a sleeve shape, is preferable over having a cap-shaped socket, since the socket is affixed without covering the ends of the gas exhaust tube that are outside of the outer ends of the glass bulb 2314.

Since the outer ends of the gas exhaust tubes 2314 are tipped off and sealed after gas is supplied to, and discharged from, the space inside the glass bulb 2015 as described above, processing strain occurs on the ends. When the cap-shaped sockets 2184 are made to cover the ends that experience processing strain, stress occurs on the ends due to a difference in temperature between the sockets 2184 and the gas exhaust tube 2314 when the lamp is lit or extinguished, cracks develop easily on the ends due to the stress, and there are cases when discharge gas leaks out of the cracks in the glass bulb, leading to hindrances in lighting the lamps.

The present embodiment is preferable since the sleeve-shaped sockets 2184 are used, and the gas exhaust tube 2314 has been fitted therein without the sockets 2184 covering the end of the gas exhaust tube 2314 on the outside of the glass bulb 2115, thereby enabling suppressing the occurrence of stress, the development of cracks at the point of contact, and the discharge gas leak described above.

### Embodiment 12 Summary

As described above, in the present embodiment, the sockets 2184 are in contact with the lead-in wires 2254 and 2274, the extending portions of the gas exhaust tube 2314 have been fitted in the sockets 2184, and the cold cathode fluorescent lamps 2107 are supported by, and electrically connected to, the sockets 2184 of the housing 2109 while a load on the lead-in wires 2254 and 2274 is suppressed more than when the cold cathode fluorescent lamps 2107 are supported by the lead-in wires and electrically connected to the lead-in wires and an electrical contact on the housing side.

Furthermore, employing this structure enables the cold cathode fluorescent lamps 2107 to be supported and electrically connected to the sockets 2184 of the housing 2109, and the load on the end of the glass bulb 2115 that experiences processing strain can be suppressed more than in conventional bead sealing.

Accordingly, the backlight unit 2105 pertaining to the present embodiment can suppress the load on the lead wires 2254 and 2274 and the ends of the glass bulb 2115, and electrically connect and support the cold cathode fluorescent lamps 2107.

Also, in the present embodiment, since the sockets 2184 of the housing 2109 have been separated from the sealed portions 2324 and 2334 of the glass bulb 2115, have the gas exhaust tubes 2314 fit therein, and have contact with the lead-in wires 2254 and 2274, stress on the gas exhaust tubes 2314 can be suppressed, the load can be suppressed on the gas exhaust tube 2314, and the cold cathode fluorescent lamps 2107 can be more reliably electrically connected and supported.

Additionally, since the present embodiment uses a sleeve-type socket 2184, which is affixed to the gas exhaust tube 2031 so as not to cover the ends of the gas exhaust tube 2031 on the outer ends of the glass bulb 2015, stress on the gas exhaust tube 2314 can be suppressed, the load on the gas exhaust tube 2314 can be suppressed, and the cold cathode fluorescent lamps 2107 can be electrically connected and supported more reliably.

### Embodiment 13

Since the present embodiment differs from embodiment 12 only in employing a hot cathode fluorescent lamp as the fluorescent lamp in place of a cold cathode fluorescent lamp, only portions that differ are described below.

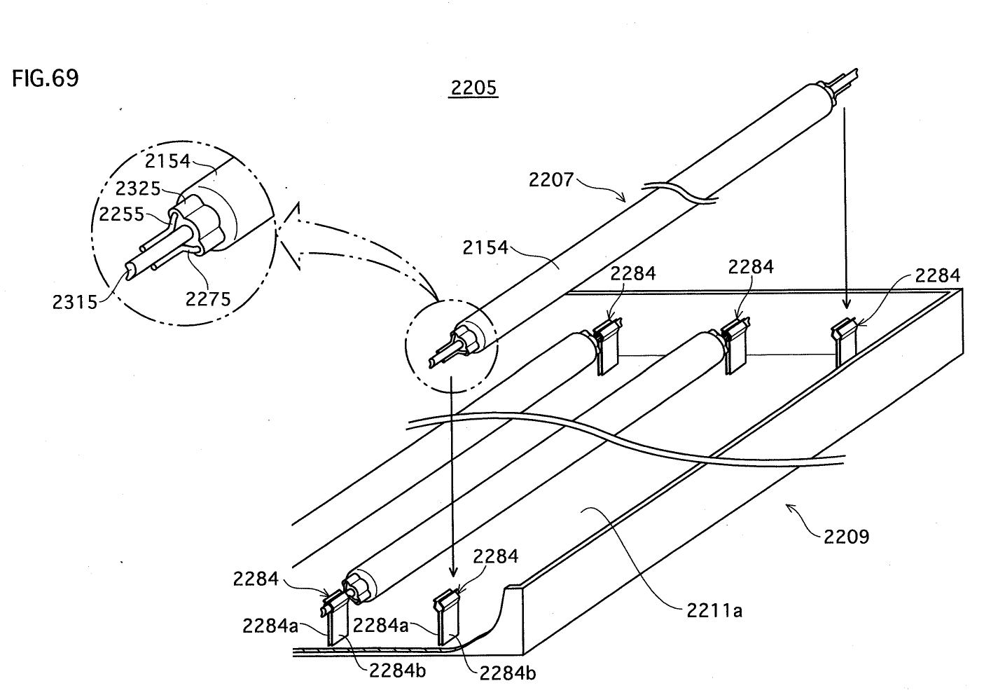

FIG. 69 is a perspective view of a relevant portion of a backlight unit 2205 of the present embodiment, and an optical sheet or the like has been cut away to show the interior.

In the present embodiment, a hot cathode fluorescent lamp 2207 is used, and lead-in wires 2255 and 2275 extending from sealed portions 2325 and 2335 of the ends of a glass bulb 2154 that constitutes the hot cathode fluorescent lamp conform to similarly extending gas exhaust tubes 2315. Extending portions of the gas exhaust tube 2315 parallel to the lead-in wires 2255 and 2275 have been fit into sockets 2284, and the hot cathode fluorescent lamp 2207 is electrically connected to, and supported by, a housing 2209.

In such a case, a double-sided insulating tape having a width that is smaller than the length of the sockets 2284 is wound around the gas exhaust tube 2315, the lead-in wires 2255 and 2275 are temporarily fastened to the tape, and the lead-in wires 2255 and 2275 are inserted into the sockets 2284. This prevents the lead-in wires 2255 and 2275 from spilling out, enables the lead-in wires 2255 and 2275 to be reliably inserted into the sockets 2284, and is preferable from the standpoint of increasing yield.

In the present embodiment, each of the sockets 2284 has a two-piece structure, and a current pathway can be formed between the two lead-in wires 2255 and 2275 extending from respective ends of the glass bulb 2154 and filaments (not depicted) of electrodes enclosed in the glass bulb 2154. The structure of the sockets 2284 is not limited to this, and may physically be a single piece that is electrically insulated so that the current pathway can be formed.

Also, in the present embodiment, a cross section of portions of the pieces of the sockets 2284 that support the lead-in wires 2255 and 2275 and the gas exhaust tube 2315, taken perpendicular to the axis of the gas exhaust tube 2315, has a curved shape. Specifically, in the supporting portions of the pieces of the sockets 2284, inner walls facing the lead wires 2255 and 2275 and the gas exhaust tube 2315 fold inward, and the lead-in wires 2255 and 2275 conforming to the surface of the gas exhaust tube 2315 have been fitted into the inwardly folding inner walls. By having this structure, the present embodiment enables suppressing short circuits in the lead-in wires 2255 and 2275 between the pieces that form the sockets 2284 more than when the cross section of portions of the supporting pieces of the sockets 2284 taken perpendicular to the axis of the gas exhaust tube 2315 has a circular arc shape.

Since the sockets 2284 maintain contact with the lead-in wires 2255 and 2275 and respective extending portions of the gas exhaust tube 2315 have been fitted into each of the sockets 2284, this structure enables suppressing a load that would cause the lead wires 2255 and 2275 to break, and supporting the hot cathode fluorescent lamps 2207 with the socket 2284 and electrically connecting the lamps 2207 to the lead-in wires 2255 and 2275 and the socket 2284, more than a case in which hot cathode fluorescent lamps are supported by the lead-in wires, and the lamps are electrically connected to the lead-in wires and an electrical contact on the housing side.

Furthermore, employing this structure enables the hot cathode fluorescent lamps 2207 to be supported by, and electrically connected to, the sockets 2284 and suppressing a load on ends of the glass bulb 2154 that experience processing strain more than a case of conventional bead sealing.

Although in the present embodiment, pressure is applied to the socket 2284, and the pressure is used to fasten together the socket 2284 and the extended portions of the gas exhaust tube 2314 on which the lead-in wires 2255 and 2275 have been wound, fastening with use of solder or conductive adhesive is preferable since the load on the gas exhaust tube 2314 can be reduced over a case of fastening with the pressure, and using conductive adhesive is preferable over using solder since the heat load on the gas exhaust tube 2314 can be reduced.

### Embodiment 13 Summary

As described above, since the sockets 2284 maintain contact with the lead-in wires 2255 and 2275 and respective extending portions of the gas exhaust tube 2315 have been fitted into the sockets 2284, the present embodiment enables supporting the hot cathode fluorescent lamps 2207, electrically connecting the hot cathode fluorescent lamps 2207 to the lead-in wires 2255 and 2275 and the socket 2284, and suppressing the load on the lead wires 2255 and 2275 more than a case in which hot cathode fluorescent lamps are supported by the lead-in wires, and the lamps are electrically connected to the lead-in wires and an electrical contact on the outer case side.

Furthermore, employing this structure enables suppressing, more than in conventional bead sealing, the load on the glass bulb 2154 that experiences great processing strain, and electrically connecting the hot cathode fluorescent lamp 2207 to the lead-in wires and the socket 2284 of the housing 2209 while supporting the hot cathode fluorescent lamp 2207.

Accordingly, the backlight unit 2205 pertaining to the present embodiment can suppress the load on the lead wires 2255 and 2275 and the ends of the glass bulb 2154, and electrically connect and support the hot cathode fluorescent lamps 2207.

Also, similarly to embodiment 9, in the present embodiment, since the sockets 2284 of the housing 2209 have been separated from the sealed portions 2325 and 2335 of the glass bulb 2154 and respective portions of the gas exhaust tube 2315, which maintains contact with the lead-in wires 2255 and 2275, have been fitted in the sockets 2284, the hot cathode fluorescent lamps 2071 can be electrically connected and supported more reliably.

Moreover, since the present embodiment, similarly to embodiment 9, uses sleeve-shaped sockets 2284 that do not cover the ends of the gas exhaust tube 2315 on the outer ends of the glass bulb 2154 when affixed to the gas exhaust tube 2315, stress on the gas exhaust tube 2315 can be suppressed, the load on the gas exhaust tube 2315 can be suppressed, and the hot cathode fluorescent lamps 2207 can be electrically connected and supported more reliably.

### Supplementary Remarks on Embodiments 8 to 13

Alternating the Lamps

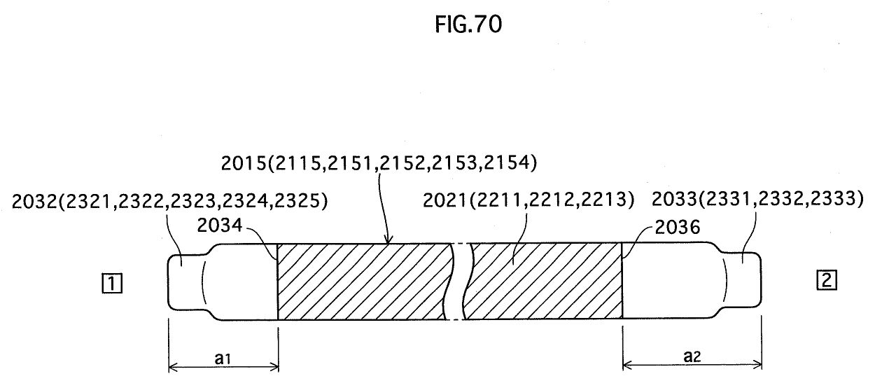

FIG. 70 is a pattern diagram showing areas where phosphor layers have formed on the glass bulb.

Since the areas of phosphor layer formation are described with reference to FIG. 70, description is omitted of other constituent elements indicated in the above embodiments, such as the bases 2072, 2721 and 2722, the gas exhaust tubes 2031, 2311, 2312, 2313, 2314, and 2315, and lead-in wires 2025 and 2027.

As shown in FIG. 70, similarly to embodiment 1, a2 is longer than a1 (a2>a1) when a1 is the distance from a boundary 2034 (a boundary between a phosphor layer 2021 (2211, 2212, 2213) area and a non-phosphor layer area) to an end on a first sealed portion 2032 (2321, 2322, 2323, 2324, 2325) side (length of the non-phosphor layer area), and a2 is the length from a boundary 2036 to an end on a second sealed portion 2033 (2331, 2332, 2333) side.

The measurements are, for example, as follows.

a1=8.0 [mm], a2=10.0 [mm].

As described in embodiment 1, the differing distances a1 and a2 can be used for detecting the orientation of a lamp.

### Manufacturing Method for Cold Cathode Fluorescent Lamps

Next, regarding a manufacturing method for the cold cathode fluorescent lamps 2007 (2071, 2073, 2074, 2107, 2207) having the structure described above, the method is described focusing particularly on details of the formation of the phosphor layer and both sealed portions. Although the example of a cold cathode fluorescent lamp is used in the following description, needless to say, the manufacturing method is also applicable when a hot cathode fluorescent lamp is used.

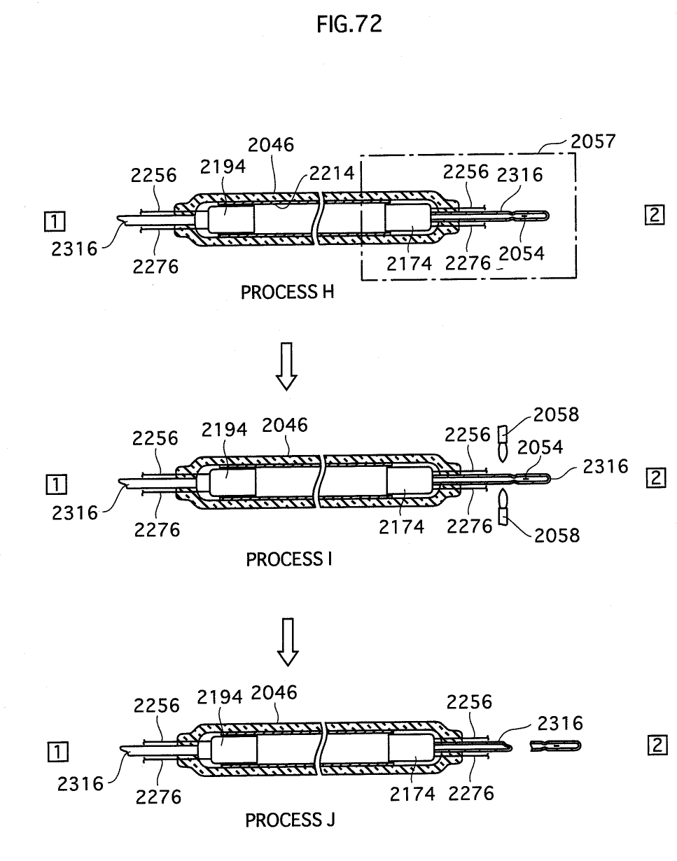

FIGS. 71 and 72 are outline process drawings showing a manufacturing process for cold cathode fluorescent lamps 2020. The manufacturing process shown in FIGS. 71 and 72 is similar in most aspects to the process shown in FIGS. 3 and 4. Following is a simple description of the aspects in common, and a detailed description of differing aspects such as how a gas exhaust tube 2316 is inserted and pinch sealed.

First, a prepared straight tube shaped glass tube 2046 is immersed into a tank containing a phosphor suspension liquid. Creating a negative pressure in the glass tube 2046 allows the glass tube 2046 to suction a portion of the phosphor suspension liquid from the tank, causing the phosphor suspension liquid to be applied to the inner face of the glass tube 2046 (process A).

Next, after drying the phosphor suspension liquid applied to the inner face of the glass tube 2046, a brush 2047 is inserted into the glass tube 2046, and any unnecessary phosphor in a phosphor layer 2214 is removed from the end of the glass tube 2046 (process B).

After inserting an electrode 2174 and the gas exhaust tube 2316 in the glass tube 2046 on which the phosphor layer 2214 has been formed, while preserving airflow in the tube axis direction of the gas exhaust tube 2316, one end (on the second sealed portion side) of the glass tube 2046 is heated by a burner 2048 and pinch sealed (process C).

Also, the margin of error from a setting value of the position of the seal is 0.5 [mm].

Next, after inserting the electrode 2194 and the gas exhaust tube 2316 into the glass tube 2046 from the opposite open side, the other end is pinch sealed. Thereafter, the end of the gas exhaust tube 2316 in which airflow is preserved in a tube axis direction is tipped off to be airtight (process D).

Also, the margin of error is 0.5 [mm] from a setting value of the seal position, the same as on the opposite side.

The insertion position of the electrode 2174 in process C and the insertion position of the electrode 2194 in process D are adjusted so that the lengths from both ends of the sealed glass tube 2046 to the respectively extending non-phosphor layer 2214 areas are different from each other. The electrode 2194 on the first sealed portion side is inserted more deeply respective to a position overlapping the phosphor layer 2214 than the electrode 2174 on the second sealed portion side. After heating, with use of a burner 2052, an end (second sealed portion) of the gas exhaust tube 2316 in which airflow has been preserved and forming a constricted portion, a mercury pellet 2054 is inserted into the gas exhaust tube 2316 (process E). The mercury pellet 2054 is formed by impregnating mercury into a titanium-tantalum-iron sinter.

Thereafter, gas is discharged from the glass tube 2046 and the glass tube 2046 is filled with the noble gas (process F). Specifically, the head of an gas exhaust apparatus, not depicted, is attached to the glass tube 2046 on the mercury pellet 2054 side. After discharging the gas in the glass tube 2046 to create a vacuum, the entire outer surface of the glass tube 2046 is heated by a heating apparatus that is not depicted. The heating temperature is approximately 380[° C.] on the outer circumference surface of the glass tube 2046. Accordingly, impure gas included in the glass tube 2046 is discharged, including impure gas that has infiltrated the phosphor layer 2214. After heating is stopped, the glass tube 2046 is filled with a predetermined amount of noble gas.

After the glass tube 2046 has been filled with the noble gas, the mercury pellet 2054 side end of the gas exhaust tube 2316 is heated on the second sealed portion side by a burner 2056 and sealed (process G).

Subsequently, in process H shown in FIG. 72, the mercury pellet 2054 is induction-heated by a high-frequency oscillation coil (not depicted) disposed in the surrounding area of the glass tube 2046, and the mercury is flushed out of the sinter (mercury discharge process). Thereafter, the glass tube 2046 is heated in a furnace 2057, and the flushed-out mercury is transferred to the electrode 2194 on the first sealed portion side.

Next, in such a way that a necessary length remains on the side of the electrodes 2174 and 2194 more than on the constricted portion formed in process E, the gas exhaust tube 2316 is heated by a burner 2058, tipped off, and sealed so as to be airtight (processes I and J). The margin of error from the setting value of the sealed position of the second seal of is 0.5 [mm].

After performing the processes described above, the fluorescent lamps are completed.

Identifying Marks

Variation 12

In the glass bulbs of embodiments 8 to 13, one portion of the phosphor layer on the inner circumference (inner face) of the glass bulb may be retained separately, and the retained portion may be used as the identifying mark of lengthwise direction orientation. The following describes variation 12 pertaining to embodiments 8 to 13.

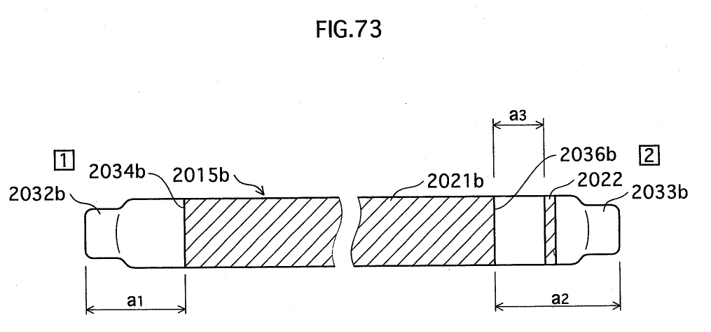

As shown in FIG. 73, a phosphor layer 2022 that is separate from the phosphor layer 2021b has been formed on the second sealed portion 2033b side of the glass bulb 2015b. Due to being in a position outside the discharge area between the electrodes 2017 and 2019, the phosphor layer 2022 is a phosphor layer that does not substantially contribute to light emission.

In the present variation, for example, distance a3 from the boundary 2036b to the phosphor layer 2022 can be used for detection. Also, since the identifying mark is the phosphor layer, luminance caused by ultraviolet irradiation can be used for detection, and a sensor having a simple structure can be used.

Variation 13

Even when identifying marks are not separately applied to the glass bulb 2015b, orientation detection in the lengthwise direction can be realized by modifying the structural members originally provided in the lamps. The following describes such a case as variation 13 of embodiments 8 to 13.

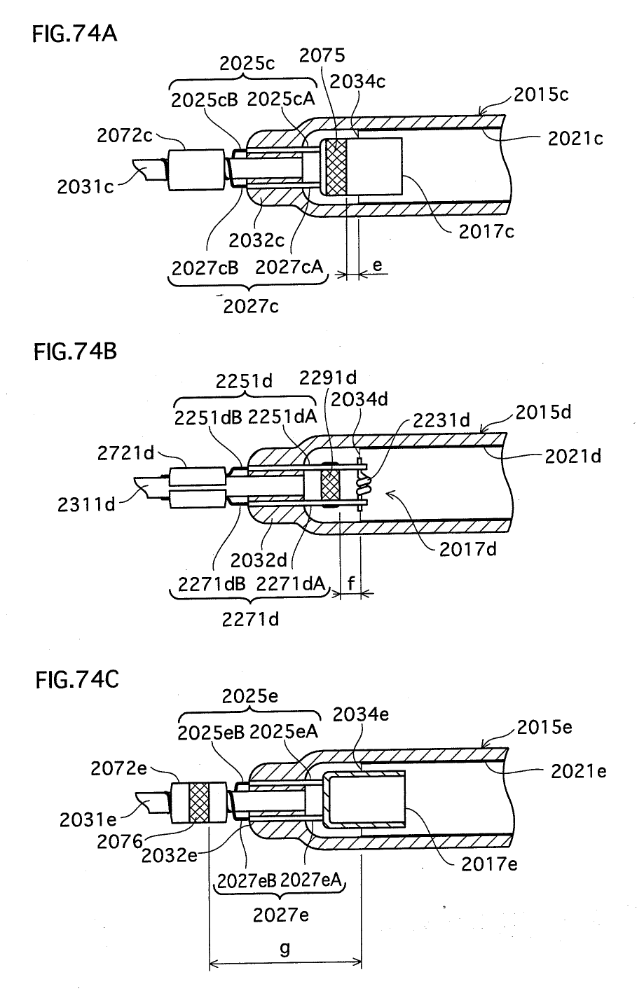

FIGS. 74A, 74B, and 74C are pattern diagrams showing a schematic structure of the glass bulb pertaining to variation 13. FIGS. 74A and 74B show the glass bulbs 2015c and 2015d and the phosphor layers 2021c and 2021d in cross section, and the lead-in wires 2025c, 2027c, 2251d, 2271d and the electrodes 2017c and 2017d from the outside. Also, in FIG. 74C, a cross section is shown in order to illustrate the shape of the electrode 2017e. Note that in FIGS. 74A, 74B, and 74C, description of structural elements similar to FIG. 65 is omitted.

In the example of FIG. 74A, a mark 2075, used for detecting orientation, has been applied to the lower center of the revolution direction of a cylinder-shaped electrode 2017c (hatching in the drawing indicates coloration).

In such a case, distance e from the boundary 2034c to the ring-shaped mark 2075 can be used for detection. Since more fade-resistant and vividly colored marks can be made on the electrode 2017 than on the outer circumference of the glass bulb, marking the electrode 2017 enables improving sensor precision.

FIG. 74B shows an exemplary application for a hot cathode fluorescent lamp, and coloring has been added to a glass stem 2291d that supports inner lead wires 2251dA and 271dA that are connected to filaments 2231d. In this example, distance f from a boundary 2034 to the glass stem 2291d can be used for detection. Since the glass stem 2291d can be detected from any direction regardless of the revolution direction of the glass bulb 2015d, the sensing equipment can be simplified.

In the example of FIG. 74C, a mark 2076 has been applied to the revolution direction of the base 2072e. In this example, distance g from a boundary 2034c to the mark 2076 can be used for detection. Similarly to the mark 2075, the mark 2076 can be detected from any direction regardless of the revolution direction of the glass bulb 2015e.

Although the shape of the electrode 17e is a bottomed tube, the shape is not limited to this, and may be a tube that is open on both ends, or a rod shape.

### Embodiment 14

The cold cathode fluorescent lamp pertaining to embodiment 14 has conductive films formed on both ends of the outer circumference of the glass bulb, and is electrically connected to the lead wires corresponding to both conductive films. Using the conductive films as power supply terminals enables improving attachability to the sockets provided in the backlight unit (outer case).

### Embodiment 14-1

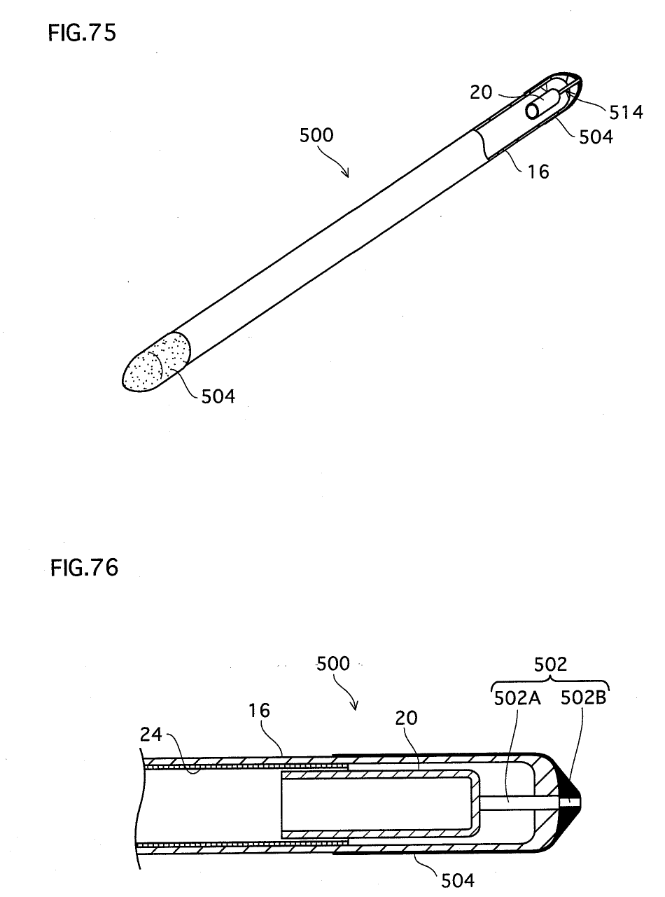

The following describes a cold cathode fluorescent lamp 500 pertaining to embodiment 14-1 with reference to FIGS. 75 and 76.

FIG. 75 is a perspective view showing a schematic structure of the cold cathode fluorescent lamp 500 (hereinafter simply “fluorescent lamp 500”) having a portion cut away. FIG. 76 shows a vertical section of an end portion thereof. Aside from adding power supply terminals and changing the measurements of the lead wires according to this addition, the fluorescent lamp 500 has a substantially similar structure to the cold cathode fluorescent lamp 10 of embodiment 1. Accordingly, common portions have been given the same reference notations, and description has been omitted or simplified. Note that drawings used to describe embodiment 14, including embodiment 14-2 that will be described later, omit depiction of the protective film 22 (FIG. 1), and bead glasses 21 and 23 (FIG. 10).

The fluorescent lamp 500 is similar to the lamp of embodiment 1. The fluorescent lamp 500 includes a cylinder-shaped glass bulb 16 formed by creating an airtight seal, with use of lead wires 502, on both ends of a glass tube having a circular cross section.

Similarly to embodiment 1, the lead wire 502 is a connected wire including an inner lead wire 502A made of Dumet and an outer lead wire 502B made of nickel. The glass tube has airtight seals formed by the inner lead wire 502A portions. The inner lead wire 502A and the outer lead wire 502B both have circular cross sections. The wire diameter of the inner lead wire 502A is 0.8 [mm] and the total length is 3 [m]. The wire diameter of the outer lead wire 502B is 0.6 [mm], and the total length is 1 [mm].

A power supply terminal 504 has been formed on the outer face of the end of the glass bulb 16. The power supply terminal 504 and the lead wire 502 (outer lead wire 502B) have been joined together, and electrically connected. The power supply terminal 504 includes a conductive film formed by sintering a conductive paste that has been applied to the outer face of the glass bulb 16.

Power supply by the power supply terminal 504 causes discharge to be generated between the two electrodes 20.

The power supply terminal 504 can be formed by a conventional dipping method (for example, Japanese Patent Application Publication No. 2004-146351). The following is a simple explanation of a dipping method for forming the power supply terminal 504. For example, the method is performed by immersing the sealed portion of the glass bulb 16 to which the electrode 20 has been sealed in molten solder that is in a melting basin. When immersing the sealed portion in the molten solder, ultrasound waves may be added. Since this type of dipping method enables forming the power supply terminal 504 simply and inexpensively, the cold cathode fluorescent lamp 1 can be manufactured inexpensively.

Note that the power supply terminal 504 may also be formed with use of a method other than the dipping method. For example, the power supply terminal 504 may be formed by vacuum evaporation, metal plating, etc.

### Embodiment 14-2

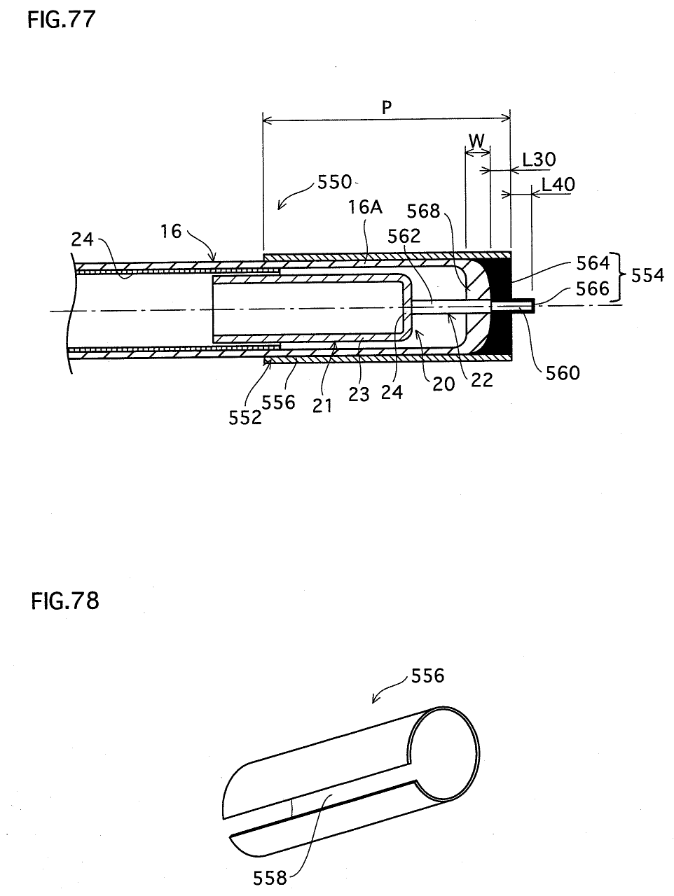

FIG. 77 is an enlarged cross section showing one end of a cold cathode fluorescent lamp pertaining to embodiment 14-2. FIG. 78 is a perspective view of a thin film member constituting a power supply terminal. The power supply terminal 552 of the cold cathode fluorescent lamp 550 shown in FIG. 77 includes a joint portion 554 made of solder and a thin film portion 556 made of an iron-nickel alloy, as a thin film member. Thus, the power supply terminal 552 is not necessarily constituted from a single material only.

As shown in FIG. 78, the thin film member 556 is cylindrical, having a C-shaped cross section and a thickness of 120 [μm], and is fitted to the outside of the end of the glass bulb 16. The thin film member 556 has an inner diameter that is slightly smaller than the outer diameter of the glass bulb 16, and a slit 558 has been provided in the thin film member 556. Accordingly, even if a metrication error occurs to some extent between the inner diameter of the thin film member 556 and the outer diameter of the glass bulb 16, the inner surface of the thin film member 556 has been designed to attach closely to the outer surface of the glass bulb 16.

Note that the thin film member 556 is not limited to being cylindrical and having a C-shaped cross section, and may have a polygonal shape such as being substantially a triangle or a square, or may be an oval cylinder, provided that the thin film member has a slit. Also, not having a slit is possible.

The total length of the outer lead wire 560 is 2 [mm]. Of this length, a length L30 of the portion stored inside the thin film 556 on the inner lead wire 562 side is 1 [mm], and a length L40 of the remaining portion that extends out of the thin film member 556 is 1 [mm]. The joint portion 554 is constituted from a thickness area 564 that has been joined to the portion of the outer lead wire 560 that is stored inside the thin film member 556, and a thinness area 566 that covers the portion of the lead wire 560 that extends outward from the thin film member 556.

When the power supply terminal 552 has the above structure, since the outer lead wire 560 is affixed to the thickness area 564 of the joint portion 554, stress is not likely to be added to the sealed portion 568 of the glass bulb 16 and the sealed portion 568 is not likely to break, even if the sealed portion 568 collides with the portion of the outer lead wire 560 that projects out of the thin film member 556. However, since the outer lead wire 560 should collide with the sealed portion 568 as little as possible, the outer lead wire 560 preferably either does not extend out of the thin film member 556, or only protrudes to a length L40 less than or equal to 1 [mm].

Note that the material that forms the power supply terminal 504 is not limited to being solder, provided that a conductive material is used. However, a material having low thermal conductivity is preferable so that the heat effect of the power supply terminal 504 does not become great.

Since solder has good conductivity, low thermal conductivity, and also a low cost, solder is generally a preferable material for the power supply terminal 504. In particular, solder whose main component is tin (Sn), a tin-indium alloy (In), or a tin-bismuth (Bi) alloy enables forming a power supply terminal 504 having a higher mechanical strength, and is therefore preferable. Due to the compatibility with glass of the following elements, adding at least one of antimony (Sb), zinc (Zn), aluminum (Al), gold (Au), copper (Cu), iron (Fe), platinum (Pt) and palladium (Pd) to the solder enables formation of a power supply terminal 504 that is not likely to detach from the glass bulb 16, and is further preferable. Additionally, manufacturing the cold cathode fluorescent lamp 1 with use of solder that does not contain lead is preferable in consideration of the environment.

When the material used to form the power supply terminal 504 is compatible with tungsten, the lead wire 560 may be made of tungsten. In other words, the lead wire 22 may be entirely made of tungsten. This enables decreasing the risk of the lead wire 22 disconnecting.

Supplementary Remarks on Embodiments 1 to 14

1. Phosphor Layer Composition

Although described based on embodiments 1 to 14, the phosphor layer is not limited to the above descriptions, and in particular, the following materials can be used for the phosphor layer.

(1) Ultraviolet Radiation Absorption

For example, in recent years, as liquid crystal televisions have become larger, polycarbonate having good measurement stability is being used for the diffusion sheet blocking the opening of the backlight unit. Such polycarbonate readily degrades due to ultraviolet radiation of 313 [nm] wavelength emitted by the mercury. In such a case, phosphor that absorbs 313 [nm] wavelength ultraviolet radiation should be used. Note that the following phosphors absorb 313 [nm] wavelength ultraviolet radiation.

(a) Blue

Europium and manganese activated barium strontium magnesium aluminate [Ba_{1-x-y}SrₓEu_{y}Mg_{1-z}Mn_{z}Al₁₀O₁₇] or [Ba_{1-x-y}SrₓEu_{y}Mg_{2-z}Mn_{z}Al₁₆O₂₇].

Here, x, y and z are preferably values that respectively satisfy 0≦x≦0.4, 0.07≦y≦0.25, 0≦z≦0.1.

Examples of this type of phosphor are europium-activated barium-magnesium aluminate [BaMg₂Al₁₆O₂₇:Eu²⁺], [BaMg₂Al₁₀O₁₇:Eu²⁺] (abbreviation: BAM-B) and europium-activated barium-strontium-magnesium aluminate [(Ba,Sr)MgAl₁₆O₂₇:Eu²⁺], [(Ba,Sr)MgAl₁₀O₁₇:Eu²⁺] (abbreviation: SBAM-B).

(b) Green
Manganese-activated magnesium gallate [MgGa₂O₄:Mn²⁺] (abbreviation: MGM)
Manganese-activated cerium-magnesium zinc aluminate [Ce(Mg,Zn)Al₁₁O₁₉:Mn²⁺] (abbreviation: CMZ)
Terbium-activated cerium-magnesium aluminate [CeMgAl₁₁O₁₉:Tb³⁺] (abbreviation: CAT)
Europium and manganese activated barium-strontium-magnesium aluminate [Ba_{1-x-y}SrₓEu_{y}Mg_{1-z}Mn_{z}Al₁₀O₁₇] or

[Ba_{1-x-y}SrₓEu_{y}Mg_{2-z}Mn_{z}Al₁₆O₂₇].

Here, x, y and z are values that respectively satisfy 0≦x≦0.4, 0.07≦y≦0.25, 0.1≦z≦0.6, and z preferably satisfies 0.4≦x≦0.5.

Examples of this type of phosphor are europium and manganese activated barium-magnesium aluminate [BaMg₂Al₁₆O₂₇:Eu²⁺,Mn²⁺] [BaMgAl₁₀O₁₇:Eu²⁺,Mn²⁺] (abbreviation: BAM-G) and europium and manganese activated barium-strontium-magnesium aluminate [(Ba,Sr)Mg₂Al₁₆O₂₇:Eu²⁺,Mn²⁺], [(Ba,Sr)MgAl₁₀O₁₇:Eu²⁺,Mn²⁺] (abbreviation: SBAM-G).

(c) Red
Europium-activated yttrium phosphovanadate [Y(P,V)O₄:Eu³⁺] (abbreviation: YPV)
Europium-activated yttrium vanadate [YVO₄:Eu³⁺] (abbreviation: YPO)
Europium-activated yttrium oxysulfite [Y₂O₂S:Eu³⁺] (abbreviation: YOS)
Manganese-activated magnesium germanate [3.5 Mg O.0.5 Mg F₂.GeO₂:Mn⁴⁺] (abbreviation: MFG)
Dyspropsium-activated yttrium vanadate [YVO₄:Dy³⁺] (phosphor emitting two components of light, red and green, abbreviation: YDS)

Note that different chemical compounds of phosphor may be mixed together and used for one type of emission color. For example, BAM-B (absorbs 313 [nm]) only may be used for blue, LAP (does not absorb 313 [nm]) for green, and YOX (does not absorb 313 nm) for red. In such a case, adjusting the phosphor that absorbs 313 [nm] radiation to have a gross weight composition ratio of more than 50[%] enables nearly totally preventing the ultraviolet radiation from leaking out of the glass tube. Accordingly, including phosphor that absorbs 313 [nm] ultraviolet radiation in the phosphor layer 105 enables suppressing degradation due to ultraviolet radiation of the polycarbonate (PC) diffusion plate, etc. that blocks the opening of the backlight unit, and long-term maintenance of the attributes of the backlight unit.

The definition used here for “absorbing 313 [nm] ultraviolet radiation” is having a 313 [nm] excitable wavelength spectrum intensity of 80% or more when the intensity of an approximately 254 [nm] excitation wavelength spectrum is 100% (the excitation wavelength spectrum is a spectrum in which an excitation wavelength and a light intensity when a phosphor is excited over a range of wavelengths is plotted). In other words, phosphor that absorbs 313 [nm] ultraviolet radiation is phosphor that can convert 313 [nm] ultraviolet radiation to visible light.

(2) High Color Reproduction

In liquid crystal display apparatuses epitomized by liquid crystal color televisions, a trend towards high color fidelity has been part of a trend towards high image quality, and in the cold cathode fluorescent lamps and external electrode fluorescent lamps that are used as light sources for backlight units of the liquid crystal display apparatuses, there is demand for expansion of the reproducible chromaticity range.

In response to this demand, using the following phosphors, for example, enables enlarging the chromaticity range. Specifically, in the chromaticity diagram CIE 1931, the chromaticity coordinate values of the high-reproduction phosphors are positioned to enlarge the chromaticity range and include a triangle formed by connecting chromaticity coordinate values of three ordinary phosphors.

Note that the chromaticity coordinate values of the phosphor (powder) described below are values measured with use of a spectroscopic value analyzer (MCPD-7000) manufactured by Otsuka Denki Co., Ltd. that have been rounded to the fourth digit after the decimal point. Also, these chromaticity coordinate values are representative values of the respective phosphor materials, and there are cases in which the values differ slightly depending on measurement method (measurement principle) etc.

(a) Blue
Europium-activated strontium-chloroapatite [Sr₁₀(PO₄)₆Cl₂:Eu²⁺](abbreviation: SCA), chromaticity coordinates: x=0.153, y=0.030

In addition to the above, europium-activated strontium-calcium-barium-chloroapatite [(Sr, Ca, Ba)₁₀ (PO₄)₆Cl₂:Eu²⁺] (abbreviation: SBCA), can be used, and SBAM-B, described above, that can absorb 313 [nm] ultraviolet radiation can also be used.

(b) Green
BAM-G, chromaticity coordinate values: x=0.136, y=0.572
CMZ, chromaticity coordinate values: x=0.164, 0.722
CAT, chromaticity coordinate values: x=0.284, y=0.663
Terbium-manganese activated serbium-magnesium aluminate [CeMgAl₁₁O₁₉: Tb³⁺,Mn³⁺] (abbreviation: CAM), chromaticity coordinate values: x=0.256, y=0.657
Manganese-activated zinc silicate [Zn₂SiO₄:Mn²⁺] (abbreviation: ZSM), chromaticity coordinate values: x=0.248, y=0.700

Note that these, as described above, can absorb 313 [nm] wavelength radiation, and other than the three types of phosphor particles described above, MGM can also be used for high-color fidelity.

(c) Red
YOS, chromaticity coordinate values: x=0.658, y=0.330
YPV, chromaticity coordinate values: x=0.661, y=0.328
MFG, chromaticity coordinate values: x=0.708, y=0.288

Note that these, as described above, can absorb 313 [nm] wavelength radiation, and other than the three types of phosphor particles described above, YPV and YDS can also be used for high-color fidelity.

Also, the chromaticity coordinate values indicated above are representative values reached by measuring only the fine particles of each phosphor type, and the chromaticity coordinate values indicated by the fine particles of each phosphor type may differ slightly from the values given above depending on measurement method (measurement principle) etc. As a reference, the chromaticity coordinate values of the phosphor powders of embodiment 1 are YOX (x=0.643, y=0.348), LAP (x=0.351, y=0.585), BAM-B (x=0.148, y=0.055).

Furthermore, the phosphors used for emitting red, green, and blue light are not limited to being one type per each wavelength, and combinations of a plurality of types may be used.

The following describes a case of using phosphor particles for high fidelity, as mentioned above. The evaluation was performed with use of an area ratio (hereinafter referred to as an NTSC ratio) of a triangle formed by connecting three chromaticity coordinate values using high-fidelity phosphor, based on the area of an NTSC triangle formed by connecting chromaticity coordinate values of the three NTSC standard colors in the CIE 1931 chromaticity diagram.

For example, when BAM-B is used for blue, BAM-G for green, and YVO for red (example 1), the NTSC ratio is 92[%], when SCA is used for blue, BAM-G for green, and YVO for red (example 2), the NTSC ratio is 100[%], and when SCA is used for blue, BAM-G for green, and YOX for red (example 3), the NTSC ratio is 95[%], and thus luminance can be improved 10[%] over examples 1 and 2.

Note that the chromaticity coordinate values used for this evaluation have been measured for a liquid crystal display apparatus in which lamps, etc. have been mounted.

2. Material of the Glass Bulb

(1) Using soda glass as the material of the glass bulb of the present embodiment enables improving the in-dark start characteristic. Specifically, the above glass contains a large amount of an alkali metal oxide typified by sodium oxide (Na₂O), and when sodium oxide is used, for example, the sodium (Na) component elutes into an inner face of the glass bulb as time passes. Since sodium has a low electronegativity, the sodium that elutes into the interior surface of the glass bulb (does not have a protective film) is thought to contribute to an improvement in the in-dark start characteristic of the lamp.

In particular, in an external/internal electrode type fluorescent lamp such as the fluorescent lamp pertaining to embodiment 19 described later or an external electrode type fluorescent lamp, a content ratio of alkali metallic oxide from 3 [mol %] to 20 [mol %] inclusive is preferable.

For example, when the alkali metal oxide is sodium oxide, a content ratio from 5 [mol %] to 20 [mol %] inclusive is preferable. If the alkali metal oxide is less than 5 mol %, the probability of the in-dark start time exceeding 1 [second] is high (in other words, the probability is high of the in-dark start time being under 1 [second] when the content ratio is under 5 [mol %]), and if over 20 mol %, prolonged use causes problems such as whitening of the glass tube and a decline in the strength of the glass bulb.

Also, using lead-free glass is preferable in consideration of environmental protection. However, there are cases in the manufacturing process of lead-free glass in which lead is included as an impurity. Therefore, lead-free glass is defined as also including glass which includes an impurity level of lead that is less than or equal to 0.1 wt %.

(2) Also, doping the glass with a transition metal oxide, in a predetermined amount depending on the type of oxide, enables absorbing 254 [nm] and 313 [nm] ultraviolet radiation.

Specifically, for example when using titanium oxide (TiO₂), doping a composition ratio of greater than or equal to 0.05 [mol %] enables absorbing 254 [nm] ultraviolet radiation, and doping a composition ratio of greater than or equal to 2 [mol %] enables absorbing 313 [nm] ultraviolet radiation. However, since the glass devitrifies if a composition ratio of more than 5.0 [mol %] of titanium oxide is used, doping a composition ratio in a range from 0.05 [mol %] to 5.0 [mol %] inclusive is preferable.

Also, when cerium oxide (CeO₂) is used, doping a composition ratio greater than or equal to 0.05 [mol %] enables absorbing 254 [nm] ultraviolet radiation. However, since doping a composition ratio of more than 0.5 [mol %] of cerium oxide stains the glass, doping a composition ratio of cerium oxide in a range from 0.05 [mol %] to 0.5 [mol %] inclusive is preferable. Note that since doping tin oxide (SnO) in addition to cerium oxide enables suppressing staining of the glass by the cerium oxide, this enables doping cerium oxide up to a composition ratio of 5.0 [mol %] inclusive. In such a case, doping a composition ratio of cerium oxide greater than or equal to 0.5 [mol %] enables absorbing 313 [nm] ultraviolet radiation. However, even in such a case, doping a composition ratio of cerium oxide of more than 5.0 [mol %] causes the glass to devitrify.

Also, when zinc oxide (ZnO) is used, doping a composition ratio greater than or equal to 2.0 [mol %] enables absorbing 254 [nm] ultraviolet radiation. However, doping a composition ratio of more than 10 [mol %] of zinc oxide causes the coefficient of thermal expansion of the glass to increase, and when the inner lead wire is made of tungsten (W), the coefficient of thermal expansion of the inner lead wire (approximately 44×10⁻⁷ [K⁻¹]) is different from the coefficient of thermal expansion of the glass, thereby making sealing difficult. Therefore, doping a composition ratio of zinc oxide in a range from 2.0 [mol %] to 10 [mol %] inclusive is preferable. However, when the inner lead wire is made of Kovar or molybdenum (Mo), since the coefficient of thermal expansion of the inner lead wire (approximately 51×10⁻⁷ [K⁻¹] is larger than when tungsten is used, zinc oxide can be doped up to a composition ratio of 14 [mol %] inclusive.

Also, when iron oxide (Fe₂O₃) is used, doping a composition ratio greater than or equal to 0.01 [mol %] enables absorbing 254 [nm] ultraviolet radiation. However, since doping a composition ratio of more than 2.0 [mol %] of iron oxide stains the glass, doping a composition ratio of iron oxide in a range from 0.01 [mol %] to 2.0 [mol %] inclusive is preferable.

Also, the infrared transmission coefficient is adjusted to be preferably in a range from 0.3 to 1.2 inclusive, and particularly from 0.4 to 0.8 inclusive. An infrared transmission coefficient of less than or equal to 1.2 enables readily obtaining a low dielectric loss tangent that is applicable to a high-voltage impressed lamp of an external electrode fluorescent lamp (EEFL) or a long-type cold cathode fluorescent lamp, and if lower than or equal to 0.8, the dielectric loss tangent is sufficiently small, and further applicable to a high-voltage impressed lamp.

Note that the infrared transmission coefficient (X) can be represented by the formula below.

X=(log(a/b))/t [Formula 1]
a: transmission rate [%] at local minimum point in the vicinity of 3840 [cm⁻¹]
b: transmission rate [%] at local minimum point in the vicinity of 3560 [cm⁻¹]
t: thickness of the glass

Note that adjusting the thermal expansion coefficient of the glass enables increasing the sealing strength of the inner lead wires of the lamp 20. For example, if the inner lead wires are made of tungsten (W), a range of 36×10⁻⁷ [K⁻¹] to 45×10⁻⁷ [K⁻¹] inclusive is preferable. In such a case, causing the sum of the alkali metal component and the alkali earth metal component in the glass to be from 4 [mol %] to [mol %] inclusive enables the thermal expansion coefficient of the glass to be in the above range.

Also, when the inner lead wires are made of Kovar or molybdenum (Mo), a range of 45×10⁻⁷ [K⁻¹] to 56×10⁻⁷ [K⁻¹] inclusive is preferable. In such a case, causing the sum of the alkali metal component and the alkali earth metal component in the glass to be from 7 [mol %] to 14 [mol %] inclusive enables the thermal expansion coefficient of the glass to be in the above range.

Also, when the inner lead wires are made of Dumet, a value in the vicinity of 94×10⁻⁷ [K⁻¹] is preferable. In such a case, causing the sum of the alkali metal component and the alkali earth metal component in the glass to be from 20 [mol %] to 30 [mol %] inclusive enables the thermal expansion coefficient of the glass to be the value mentioned above.

### INDUSTRIAL APPLICABILITY

A fluorescent lamp of the present invention is favorably applicable for use as a light source in a backlight unit in which a high initial luminance and superior luminance maintenance rate is required, the backlight unit being mounted in, for example, a liquid crystal display device.

1. A fluorescent lamp, being one of a cold cathode type and an external electrode type, and including a glass bulb, a protective film formed on an inner face of the glass bulb, and a phosphor layer formed so as to overlap the protective film, the phosphor layer including blue phosphor particles, green phosphor particles, and red phosphor particles, wherein
the glass bulb has been formed of soda glass, and among the blue phosphor particles, the green phosphor particles, and the red phosphor particles, at least the blue phosphor particles have been coated with a metal oxide, and
the protective film has been formed of silica (SiO₂).

2. The fluorescent lamp of claim 1, wherein
one of a titanium compound and a cerium compound has been dispersed in the protective film.

3. The fluorescent lamp of claim 1, wherein
the metal oxide is lanthanum oxide (La2O3), and
the lanthanum oxide is included in the phosphor layer at a ratio from 0.1 [wt %] to 1.5 [wt %] inclusive with respect to a total weight of the phosphor particles.

4. The fluorescent lamp of claim 1, wherein
the metal oxide is lanthanum oxide (La2O3), and
the phosphor layer includes CBBP as a binding agent at a ratio from 1.3 [wt %] to 3 [wt %] inclusive.

5. The fluorescent lamp of claim 1, wherein
the metal oxide is yttrium oxide (Y2O3),
the phosphor layer includes CBB as a binding agent, and
in the phosphor layer, letting A be a total weight ratio of yttrium oxide, and B be a total weight ratio of CBB, with respect to a total weight of 100 for the phosphor particles, A and B are in ranges of
0.1≦A≦0.6, and
0.4≦(A+B)≦0.7.

6. The fluorescent lamp of claim 1, wherein
the blue phosphor particles are europium-activated barium-magnesium aluminate, and
a content amount of an impurity included in the blue phosphor particles is less than or equal to 0.1 [wt %] of a total weight of the blue phosphor particles.

7. The fluorescent lamp of claim 6, wherein
cerium oxide is included in the blue phosphor particles as the impurity.

8. The fluorescent lamp of claim 6, wherein
barium aluminate and magnesium aluminate are included as the impurity.

9. The fluorescent lamp of claim 1, further including:
a pair of bottomed tube-shaped electrodes, each electrode being disposed on an inner side of a different end and of the glass bulb, wherein
an electrode material of at least one of the electrodes is composed of nickel as a base material, yttrium oxide having been added to the electrode material in a range of 0.1 [wt %] to 1.0 [wt %] inclusive.

10. The fluorescent lamp of claim 9, wherein
any of silicon, titanium, strontium and calcium has been added to the electrode material in a content amount that is less than or equal to half of a content amount of the yttrium oxide.

11. The fluorescent lamp of claim 1, further comprising:
a pair of bottomed tube-shaped electrodes, each electrode being disposed on an inner side of a different end of the glass bulb; and
a fluorescent lamp emitter formed on at least a portion of an inner face or an outer face of at least one of the electrodes, containing magnesium oxide, whose primary particles are formed from single crystals, an average particle diameter of the single crystals being less than or equal to 1 [μm].

12. The fluorescent lamp of claim 1, wherein
both ends of the glass bulb have been pinch-sealed to form pinch-sealed ends,
a lead-in wire and a gas exhaust tube have been inserted through at least one of the pinch-sealed ends, the lead-in wire functioning as a power supply route to an internal electrode, and an outer end of the gas exhaust tube being sealed, and
the fluorescent lamp further includes:
a base that is electrically connected to the lead-in wire and affixed to one of the gas exhaust tube and a portion of the glass bulb excluding the pinch-sealed ends.

13. The fluorescent lamp of claim 12, wherein
the base is sleeve-shaped and affixed to an un-pinch-sealed portion of the glass bulb, the un-pinch-sealed portion being a portion of the glass bulb other than the pinch-sealed ends.

14. The fluorescent lamp of claim 12, wherein
the gas exhaust tube extends outward from the at least one of the pinch-sealed ends, and the base has been affixed to an extending portion of the gas exhaust tube.

15. The fluorescent lamp of claim 1, wherein
the glass bulb has been sealed on both ends, and
the fluorescent lamp further includes, on at least one end of the glass bulb,
a lead wire that penetrates through the end,
an electrode that is joined to an end of the lead wire on an inner side of the glass bulb, and
a power supply terminal that is composed of a conductive film formed on an outer face of the end and an outer circumferential surface of the glass bulb that is contiguous with the outer face, and that is electrically connected to the lead wire.

16. The fluorescent lamp of claim 1, further including:
an electrode provided on an inner side of an end of the glass bulb; and
a lead wire, one end of which is connected to the electrode, and another end of which extends out of the end of the glass bulb, wherein
a member has been attached to at least one end of the glass bulb via a buffer material, an elastic modulus of the member being higher than the buffer material, and
the lead wire has been fitted through the buffer material and the member.

17. The fluorescent lamp of claim 1, wherein
a difference between a length of a non-phosphor layer area extending from a one end of the glass bulb and a length of a non-phosphor layer area extending from another end of the glass bulb is greater than or equal to 2 [mm].

18. A backlight unit including the fluorescent lamp of claim 1 as a light source.

19. The backlight unit of claim 18, wherein
a mixed gas including argon gas and neon gas has been enclosed in the glass bulb of the fluorescent lamp,
the backlight unit further includes a lighting apparatus for lighting the fluorescent lamp,
letting a charged pressure [Torr] of the mixed gas be plotted on an x axis and a drive current value [mA] be plotted on a y axis in an x-y orthogonal coordinate system, a charged pressure of the mixed gas is a coordinate value of x and the mixed gas drive current value is a coordinate value of y that are in an area enclosed by a line (including the line) drawn sequentially between points represented as (x,y) coordinates, the points being (10,10), (10, 7.6), (21,6), (31,4), (49,4), (51,6), (52,8), (53,10), and (10,10), and
the mixed gas contains the argon gas at a partial pressure rate of greater than or equal to 20[%].

20. A liquid crystal display apparatus, comprising:
the backlight unit of claim 18 further including an outer case that stores the fluorescent lamp; and
a liquid crystal display panel, wherein
the outer case is disposed behind the liquid crystal display panel.
